(19) United States
(12) Patent Application Publication
(10) Pub. No.: US 2008/0235055 A1
(43) Pub. Date: Sep. 25, 2008

(54) Laboratory instrumentation information management and control network

(76) Inventors: Scott Mattingly, Tucson, AZ (US); Alain Larson, Marana, AZ (US); Brian Messick, Oro Valley, AZ (US); Jack Phillips, Tucson, AZ (US); Randy Stephens, Honey Grove, TX (US); William C. Crawford, Oro Valley, AZ (US); Aaron Ewoniuk, Oro Valley, AZ (US)

Correspondence Address: MUIRHEAD AND SATURNELLI, LLC, 200 FRIBERG PARKWAY, SUITE 1001, WESTBOROUGH, MA, 01581, US

(21) Appl. No.: 11/818,223

(22) Filed: Jun. 13, 2007

Related U.S. Application Data
(63) Continuation-in-part of application No. 11/032,324, filed on Jan. 10, 2005.
Application No. 11/032,324 is a continuation-in-part of application No. 10/893,725, filed on Jul. 16, 2004.
Application No. 10/893,725 is a continuation-in-part of application No. 11/639,586, filed on Dec. 15, 2006.
(60) Provisional application No. 60/487,998, filed on Jul. 17, 2003.
(60) Provisional application No. 60/751,807, filed on Dec. 19, 2005.

(51) Int. Cl. G06Q 50/00; G06F 17/30; G06F 17/40

(52) U.S. Cl. 705/3; 705/2

(57) ABSTRACT

Described are techniques for identifying samples processed in a laboratory using harmonized identifier. A case identifier identifying a patient from whom a specimen is collected is determined. A specimen identifier associated with the specimen is determined. An entry for the specimen is recorded in a data store where the entry being associated with the case identifier and the specimen identifier. A harmonized specimen identifier including the case identifier and the specimen identifier is formed. The specimen is labeled with the harmonized specimen identifier.

### CROSS REFERENCE TO RELATED APPLICATIONS

This application is a continuation-in-part of U.S. patent application Ser. No. 11/032,324, filed, Jan. 10, 2005, Attorney Docket No. VMS-002US, which is a continuation-in-part of U.S. patent application Ser. No. 10/893725, filed Jul. 16, 2004, Attorney Docket No. VMS-00101, which claims the benefit of U.S. Provisional Application No. 60/487,998, filed Jul. 17, 2003, Attorney Docket No. VMS-00160, and is a continuation-in-part of U.S. patent application Ser. No. 11/639,586, AUTOMATED LEAN METHODS IN ANATOMICAL PATHOLOGY, filed Dec. 15, 2006, Attorney Docket No. VMS-003US, which claims the benefit of U.S. Provisional Patent Application No. 60/751,807, filed on Dec. 19, 2005, entitled AUTOMATED LEAN METHODS IN ANATOMICAL PATHOLOGY, Attorney Docket No. 310/003/PPA, all of which are incorporated by reference herein.

### BACKGROUND OF THE INVENTION

1. Technical Field

This invention relates generally to data management and more particularly to communicating, managing, brokering and facilitating the replication of data over a system of instruments, computers and interfaces for managing laboratory information.

2. Description of Related Art

In order to correctly diagnose or confirm the presence of disease in a patient, a physician typically must excise a sample of diseased tissue and have that tissue examined on a microscopic level by a pathologist. Using a plurality of analysis techniques and laboratory instruments, the pathologist will be able to analyze the diseased tissue to identify any structural (or other) changes in cell tissues and organs. In most cases, the pathologist may be able to 1) identify the type of disease, 2) establish a prognosis on the likely progression of the disease, and 3) make a determination as to what therapy might be most effective in curing or treating the disease. As with most diseases, one important element to a successful treatment or cure is the ability of the physician to rapidly and effectively treat the patient before the disease progresses to an incurable state. This requires that the pathologist have the ability to rapidly analyze the tissue sample, diagnose the condition and disseminate this information to the patient's physician, all the while maintaining accuracy and reliability.

Laboratory Information Systems (LIS) are known for management of patient and laboratory information. Such systems typically consist of a server or host computer, a data base and data base management system, and application software for receiving and processing patient information. Known LIS may be “web-enabled” to facilitate access of the system and information over the Internet.

Unfortunately, however, current Laboratory Information Systems tend to lack the ability to manage workflow with certain laboratory instrumentation, such as, for example, an advanced staining instrument. This management includes basic connectivity, data exchange capability and business rules implemented to optimize workflow, costs and efficiencies. As such, there exist several deficiencies in how these instruments are utilized in the laboratory. A significant amount of time and energy is expended replicating tedious functions, such as data entry, labeling and manual entry for report generation. This replication increases the amount of time it takes to process samples by creating a significant bottleneck in laboratory work flow. The tedious nature of these tasks can substantially increase errors and can affect the accuracy of the diagnostic process. The resulting increase in test completion time may allow a localized disease to progress into systemic proportions, such as a localized tumor metastasizing, having a devastating effect on patient prognosis and/or treatment options and results.

One example of how a bottleneck in laboratory work flow may occur is illustrated in FIG. 1. Typically, a pathologist receives a sample for testing, and orders tests 10. Upon receipt of a tissue sample, accessioning and test order information is entered into the LIS by a laboratory technician 12. However, because the LIS is not connected to the laboratory instruments, the accessioning and test order information that was just entered into the LIS needs to be sent to the test laboratory 14 and re-entered into each laboratory instrument that will be used for testing in order to create slide labels 16. This could take a significant amount of time depending on the number of samples and the extent of testing being performed on the samples. Additionally, each time this data entry function is replicated, the possibility of error in the information transfer increases, reducing the accuracy and reliability of the testing procedure.

Another example of how a bottleneck in laboratory work flow may occur is described as illustrated in FIG. 2 and involves the generation of a status report. Again, the pathologist receives the test sample and orders tests 18. Accessioning and test ordering information is entered into the LIS 20, and then such information must be sent to the test lab 22. Then accessioning and test order information has to be entered into a laboratory instrument 24, such as an advanced staining instrument, and a slide label is generated and the laboratory instrument will begin performing the ordered test. In some cases, the pathologist, lab manager and technician may be keenly interested in the progress of the test and thus may desire to monitor the status of the test. Unfortunately however, the lack of data communications between the LIS and the laboratory instruments prevents test status monitoring by precluding the automatic generation of a test status report. As such, in order to check the status of the test the testing must be interrupted 26 and a test status report must be manually generated.

In addition to this lack of connectivity creating a bottleneck in laboratory work flow, the diagnostic capability of the laboratory is also adversely affected due to the reality that current laboratory set-ups do not have the ability to perform many new and advanced features which may substantially increase the timeliness, reliability and accuracy of new and existing tests.

One way to maximize the timeliness, reliability and accuracy of the sample analysis, condition diagnosis and dissemination of information would be to establish a communication connection between the LIS and the laboratory instrumentation. The extent to which the work flow bottleneck or the performance efficiency would be improved thus would be dependent upon the type of connectivity (unidirectional or bidirectional) established between the LIS and the laboratory instrumentation. For example, a unidirectional, or one-way, connection between the LIS and the laboratory instrumentation would allow for test result information to flow, in one direction, between the laboratory instrument and the LIS, thus eliminating duplicate data entry. Similarly, a bidirectional, or two-way, connection between the LIS and the medical laboratory instrumentation would enable new advanced features to be included, such as order entry and tracking, status updates, sample tracking, quality control, College of American Pathologists (CAP) compliance, inventory management and maintenance, all of which would increase performance time, reliability and accuracy.

Unfortunately however, a suitable system management structure does not exist that would allow for effective control between the LIS and automated laboratory instrumentation, such as staining instrumentation, such that the timeliness of the test performance, data analysis, disease diagnosis and information dissemination process is substantially optimized. Additionally, known systems for interconnecting laboratory instrumentation and information systems do not effectively and automatically identify, prioritize and stage specimens to optimize the throughput and utilization of the automatic staining systems. Nor do known systems have the capability to automate the identification, labeling and tracking of specimens and results through the clinical pathology process. Furthermore, known systems are not specifically capable of optimizing the storage, use, and management of the reagents between staining systems necessary for performing the multitude of staining procedures for disease diagnosis.

### SUMMARY OF THE INVENTION

In accordance with one aspect of the invention is a method for identifying samples processed in a laboratory using harmonized identifiers, the method comprising: determining a case identifier identifying a patient from whom a specimen is collected; determining a specimen identifier associated with the specimen; recording in a data store an entry for the specimen, the entry being associated with the case identifier and the specimen identifier; forming a harmonized specimen identifier including the case identifier and the specimen identifier; and labeling the specimen with the harmonized specimen identifier. The method may also include determining a block identifier for each tissue block produced from the specimen; recording in the data store an entry for said each tissue block, the entry being associated with the case identifier, the specimen identifier, and the block identifier; forming a harmonized block identifier for each tissue block including the case identifier, the specimen identifier, and the block identifier; and labeling each tissue block with the harmonized block identifier. The method may also include, for each tissue block: determining a slide identifier for each slide produced from said each tissue block; recording in the data store an entry for said each slide, the entry being associated with the case identifier, the specimen identifier, the block identifier, and the slide identifier; forming a harmonized slide identifier for said each slide including the case identifier, the specimen identifier, the block identifier, and the slide identifier; and labeling said each slide with the harmonized slide identifier. The harmonized identifiers include one or more types of harmonized identifiers, said type of harmonized identifiers comprising a harmonized slide identifier type, a harmonized block identifier type, and a harmonized specimen identifier type, each type of harmonized identifier used by consumers of said harmonized identifiers to differentiate between different samples of said each type in a workflow process of the laboratory. The harmonized identifiers may have an associated local level of uniqueness with respect to consumers thereof to allow for identification and tracking of a sample by the consumers. The case identifier may include a first portion identifying a source of the specimen and a second portion including one or more alphanumeric characters representing an element in a sequence of elements. The specimen identifier may include one or more alphanumeric characters representing an element in a sequence of elements, each specimen associated with the case identifier having a different specimen identifier. The block identifier may include one or more alphanumeric characters representing an element in a sequence of elements, each tissue block associated with a same specimen having a different block identifier. The slide identifier may include one or more alphanumeric characters representing an element in a sequence of elements, each slide produced from a same tissue block having a different slide identifier. Each harmonized specimen identifier, harmonized block identifier, and harmonized slide identifier may be encoded in a machine readable form.

In accordance with another aspect of the invention is a method of automating information associated with biological specimens processed in a laboratory comprising the steps of: performing accessioning for one or more specimens, said accessioning including entering case information communicated to a server, the case information identifying a patient from whom the one or more specimens are obtained; determining a case identifier for the case information; recording data on the server associating the case identifier with the case information and the one or more specimens; determining a different specimen identifier for each of the one or more specimens; recording data associating the different specimen identifier with each of the one or more specimens; and labeling each of the one or more specimens with a harmonized specimen identifier, the harmonized specimen identifier for each specimen being formed from the case identifier and the different specimen identifier associated with said each specimen. The method may also include, for each of the one or more specimens: delivering said each specimen to a grossing station; reading, from a label on said each specimen, a harmonized specimen identifier; communicating with the server to retrieve data indicating a number of cassettes to be produced for said each specimen based on the harmonized specimen identifier; determining a different block identifier for each of the number of cassettes; recording data on the server associating the different block identifier with each of the number of cassettes; marking the number of required cassettes by labeling each cassette with a harmonized block identifier formed using the case identifier, a specimen identifier included in the harmonized specimen identifier, and the block identifier associated with said each cassette; partitioning a number of tissue portions from said specimen in accordance with said number of cassettes; and placing a tissue portion into each of said cassettes. The method may also include for each tissue block included in one of said number of cassettes: delivering said cassette to a cutting station; reading, from a label on said cassette, a harmonized block identifier; communicating with the server to retrieve data indicating a number of slides to be produced for said cassette based on the harmonized block identifier and staining information for each of said number of slides; determining a different slide identifier for each of the number of slides; recording data on the server associating the different slide identifier with each of the number of slides; and marking, at said cutting station, each slide by labeling said each slide with a harmonized slide identifier formed using the case identifier, a specimen identifier and a block identifier of the harmonized block identifier, and the slide identifier, said slide label also including said staining information; cutting a number of tissue section from said each tissue block in accordance with said number of slides; and placing a tissue section on each of said number of slides. The method may also include obtaining chain of custody information for each specimen during processing of said each specimen at one or more workflow processing points in the laboratory. The method may also include: reading a label associated with each specimen containing the harmonized specimen identifier at the grossing station; and recording on the server tracking information and associating the tracking information with said each specimen, the tracking information including date and time information and identifying an individual performing processing at the grossing station on said each specimen. The chain of custody information may be obtained related to processing a specimen, or portion derived therefrom, in connection with at least one of: grossing, tissue processing, embedding, cutting, staining, case assembly, coverslipping, pathologist review and archiving, and the method may further include recording on the server the chain of custody information and associated the chain of custody information with an appropriate workflow processing point.

In accordance with another aspect of the invention is a method of tracking specimens and samples derived from the specimens in a laboratory comprising: determining one or more checkpoint notification times associated with a specimen, each of said checkpoint notification times being associated with a workflow processing point in the laboratory; recording the one or more checkpoint notification times and associating the one or more checkpoint notification times with the specimen; labeling said specimen and each sample derived from a specimen with a machine readable label including information encoded thereon used for identifying said specimen and each sample derived from said specimen; as part of processing at a workflow processing point in the laboratory, reading the machine readable label and recording tracking information associated with one of the specimen or said each sample derived therefrom having the machine readable label, said tracking information including data identifying said workflow processing point and a time at which said one of the specimen or said each sample derived therefrom is at said workflow processing point; determining whether a checkpoint notification is associated with the workflow processing point for said specimen; if a checkpoint notification and checkpoint notification time are associated with the workflow processing point for said specimen and the checkpoint notification time has not arrived, recording information so that a checkpoint notification communication is not generated at the checkpoint notification time; and if a checkpoint notification and checkpoint notification time are associated with the workflow processing point for said specimen and the checkpoint notification time arrives prior to tracking information associated with the workflow processing point being entered, generating a checkpoint notification communication. The method may also include: specifying one or more default time intervals each associated with a workflow processing point; and determining a checkpoint notification time associated with the specimen at a workflow processing point relative to a first time associated with the specimen and one of the default time intervals associated with the workflow processing point. The method may also include customizing one or more checkpoint notification times associated with a specimen by overriding a default notification time generating using the one or more default time intervals.

In accordance with another aspect of the invention is a method for generating a harmonized identifier for a sample entity processed in a laboratory comprising: determining a node corresponding to the sample entity at a position in a hierarchical representation, each level of the hierarchical representation being associated with a workflow processing point in the laboratory, said hierarchical representation having a root node and a path formed from said root node to said node, said root node corresponding to a case identifier associated with a patient from whom the sample entity is obtained; determining a data identifier for each node in the path other than the root node, the path including two or more nodes, each node other than the root node being associated with another sample entity from which the sample entity is obtained; and forming a harmonized identifier for the sample entity by combining the case identifier and each data identifier associated with a node in the path other than the root node. The harmonized identifier may be stored in a database and associated with the sample entity. The method may further include labeling a container including the sample entity with the harmonized identifier encoded in a machine readable form. The method may also include labeling the container including the sample entity with the harmonized identifier encoded in a human readable form. The sample entity may be a tissue processed in an anatomical pathology laboratory. The machine readable form may include at least one of a bar code and an encoded radio frequency identification label. The labeling may include marking a surface of the container. The labeling may include generating a label affixed to the container.

In accordance with another aspect of the invention is a method for identifying a slide processed in a laboratory, the method comprising: determining a first identifier associated with a specimen, the first identifier including a first portion denoting a source of the specimen and a year in which the specimen is obtained, and the first identifier including a second portion denoting a next integer in a sequence; determining a second identifier for a tissue block derived from the specimen, the second identifier being one or more alphanumeric characters; determining a third identifier for the slide having a tissue section thereon cut from the tissue block; forming a slide identifier for the slide by concatenating the first identifier, the second identifier and the third identifier; recording in a data store an entry for the slide, the entry being associated with the slide identifier; and labeling the slide with the slide identifier encoded in a machine readable form. The slide identifier may be encoded in a selected bar code symbology. The slide identifier may be encoded on a radio frequency identifier label affixed to said slide.

### BRIEF DESCRIPTION OF DRAWINGS

The foregoing and other features and advantages of the present invention will be better understood from the following detailed description of illustrative embodiments, taken in conjunction with the accompanying drawings in which:

FIG. 1 is a block diagram illustrating a first type of bottleneck in laboratory work flow in accordance with the PRIOR ART;

FIG. 2 is a block diagram illustrating a second type of bottleneck in laboratory work flow in accordance with the PRIOR ART;

FIG. 3 is a block diagram of an illustrative embodiment of an interface point network (IPN);

FIG. 3A is a data flow diagram of a system implementing an IPN according to an illustrative embodiment;

FIG. 4 is a block diagram illustrating a multi-layer software architecture;

FIG. 5 is a block diagram illustrating an established hierarchy of an HL7 message;

FIG. 6 is a block diagram illustrating a general method of Host/IP Data Synchronization according to an illustrative embodiment;

FIG. 7 is a block diagram illustrating a method for Host-Side Data Element Synchronization according to an illustrative embodiment;

FIG. 8 is a block diagram illustrating a method for Host-Side Data Element Marshalling according to an illustrative embodiment;

FIG. 9-12 are examples of embodiments of slide arrangements with RFID labels;

FIG. 13 is an example of an embodiment of a specimen container including an RFID label;

FIG. 14 is an example of an embodiment of a reagent container including an RFID label;

FIG. 15 is an example of components that may be included in a system using RFID labels;

FIG. 16 is a flowchart of processing steps that may be performed in an embodiment in connection with preparing RFID labels for tissue samples;

FIG. 17 is a flowchart of processing steps that may be performed in an embodiment in connection with processing prepared slides using RFID labels;

FIG. 18-22 are example representations of different types of codes that may be used in connection with encoding information in labels;

FIG. 23 is an example illustrating placement of bar codes on slides;

FIG. 24 is an example arrangement of slides using bar code labels;

FIGS. 25 and 26 are examples of embodiments of slide arrangements with bar code labels;

FIG. 27 is an arrangement of a reagent holder illustrating use of labeling techniques described herein;

FIG. 28 is an illustration of how bar codes may be used to obtain case information;

FIG. 29 is an example of an embodiment of a system illustrating the use of selective data synchronization and data sharing by hosts;

FIG. 30 is an example representation of a configuration screen shot that may be displayed in connection with selection of configuration options;

FIG. 31 is an example illustrating an embodiment of a batch scheduler;

FIG. 32 is a flowchart of processing steps that may be performed in an embodiment in connection with collating slides;

FIG. 33 is an example of an embodiment of a system illustrating remote access and cross host case reporting;

FIG. 34 is an example representation of an embodiment of a template that may be used in connection with automating processing for retesting;

FIGS. 35 and 36 are exemplary embodiments of systems using the techniques herein;

FIG. 37 is a representation of a workstation configuration;

FIG. 38 is another representation of an embodiment of a system using the techniques herein;

FIG. 39 is a representation of the portions included in the harmonized identifiers;

FIG. 40 is a hierarchical representation of the different portions that may be used in generating the different harmonized identifiers;

FIG. 41 is a representation of the different components and workflow processing points that may be included in a laboratory utilizing techniques herein;

FIGS. 42 and 43 are flowcharts of processing steps that may be performed in connection with processing specimens in a laboratory; and

FIGS. 44 and 45 illustrate examples of checkpoint notification.

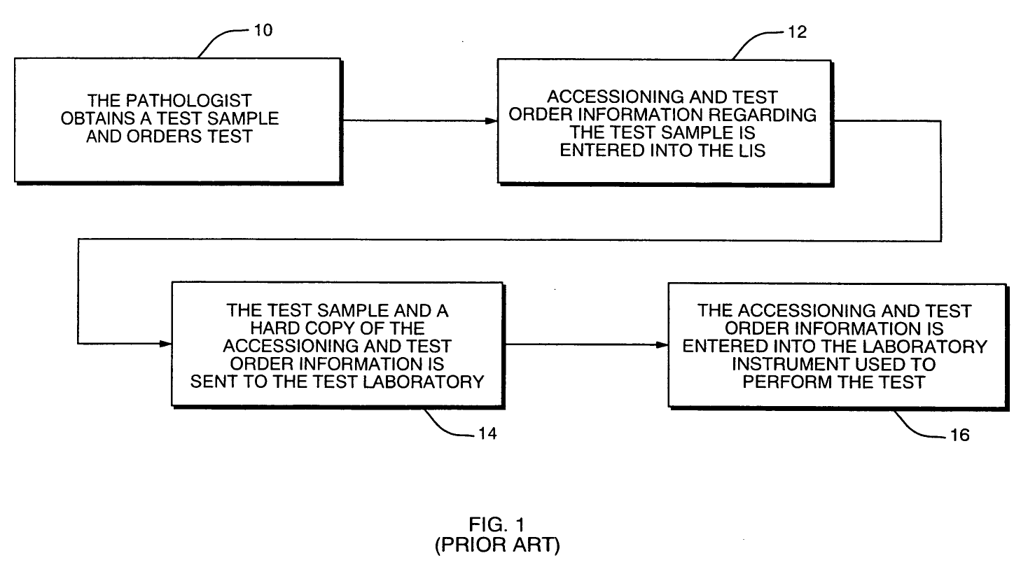

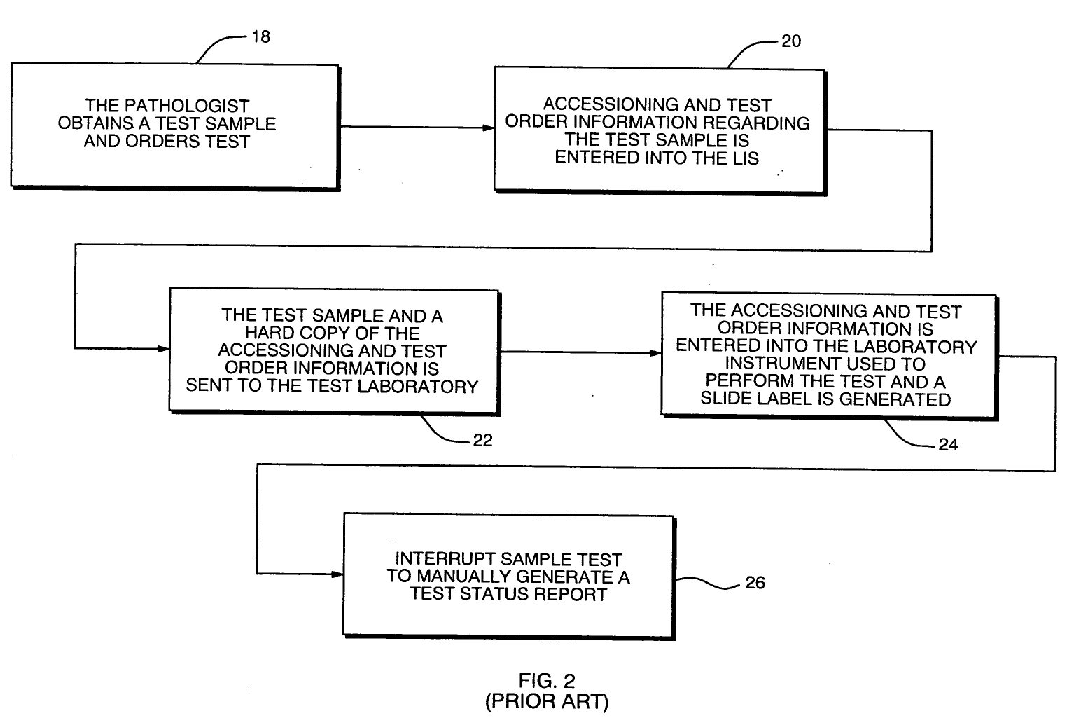

### DETAILED DESCRIPTION OF VARIOUS EMBODIMENTS

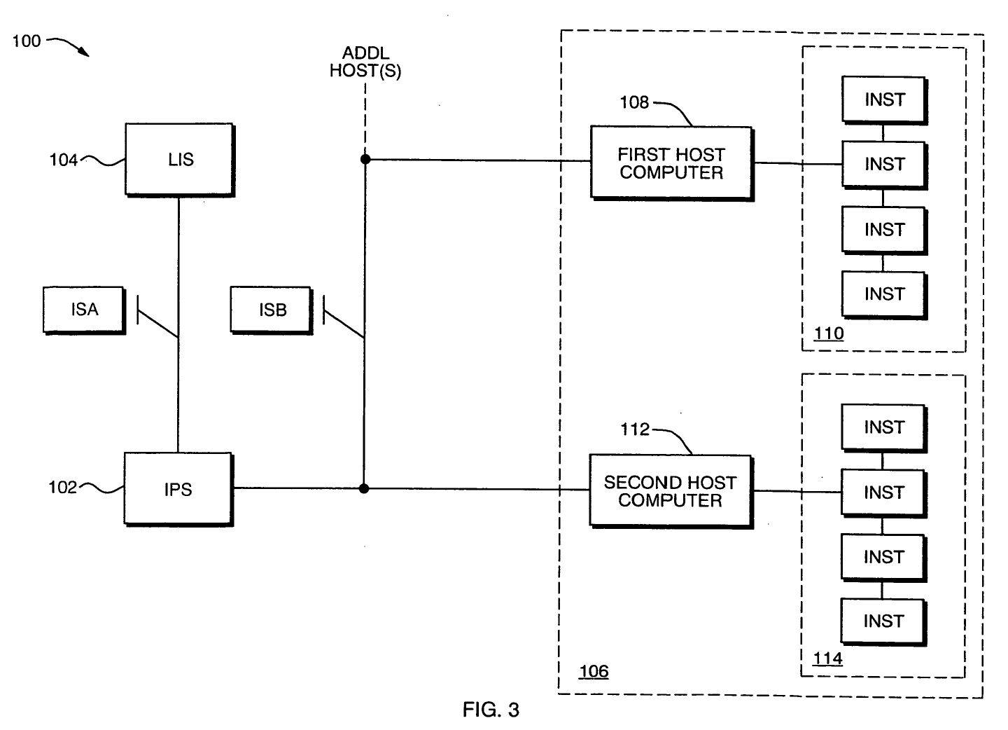

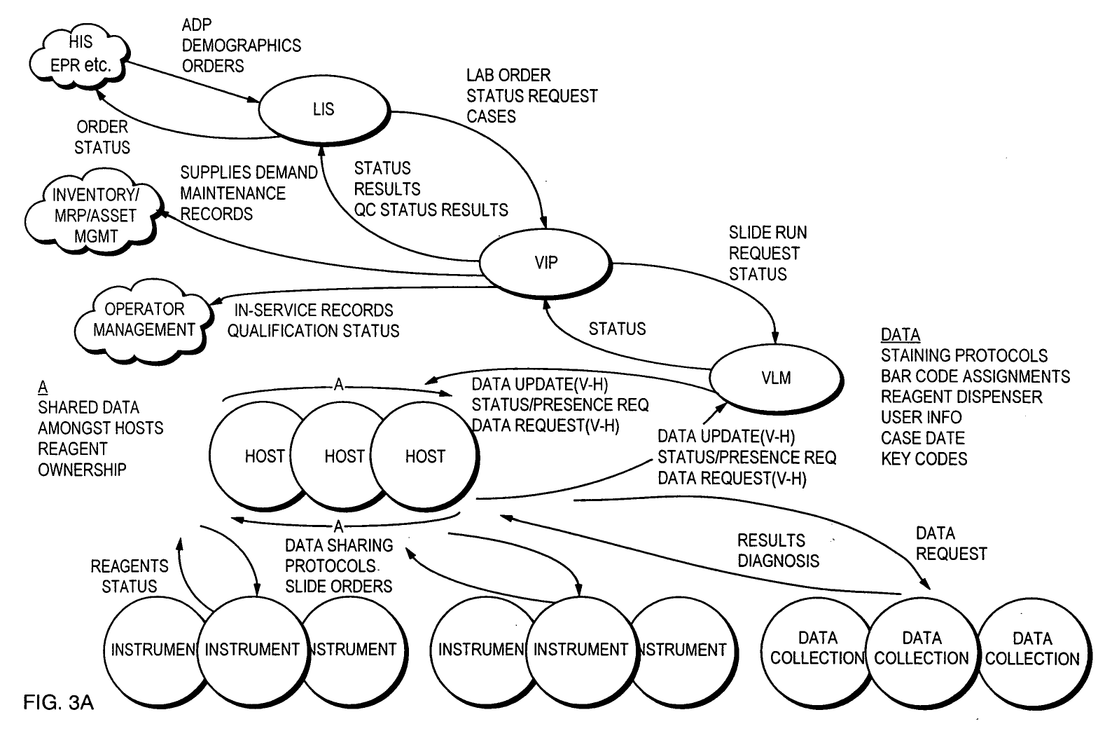

Referring to FIG. 3, an Interface Point Network (according to an illustrative embodiment, IPN) 100 is provided and includes an Interface Point Server (IPS) 102 in communication with at least one hospital Laboratory Information System (LIS) 104 and a network of host computers 106. The network of host computers 106 includes a first host computer 108 communicated with a first plurality of laboratory instruments 110 and a second host computer 112 in communication with a second plurality of laboratory instruments 114. The host computer(s) may be interconnected with the laboratory instrumentation via known Ethernet connection or by other interconnectivity mechanisms known in the art, such as known serial or parallel connections or wireless connection. IPS 102 includes Interface Software B (referred to herein synonymously as “ISB” or “Ventana Lab Manager” or “VLM” software), that allows for the performance of automatic functions related to the management of data between network of host computers 106, such as the sharing of data elements between the first host computer 108 and second host computer 112 without difficulty or undesired data transmittal even if the first host computer 108 is one type of host computer and second host computer 112 is a different type of host computer. It should be noted that an embodiment may include an IPS configured without a connection to the LIS to aid in non-patient information between host computers.

The VLM software in the illustrative embodiment runs on the IPS 102. The main purpose of the VLM software is to facilitate the replication of data over a network between host systems. In an illustrative embodiment described herein the host systems are PCs interfaced to known automated slide staining apparatus such as available from Ventana Medical Systems of Tucson, Ariz. The data handled by the VLM can be of many types, such as staining protocols, bar code assignments, reagent dispenser information, reagent ID, reagent consumption, reagent ownership or registration with a particular instrument, user passwords, case data, Patient ID or name, institution, order requester, accession ID, slide ID, operator ID, operator in-service status, operator quality control (QC) status, instrument QC status, inspection results, diagnosis results and/or staining results. VLM is a piece of software that resides on a PC connected to a network that can provide services to instrument 110, 114 host systems 108, 112. In this embodiment the VLM resides on the IPS 102, however it should be appreciated that the VLM software could reside on one or more of the hosts 108, 112 or be otherwise distributed in the network. Standard TCP/IP protocols are used to connect each instrument host computer with the VLM on the IPS 102. When the VLM software first comes online, it broadcasts a message to all devices on the network proclaiming its presence. If a host is configured to use VLM services, it can then connect with the VLM and request the latest data elements known to the VLM or it can share new data elements with the VLM, making them available to other host computers 108, 112. Typically, in a lab situation, such as in the illustrative embodiment, data sharing among automated slide staining instruments would include: staining protocols; user passwords and privileges; reagents (dispensers/vials); cases; keycodes; templates; panels; and 3^{rd} party reagents.

Each host 108, 112 can be independently set up to either share these data elements or not, depending on the individual lab and host requirements. If hosts are sharing data elements, there are algorithms in the software that evaluate which data is the most current, ensuring accurate data replication and avoiding data loss. The VLM initially builds and then holds a copy of the latest data elements being shared by all sharing hosts. It does this with close cooperation of the software in the host systems, which form a partnership with the VLM to make the complete system. Some data elements, most notably reagents, require ownership rights by the host system they are being used on. There is a software messaging system that permits one host to request a transfer of ownership from another host, thereby ensuring that reagent data elements get properly and safely changed (i.e. dispensed amount does not exceed container limits). The architecture of the VLM communication protocol allows a host to continue processing tissue with an owned reagent while the network connection is unavailable. The host may then synchronize with the VLM once a network connection is re-established.

The VLM software can manage data from a disparate group of host computers automatically. For instance, Ventana Medical Systems' NexES, HVS and NeuVision hosts can all share data elements between like systems without difficulty or undesired data transmittal from one host type to another. Data element storage and sharing, as described hereinafter, is implemented in the VLM software that allows for new types of hosts, previously unknown to the VLM, to share new types of data elements using the VLM without requiring software upgrades to the VLM system software. This permits host software to be upgraded independently and share new data elements using existing VLM systems. Another function of the VLM is to provide a web interface to a remote operator that can be used for reporting and status updates for the host systems and the instruments to which the hosts are connected.

The IPS 102 implements data element storage and sharing of data that as delivered from a LIS, in the illustrative embodiment described herein, conforms to an adaptation of the Health Level Seven (HL7) standard for information exchange between medical applications, adapted as described hereinafter. However, it should be appreciated that other predetermined protocols, such as the IEEE 1073 Standard for Medical Device Communication or proprietary protocols designed for medical device communications, can be implemented. As illustrated in FIG. 3, Interface Software A (referred to herein synonymously as “ISA” or “Ventana Interface Point” software or “VIP”) also resides on the IPS 102 and acts as a gateway between VLM and a LIS, which in this illustrative embodiment is implementing HL7. The data handled by the VIP includes case management, stain requests from the LIS, staining status and results back to the LIS. Standard TCP/IP protocols are used to connect with the LIS and VLM. Data mapping is available to permit site to site variations in data formats without custom code changes.

The IPS 102 forms the functional connection between the LIS 104 and the IPN, where the IPN is comprised of the IPS 102, host computers and instruments, all connected into a system. The function of the IPS is logically and structurally partitioned into two pieces, the VLM and VIP, as described hereinbefore. While each of these are comprised of contained software objects, it is the encapsulation of their functionality that enable the system to be scalable—for both increased numbers and types of instruments and for function. For the specific application of laboratory automation, it is especially important as the current state of installed instrumentation, types and purposes of data transmission and sharing and levels of automation will be dynamic.

The illustrative embodiment of a system described herein, therefore, is comprised of hardware entities and software programs that are interfaced through communications protocols and data sharing (generally through the use of databases and extensible binary structures). In addition to the physical representation of FIG. 3, the system can be represented as a data flow, such as illustrated in FIG. 3a

From this perspective, the LIS and other institutional data systems (e.g., HIS, EPR, Inventory management, maintenance management, operator management) represent data resources and management systems that functionally require interaction with the IPN. It is the role of the VIP to provide the gateway interface for this communication with any multiplicity of institutional systems. The advantage of having this encapsulation of function is that it becomes possible to identify and tailor this interface to the needs of a specific site or institution while retaining the key management functions for the IPN in the VLM. In this way, the VIP is the manager for communications to the institution.

Alternately, the VLM provides the functionality to manage the IPN. This set of tasks and their highly unique set of data management and decision processes is encapsulated in the VLM for the purposes of integrating, at an appropriate level, the management functions associated with an entire IPN. Just as a Host is responsible for the management of a single or group of instruments, the VLM must synchronize data, arbitrate staining requests and manage the work flow throughout the IPN. Additionally, the VLM would manage the request and results for the inspection process and ultimately consolidate the laboratory information reporting for a complete order—from initiation through result reporting. Thus the illustrative embodiment provides a multiple tiered architecture, both physical and logical, for the management of workflow, data and status through the laboratory, for example for histology and clinical pathology. It is this tight integration, embodied in the functionally encapsulated modules, that facilitates the adaptation of this system into the highly varied (from site to site) institutional laboratory environment. In illustrative implementations relating to anatomical pathology, the data management method and apparatus described herein may be used to manage work flow, including but not limited to, pathology order placement; slide processing optimization on multiple instruments; slide identification through the process; bar code use; reagent use and supply; reagent sharing between laboratory instruments; operator in-service qualification; operator lock out on failure to meet training of QC requirements; laboratory instrument QC testing; and/or laboratory instrument QC lockout on failure to meet QC requirements.

In the illustrative embodiment involving the automation of a clinical pathology process, just as automation of the staining process provides cost, reliability and efficacy advantages over traditional, manual techniques, the automation of the larger clinical pathology process affords similar advantages. In particular, the ability to fully automate the process from sample preparation through result reporting eliminates labor cost, transcription errors, unnecessary data replication and time required to manually report results, as described hereinbefore.

The IPN forms the backbone for providing this level of automation as it has visibility to the order process into the laboratory, the status of an order as it proceeds through the process and can report back results. The ability to consolidate the preparation, processing, inspection and reporting is highly advantageous in obtaining efficiency and accuracy.

Since the VLM manages orders throughout the process, it forms the centerpiece for this integration. The addition of an automated data collection station for inspection (either fully automatic inspection or pathologist driven inspection with automated data collection) provides the next step in fulfilling the full initiation through reporting function. For automated data collection driven by a pathologist inspection, there can be a multiplicity of methods, such as a computer entry station, touch pad data entry, voice data entry, and interactive video with voice. Such data would become part of the clinical record for the specific order.

Referring still to FIG. 3A, the data flow diagram provides visibility at another level to the functional capabilities of the IPN. The data interactions depicted between the LIS and VIP show the high level nature of the interaction. Specifically, the LIS-VLM data flow is focused on IPN system status, staining orders and reporting results. Additionally, those interactions depicted with other non-LIS institutional entities (e.g., inventory and operator management) are related to material and work flow areas impacting the overall institution.

At a lower level (within the system architecture and specifically as between the VLM and hosts and hosts and instruments), the data objects are of a nature allowing for the management of specific aspects of the IPN operation. For example, some specific interactions deal with data sharing between hosts where staining protocols, bar code assignments and user information is exchanged as required to manage the operation and share common data between hosts and instruments.

At a yet lower level, data is shared between hosts to manage specific operating criteria that affect individual instruments. An example of this is reagent ownership, where a particular instrument claims ownership for a specific dispenser. Additionally, the addition of data collection stations to the IPN leverage the data hierarchy design by enabling the allocation and management of orders and reporting of results (which are the critical objects for data collection).

It is this hierarchy, the control exerted by individual entities in the IPN and the appropriate level of data sharing, exchange and storage that provides the efficient partitioning of functionality and data management within the IPN. The model of encapsulating function and associated data at an appropriate level is efficiently applied to this large scale system via the IPN and architecture as described.

Data sharing and storage in (general) is provided one of two ways, relating to the nature of which system entity drives the sharing functions. The ways in which this can occur (for the Host-VLM relationship) is for either the VLM or the host systems to control the active sharing of data over the IPN. In considering an optimal design for sharing and storage, it is critical to consider the nature of the designed functional encapsulation (as discussed hereinbefore with respect to the VIP and VLM as part of the IPS). As a general rule, the entity that has the most ‘knowledge’ of data requirements is best suited to drive the sharing and storage rules. In the case of the VLM and host computers, the overall detail of function relating to management of reagents and staining recipes is encapsulated in the host computers and consequently, they drive the sharing paradigm from a ‘push’ perspective—deciding what data is shared and when. In this way, the prioritization and actual actions taken to synchronize data is driven from the use case and represents the more efficient of the means of managing data sharing.

In the case of identifying data that the VLM and VIP may manage, a transition occurs where rather than maintaining a synchronized state, it may be more optimal to simply enable ad hoc transactions or status requests as necessary to support the functionality. In this way, the way in which data is managed changes from a maintained synchronized state to one of identifying and requesting data as required for a specific instance. The use of communications protocols tailored to support such transactions (e.g., HL-7) is highly appropriate for these types of data requirements.

As is known in the art, HL7 is an American National Standards Institute (ANSI) accredited standard that governs the exchange, management and integration of data in order to support clinical patient care and the management, delivery and evaluation of healthcare services. Adaptation and implementation of the HL7 standard allows new types of data elements to be shared without requiring software upgrades to IPS 102, thus allowing the software on first host computer 108 and second host computer 112 to be upgraded independently while sharing new data elements using existing IPS 102. For example, if first host computer 108 and second host computer 112 are disposed within the network of host computers 106 and are sharing data elements, then in order to avoid data loss the ISB in IPS 102 may include algorithm(s) to ensure that accurate data replication occurs. These algorithm(s) may accomplish this by allowing IPS 102 and network of host computers 106 to work in close cooperation with each other to evaluate which data elements being shared by first host computer 108 and second host computer 112 are the most current and by building and retaining a copy of these data elements. In essence, a “partnership” is formed between network of host computers 106 and IPS 102 and is explained in more detail hereinafter.

It should be appreciated that some data elements, such as those elements regarding reagents in an IPN with automated staining instrumentations, require that the host system have ownership rights to those elements and as such a software messaging system is provided to allow one host computer to marshal these elements, or request a transfer of ownership of these elements, from another host computer. The marshalling of data elements is explained in greater detail hereinafter. This ability to marshal data elements ensures that those data elements that require ownership rights get properly and safely changed to remain within predetermined limits (e.g. dispensed amount does not exceed container limits).

As described briefly above, HL7 is a standard that governs the exchange, management and integration of data between independent applications. As such, HL7 is an open messaging standard governing a method for moving clinical data between independent medical applications. HL7 is designed to enable data communications across a network in real-time, and is described in detail in the HL7 specifications, available from the Health Level Seven organization, Ann Arbor, Mich., which specifications are incorporated herein in the entirety. An implementation of HL7 is used, as described hereinafter, to communicate between the LIS and the single point server IPS 102, and ultimately with the host computer(s) 108, 112 and instruments 110, 114.

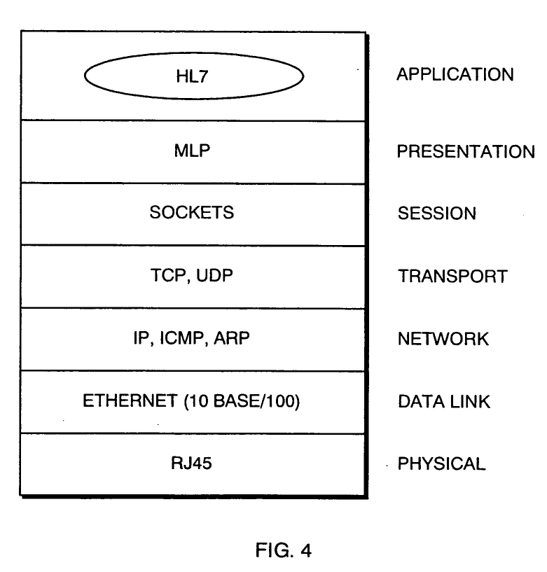

Referring to FIG. 4, a high level block diagram illustrating a multi-layer (i.e. seven layer) software architecture is shown and includes a first level or “physical level,” a second level or “data link level,” a third level or “network level,” a fourth level or “transport level,” a fifth level or “session level,” a sixth level or “presentation level” and a seventh level or “HL7 application level.”

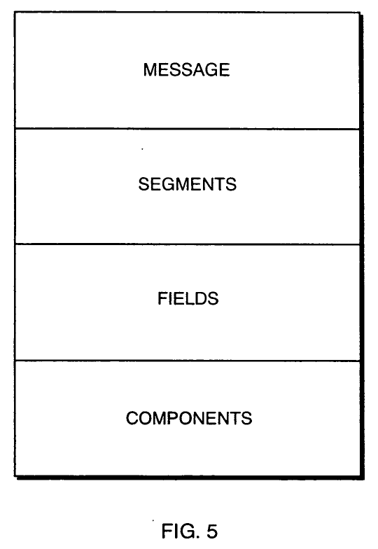

The term “Level Seven” refers to a multi-level (i.e. seven level) software architecture scheme developed by the International Standardization Organization (ISO) and is an application-to-application interface. This means that HL7 defines specification protocols for level 7 functions only (hence, application-to-application interface) and does not define specifications for the remaining six (6) supporting levels. HL7 specifies the type of data to be exchanged, the timing of these communications and the treatment given certain predefined application-specific errors, such as patient demographic information, orders from physicians to the laboratory, test results from the lab to the physician, billing information and enterprise-wide scheduling. FIG. 5 illustrates an additional high level block diagram showing the established hierarchy that governs the construction of an HL7 message and includes a plurality of elements, such as a “components element,” a “fields element,” a segments element” and a “message element.”

The overall HL7 standard is quite broad and supports a central patient care system as well as a distributed environment with departmental data. For example, specific interfaces or messages covered by the standard include patient admissions/registration, discharge or transfer (ADT) information; queries; resource and patient scheduling; orders, status results and clinical observations; billing; master file update information; medical records and patient referral and patient care. Although each of these interfaces or messages may be handled by this standard, for purposes of explanation only the Automatic Test Ordering (OML), Automatic Status Updates (OUL) and Master File Transfer (MFN and MFQ) messages, as implemented in the context of the interface point network, will be addressed in this detailed description. Each of these messages is described separately below.

It should be appreciated that the term “message,” as used herein, refers to a group of segments in a defined sequence, the message is the atomic unit of data transferred between systems and each message has a message type that defines its purpose. Similarly, the term “trigger events” refers to real-world events that initiate a message. The trigger event is a code that represents a value, such as an order event and involves a one-to-many relationship between message types and trigger event codes. Thus, although a trigger event code may be associated with only one message type, a message type may be associated with multiple trigger event codes. Moreover, the term “extraneous message segments” refer to those segments that are “Ignored” or “Not Used.” Although it is preferred that Ignored or Not Used message segments not be included in an HL7 message, it is not a requirement. As such, when present no data validation is performed on Ignored message segments.

Automatic Test Ordering Message

The ordering message, or Automatic Test Ordering (OML) message, is a unidirectional message used to send accessioning information and test orders from the LIS to the laboratory instrument. HL7 includes bi-directional message/acknowledgement communication message pairs. It should be noted that unidirectional messaging may be used to characterize the flow of information, for example, as may be originated by the LIS and sent to the IPS. The OML message applies to new orders and may not be used to cancel or modify existing orders. The OML message typically includes a plurality of key message segments that include a Message Header (MSH) segment, a Patient Identification (PID) segment, a Patient Visit (PV1) segment, a Specimen and Container (SAC) segment for information relating to the tissue sample, a Common Order (ORC) segment for adding new test orders, an Observation Request (OBR) segment to allow the LIS to request an order and a Message Acknowledgement (MSA) segment to allow for the receipt of any sent messages. The MSH segment, SAC segment, ORC segment and OBR segment are required fields and must contain valid information. The PV1 segment is optional and may or may not include information and the PID segment is a conditional field which is required only if the PV1 segment is completed.

Example of an OML Test Order Message

```
MSH|\hat{ }~\&|MFN|LIS_APP|APLAB|VIP|APLAB|2002120211
    26|| OML\hat{ }O21|MSG03219|P|2.4|<cr>
PID|||112234\hat{ }\hat{ }\hat{ }METRO HOSPITAL~98223\hat{ }\hat{ }\hat{ }SOUTH
    LAB||Everyman\hat{ }Adam||19600614|M||C|2101
    Webster # 106\hat{ }\hat{ }Oakland\hat{ }CA\hat{ }94612|
PV1||O|||||0148\hat{ }ADDISON,JAMES|0148\hat{ }ADDISON,JAMES
    |0148\hat{ }ADDISON,JAMES|AMB|||||||0148\hat{ }ADDISON,
    JAMES|S|1400|A|||||||||||||||||||GENHOS|||
    |||<cr>
SAC|||S03-13241A<cr>
ORC|NW|5212498721A|||ID|B~E<CR>
OBR|1|5212498721A||295\hat{ }DAB
    Paraffin\hat{ }STAIN|||199807240826|||||||||||Sergical
    Specimen<CR>
ORC|NW|S03-00234B\hat{ }LAB|||||\hat{ }\hat{ }\hat{ }\hat{ }\hat{ }R<CR>
OBR|1|S03-
    00234B\hat{ }LAB||111\hat{ }iVIEW\hat{ }STAIN|||199808101444|
    |||A||||XXX<CR>
SAC||S03-
    00241A\hat{ }LAB||||SER|19980620081107|U\hat{ }UNKNOWN<
    cr>
ORC|NW|S03-00241A\hat{ }LAB|||||\hat{ }\hat{ }\hat{ }\hat{ }\hat{ }R<CR>
OBR|1|S03-
    00241A\hat{ }LAB||640\hat{ }AFB\hat{ }STAIN|||199808101444|||
    |A||||SER<CR>
ORC|NW|S03-00241A\hat{ }LAB|||||\hat{ }\hat{ }\hat{ }\hat{ }\hat{ }R<CR>
OBR|1|S03-
    00241A\hat{ }LAB||642\hat{ }IRON\hat{ }STAIN|||199808101444||
    ||A||||SER<CR>
```

The SAC segment includes the data necessary to maintain the containers that are being used throughout the Laboratory Automation System and includes three (3) segment attribute fields: an external accession identifier field, an accession identifier field and a container identifier field. The external accession identifier field includes data that is used to identify the laboratory specimen based upon an identifier provided by an outside facility. The accession identifier field includes data that is used to identify the laboratory specimen based upon an identifier provided by the laboratory performing the tests. It should be noted that the accession identifier field may or may not contain data referring to more than one container. The container identifier field includes data that assigns a unique identifier to the container. A container may hold a primary (original) or an aliquot (secondary) sample of that specimen. For a primary sample, this field includes a Primary Container ID and for bar-coded aliquot samples, this field includes an Aliquot Container ID. In the event an aliquot sample is non-bar-coded, this field remains empty or filled with default data.

The ORC segment is used to transmit fields that are common to all requested services and includes six (6) segment attribute fields: an Order Control (ORC-1) attribute field, a Placed Order (ORC-2) attribute field, a Filled Order (ORC-3) attribute field, a Placer Group (ORC-4) attribute field, an Order Status (ORC-5) attribute field and a Response Flag (ORC-6) attribute field.

The ORC-1 attribute field is a required field that determines the function of the order segment and is critical to the operation of both OML and OUL messages. The ORC-1 attribute field includes ORC field values for a New order/service (NW) function, an Order/service accepted & OK (OK) function and an Unable to accept order/service (UA) function. It should be noted that the only valid value in this field for an OML message is NW. The OUL message, however, can have one of two (2) possible values depending on predetermined conditions. If the observation was completed successfully, then the OUL message value should be OK. If the observation was not completed, then the OUL message value should be UA. In this case, the observation segments (OBX) as described below may be examined to determine the cause of the incomplete message. Each order message that defines any type of new order (i.e. ORC-1=NW, OK or UA) requires an ORC/OBR message pair to define each order to the receiving application. This also applies to any other types of orders, with the OBR being replaced by the appropriate order detail segment.

The ORC-2, ORC-3 and ORC-4 attribute fields are optional fields that are typically used to send the sample accession number to the laboratory instrument and are used to identify an individual order. The ORC-2, ORC-3 and ORC-4 attribute fields contain a unique order identifier which is of the Entity Identifier (EI) type, as explained below. It should be noted that although the first component (a string that identifies an individual order) has a suggested, but not required, fifteen (15) character limit, the first component may include any number of characters as defined by the HL7 standard.

The ORC-5 attribute field is an optional field that is used to specify the status of an order, but that does not initiate any action. The ORC-5 attribute field includes five (5) possible values: an “Identifier” (ID) value, an “In Process” (IP) value, an “Order is completed” (CM) value, an “Error, order unable to complete” (ER) value and an “Order is on hold” (HD) value. It should be noted that in some cases it is assumed that the order status always reflects the status as it is known to the sending application at the time the message is sent. It should also be noted that only the filler can originate the value in this field. As such, this field is only valid in the ORL and OUL messages.

The ORC-6 attribute field is an optional field that enables the status update (OUL) and allows the sending application to determine the amount of information to be returned from the filler via one or more OUL messages. The ORC-6 attribute field includes five (5) possible values: a “Report begin of staining run status” (B) value, a “Report end of staining run status” (E) value, a “Report end of imaging run status” (I) value, a null or “Default” (N) value and a “Pointer” (L) value. It should be noted that this field may be repeated with several ID values if multiple OUL messages are desired.

It should be noted that the ORC segment is a required field in an OML message and if an order detail segment is present, the ORC segment is also mandatory in Unsolicited Laboratory Observation (OUL) messages.

The OBR segment is used by the LIS to request an order and includes seven (7) attribute fields: a “Placer Order Number” (OBR-2) attribute field, a “Filler Order Number” (OBR-3) attribute field, a “Universal Service Identifier” (OBR-4) attribute field, an “Observation Data/Time Number” (OBR-7) attribute field, a “Label Template” (OBR-18) attribute field, a “Text” (OBR-19) attribute field and a “Placer Supplemental Service Information” (OBR-46) attribute field.

The OBR-2 attribute field is a conditional field that is identical to the ORC-2 attribute field and is used to identify an individual order. This field is a special case of the EI field as explained below and is conditional in a manner responsive to whether a placer order number is provided in attribute field ORC-2. For example, if a placer order number is not provided in attribute field ORC-2, then OBR-2 is a required field.

The OBR-3 attribute field is a conditional field that is identical to the ORC-3 attribute field and is used to identify an individual order. This field is a special case of the EI field as explained below and is conditional because it is required only in the OUL message and will be the same value as the ORC-3 attribute field. OBR-3 is assigned by the order filling (receiving) application and identifies an order uniquely among all orders from a particular filling application.

The OBR-4 attribute field is a required field that contains the CE data type of the staining protocol that will be performed on the slide. This is based on local protocols defined on the laboratory instrument and may be used by the laboratory instrument to determine which staining protocol to use on the slide.

The OBR-7 attribute field is a conditional field that contains any clinically relevant date/time of observation and is the data that the laboratory system uses to identify what staining protocol to perform on a slide. This field represents the date and time the specimen was first obtained. This field is conditional because when the OBR is transmitted as part of a report message, this field must be completed and it is transmitted as part of a request, then this field may be ignored.

The OBR-18 attribute field is an optional field that is a user-defined string of text that allows the LIS to specify the name of the template to be use when printing the slide label. If the value in this field is “NO LABEL” or is NULL (e.g., “ ”), then a label is not generated. Moreover, this may be used to print the instrument bar code label using alternative label printing resources. If this attribute is null, then the laboratory instrument may use the default label template to print.

The OBR-19 attribute field is an optional field that is reserved for future use. This field may be used for site defined bar code symbology and bar code text to uniquely identify various items, such as slides in a laboratory. This field may also be used to allow the LIS to inform the laboratory instrument of unique text that is encoded in the bar code that will be encountered when reading the bar code.

The OBR-46 attribute field is an optional field that is used to describe details such as what types of imaging protocols should be done on the slide that received the OBR-4 staining protocol. The OBR-46 field contains supplemental service information sent from a placer system to a filler system for the universal procedure code reported in OBR-4 Universal Service ID. This field may be used to provide ordering information detail not available in other fields in the OBR segment. Multiple supplemental service information elements may also be reported. This field may also be used to request Image Protocols (s) for the slide after it has been stained with the protocol requested in OBR-4.

It should be noted that when observations are successfully completed, the message returned to the placer field(s) may include the order segment (OBR) followed by observation (OBX) segments for each distinct observation generated by the order. The number of such observation segments may be dependent upon the number of individual measurements performed in the process. In the OUL message if the observations cannot be performed, e.g. because the Universal Service Identifier doesn't match a known protocol, the placer will receive an OBR-25—result status equal to X (to indicate that the study was not performed). In this case, no observation segments will be transmitted.

The MSA segment includes information sent while acknowledging another message and includes six (6) attribute fields: an “Acknowledgement Code” attribute field, a “Message Control ID” attribute field, a “Text Message” attribute field, an “Expected Sequence Number” attribute field, a “Delayed Acknowledgment Type” attribute field and an “Error Condition” attribute field.

The Acknowledgment Code field is a required field and includes an acknowledgment code that may include at least one (1) of following three (3) values: AA (Original mode: Application Accept—Enhanced mode: Application acknowledgement: Accept), AE (Original mode: Application Error—Enhanced mode: Application acknowledgement: Error) or AR (Original mode: Application Reject—Enhanced mode: Application acknowledgement: Reject).

The Message Control ID field is a required field and includes the message control ID of the message that was sent by the sending system. Also, this may allow the sending system to associate this response with the message for which it is intended. The Text Message field is an optional field that further describes an error condition. This text may be printed in error logs or presented to an end user. The Expected Sequence Number is an optional numeric field used in the sequence protocol. The Delayed Acknowledgment type is optional and may be ignored.

The Error Condition field is an optional field that may allow the acknowledging system to use a user-defined error code to further specify AR or AE type acknowledgments. The Error Condition field may include at least one of the following thirteen (13) values: 0, 100, 101, 102, 103, 200, 201, 202, 203, 204, 205, 206 and 207. An Error Condition value of “0” gives an error text message of “message accepted” and indicates success. This is typically used for systems that must always return a status code and is optional, as the AA conveys success. An Error Condition value of “100” gives an error text message of “Segment Sequence Error” and indicates that the message segments were not in the proper order, or that the required segments are missing. An Error Condition value of “101” gives an error text message of “Required Field Missing” and indicates that a required field is missing from a segment. An Error Condition value of “102” gives an error text of “Data Type Error” and indicates that the field contained data of the wrong data type, e.g. an NM field contained “FOO”. An Error Condition value of “103” gives an error text of “Table value not found” and indicates that a field of data type ID or IS was compared against the corresponding table, and not match was found.

An Error Condition value of “200” returns an error text message of “Unsupported Message Type” and indicates that the message type is not supported. An Error Condition value of “201” returns an error text message of “Unsupported Event Code” and indicates that the event code is not supported. An Error Condition value of “202” returns an error text message of “Unsupported Processing ID” and indicates that the processing ID is not supported. An Error Condition value of “203” returns an error text message of “Unsupported Version ID” and indicates that the version ID is not supported. An Error Condition value of “204” returns an error text message of “Unknown Key Identifier” and indicates that the ID of the patient, order, etc., was not found. This field may be used for transactions other than additions, e.g. transfer of a non-existent patient. An Error Condition value of “205” returns an error text message of “Duplicate Key Identifier” and indicates that the ID of the patient, order, etc., already exists. This field may be used in response to addition transactions (Admit, New Order, etc.). An Error Condition value of “206” returns an error text message of “Application Record Locked” and indicates that the transaction could not be performed at the application storage level, e.g. database locked. An Error Condition value of “207” returns an error text message of “Application Internal Error” and is a catchall for internal errors not explicitly covered by other codes.

Automatic Status Updates

The status results message, or Automatic Status Updates (Unsolicited Laboratory Observation or OUL) message is also a unidirectional message. However, the OUL is generated by the laboratory instrument and received by the LIS to notify the LIS of the specimen status. The OUL message is a response status message that combines the original order request from the LIS with a status update relating to that order request and includes at least two (2) key segments: an OBX segment which is the status of each component of the diagnostic report and a ZSI segment which includes detailed information about the reagents used in the test.

It should be noted that with the segment types OBX and OBR, almost any clinical report may be constructed as a three level hierarchy, with the PID at the upper level, an order record (OBR) at the next level and one or more observation records (OBX) at the bottom. It should further be noted that one result segment (OBX) is transmitted for each component of a diagnostic report and it permits the communication of substance data (lot, manufacturer, etc.) of the reagents and other substances involved in the generation of analysis results in addition to the results themselves via the ZSI segments.

The Observation (OBX) segments allow for the transfer of information regarding run number, start time, end time and error messages and includes at least five (5) OBX attribute fields: a Set ID (OBX-1) attribute field, a Value Type (OBX-2) attribute field, an Observation Identifier (OBX-3) attribute field, an Observation Sub-ID (OBX-4) attribute field and an Observation Value (OBX-5) attribute field.

The OBX-1 field is a required field that contains the sequence number. The OBX-2 field is a required field that contains the format of the observation value contained in OBX-5 field and may include at least one of the following values: OBX-2=NM indicates a numeric format, OBX-2=ST indicates a string format and OBX-2=TS indicates a time stamp format. The OBX-3 field is a required field that includes at least one unique identifier for the observation. This may reflect the staining protocol value in the ORC-4 field, with the exception that when this observation refers to an imaging result, OBX-3 field may reflect the value of one of the image protocols in the OBR-46 field. The OBX-4 field is a required field that may be used to distinguish between multiple OBX segments with the same observation ID organized under on OBR and may be used to categorize the observation segment. The OBX-4 field may include at least one of the values shown in Table 1:

TABLE 1
Observation Sub

| OBX-4 Value | Description |
|---|---|
| HostID | Host ID of the laboratory instrument providing |
| | the service. |
| HostVersion | Software Version of the Providing Host. |
| StainerSerialNumber | Serial number of the laboratory instrument |
| | providing the service. |
| StainerEffectiveType | Effective type of the providing laboratory |
| | instrument. |
| RunNumber | Host's run number assigned to provided service. |
| RunStartTime | Start time of service run. |
| RunEstimatedTime | Estimated number of minutes run is |
| | expected to take. |
| SlidePosition | The position this slide is located on the |
| | laboratory instrument. |
| RunCompletedTime | Actual time service run finished. |
| RunTime | Actual number of minutes run took to run. |
| RunError(n) | Run Error Message (n starts at 1 and increment |
| | for each successive error message. |

The OBX-5 field is a required field that contains a value observed by the observation producer. OBX-2 (Value Type) contains the data type for this field according to which observation value is formatted.

The Substance Identifier (ZSI) segment contains data necessary to identify the substance (e.g., reagents) used in the production of analytical test results and includes at least ten (10) attribute fields. The combination of these fields uniquely identifies the substance and depending upon the manufacturer, all or some of these fields are required. If the analysis requires multiple substances, this segment is repeated for each substance. The ZSI segment allows for the transfer to information regarding the manufacturer of the reagent, the chemical name, the catalogue number, the lot number and expiration and the serial number.

The ZSI segment includes the attribute fields shown in Table 2:

TABLE 2
ZSI Attribute Fields

| ZSI Attribute Field | Description |
|---|---|
| Substance Type | This is a required field that identifies the substance type used for |
| | analysis. It is the group that this substance is in, ANTIBODY, |
| | REAGENT, PROBE or BULK. |
| Substance Name | This is a required field that identifies the substance name used for |
| | analysis. |
| Substance Lot | This is a require field that specifies the lot number assigned by the |
| Number | manufacturer during production of the substance. |
| Substance Lot Serial | This is a required field that specifies the container assigned by the |
| Number/Container | manufacturer during production of the substance. This identifier |
| Identifier | should be unique within specific lots of the substance. |
| Catalog Number | This is an optional field that specifies the Manufacturer's catalog |
| | ordering number. |
| Substance Other | This is an optional field that is used to described additional information |
| Name | about the substance. In the case of Antibodies, it will specify the |
| | Clone Name. In the case of Probes, it will hold the Probe Label type. |
| | In the case of Reagents and Bulk, this field is not used. |
| Substance | This is a required field and identifies the manufacturer of the |
| Manufacturer Name | substance. |
| Expiration Date | This is a required field and identifies the expiration date of the |
| | substance. |
| Received Date/Time | This is a required field and identifies the date the substance was |
| | received. |
| Intended Use Flag | This is an optional field and identifies the manufacturer's intended use |
| | of the substance. This field includes at least four valid values |
| | including: ASR (Analyte Specific Reagent), IVD (In Vitro Diagnostic |
| | (Class 1 Exempt)), 510(K) (Pre-Market 510(K) Cleared) and PMA |
| | (Pre-Market Approved). |

Master File Exchange Message

The master file exchange or master file transfer message is also a unidirectional message and includes two (2) types of messages 1) a Master File Change Notification (MFN) message and a Master File Query (MFQ) message. The master file transfer message is generated by the laboratory instrument and received by the LIS to keep master file information synchronized between the two systems.

The MFQ message allows the LIS to query for a group of records in a particular master file. The MFQ message includes two (2) required segments: a Message Header (MSH) segment and a Query Definition (QRD) segment. The QRD segment is used to define a query and includes ten (10) attribute fields as shown in Table 3.

TABLE 3
QRD Attribute Fields

| QRD | |
|---|---|
| Attribute | |
| Field | Description |
| QRD-1 | This is an optional field that identifies the Query Date/Time. |
| QRD-2 | This field identifies the Query Format Code. |
| QRD-3 | This field identifies the Query Priority. |
| QRD-4 | This is an optional field that identifies the Query ID. |
| QRD-5 | This field identifies the Deferred Response Type. |
| QRD-6 | This field identifies the Deferred Response Data/Time. |
| QRD-7 | This field identifies the Quantity Limited Request. |
| QRD-8 | This field identifies the Who Subject Filter. |
| QRD-9 | This is a required field that identifies the What Subject Filter |
| | and describes the kind of information that is required to satisfy |
| | the query request. Valid values include: PROTOCOL |
| | (Staining Protocols), TEMPLATE (Slide Templates), |
| | ANTIBODY (Logged Antibodies), REAGENT (Logged |
| | Reagent), PROBE (Logged Probes) and BULK |
| | (Logged Bulks) |
| QRD-10 | This field identifies the What Department Data Code. |

The MFQ transaction also includes a Master File Response (MFR) message that includes seven (7) segments: a Message Header (MSH), a Message Acknowledgement (MSA), a Query Definition (QRD), a Master File Identification (MFI), a Protocol Entry (ZVP), a Template Entry (ZVT) and a 3^{rd} Party Chemistry Entry (ZSI), wherein all but ZVP and ZVT are required segments.

The MFI segment is typically used to identify the master file and includes five (5) segment attribute fields as shown in Table 4.

TABLE 4
MFI Attribute Fields

| MFI Attribute Field | Description |
|---|---|
| MFI-1 | Master File Identifier - This is a required field of CE type data that |
| | identifies the database table being affected. A plurality of values are |
| | supported by this field and include: PROTOCOL (Staining Protocols); |
| | TEMPLATE (Slide Template), ANTIBODY (Logged Antibodies), |
| | REAGENT (Logged Reagents), PROBE (Logged Probes) and BULK |
| | (Logged Bulks). |
| MFI-2 | Master File Application Identifier - This is an optional field that |
| | defines the optional code for which the application is responsible for |
| | maintaining and may include a valid value, such as VIP. |
| MFI-3 | File-Level Event Code - This is an optional field that identifies the file |
| | level event code and may include a valid value, such as UPD, where |
| | UPD is a file level event code described as Change file records as |
| | defined in the record-level event codes for each record that follows. |
| MFI-4 | Entered Date/Time - This is an optional field that identifies the time |
| | stamp for file level events. |
| MFI-5 | Effective Date/Time - This field may be ignored because all Master |
| | File transactions are posted as effective when they are received. |

The ZVP segment is used to enter master file protocol information and includes three (3) segment attribute fields as shown in Table 5.

TABLE 5
ZVP Attribute Fields

| ZVP Attribute Field | Description |
|---|---|
| ZVP-1 | Staining Protocol Identifier - This is a required field of CE type data |
| | that identifies the Name, Number and Platform Type of the Protocol. |
| | A plurality of values are supported by this field and include: My |
| | Protocol (ID = 255, STAIN); Image Protocol (IMAGE), Protocol 2 |
| | (ID = 222, STAIN) and AFB (ID = 640, STAIN). It should be noted |
| | that the numeric ID value range should fall between 0 and 999. |
| ZVP-2 | Modified Date/Time - This is a required field that identifies the date |
| | this protocol was last modified |
| ZVP-3 | Procedure Name - This is an optional field of ST type data that |
| | identifies the Procedure that the specified Protocol is derived from. |

The ZVT segment is used to enter master file template information and includes two (2) segment attribute fields as shown in Table 6. It should be noted that the ZVT segments are only used when the field type in the MFI-1 segment field is set to template.

TABLE 6
ZVT Attribute Fields

| ZVT Attribute | |
|---|---|
| Field | Description |
| ZVT-1 | Template Name - This is a required field of ST type |
| | data that identifies the Name of the Label Template. |
| ZVT-2 | Entered Date/Time - This is a required field of TS type |
| | data that identifies the date this template was last |
| | modified |

The ZSI 3^{rd} party Chemistry/Substance segments are user-defined segments that are only used when the field type in the MFI-1 segment field are set to ANTIBODY, REAGENT, PROBE or BULK.

The MFN messages are generated to synchronize laboratory instrument protocols, slide label templates and 3^{rd} Party Chemistry with other systems and include a Master File message and a Master File Acknowledgment message. The Master File message may be used to accept third party chemistry information that may be used with user-fillable dispensers and includes six (6) segments: a Message Header (MSH) segment, a Master File Identification (MFI) segment, a Master File Entry (MFE) segment, a Protocol Entry (ZVP) segment, a Template Entry (ZVT) segment and a 3^{rd} Party Chemistry Entry (ZSI) segment. All of these segments are required with the exception of the ZVP segment and the ZVT segment which are not used during the import procedure.

The Master File Acknowledgment message is used to acknowledge receipt of a Master File message and includes two (2) required segments: a Message Header (MSH) segment, an Acknowledgment (MSA) segment, and one (1) optional segment: an Error (ERR) segment.

The MFE segment is a required segment that repeats several data elements from the ZVP, ZVT and ZC3 segments. The MFE segment is used to indicate the Record-Level Event Code during import and export operations which will indicate whether a record has been added, deleted or updated and includes five (5) segment attribute fields as shown in Table 7.

TABLE 7
MFE Attribute Fields

| MFE Attribute | |
|---|---|
| Field | Description |
| MFE-1 | Record Level Event Code - This is a required field of ID type data |
| | that defines the record-level event for the master file record identified |
| | by the MFI segment and the primary key field in this segment. Valid |
| | values for this field include: MAD (Add record to master file), MDL |
| | (Delete record from master file) and MUP (Update record for master |
| | file). It should be noted that if the file-level event code is “REP” |
| | (MFI - 3 replace file), then each MFE segment must have a record- |
| | level event code of “MAD” (add record to master file) in this field. |
| MFE-2 | MFN Control ID - This field may contain data of TS type. |
| MFE-3 | Effective Date/Time - This is an optional field of TS type data that |
| | identifies the date and time the change took place. |
| MFE-4 | Primary Key Value - This is a conditional field that uniquely identifies |
| | the record of the master file (identified in the MFI segment) to be |
| | changed (as defined by the record-level event code). This field is |
| | required when the value of MFE-1 is equal to MDL or MUP. |
| MFE-5 | Primary Key Value Type - This is a conditional field that contains the |
| | HL7 data type of MFE-4. Valid values for this field include: |
| | PROTOCOL (Staining Protocols), TEMPLATE (Slide Templates), |
| | ANTIBODY (Logged Antibodies), REAGENT (Logged Reagents), |
| | PROBE (Logged Probes) and BULK (Logged Bulks). This field is |
| | required when the value of MFE-1 is equal to MDL or MUP. |

In an illustrative implementation wherein the lab instruments 110, 114 (FIG. 3) include automated slide staining, in order to provide an editable mechanism to allow received HL7 messages to be transformed and mapped to slide data elements, an editor with a GUI interface is implemented to allow a user to build and test a transform script that consists of rules for processing HL7 messages.

This mechanism provides an object that can both perform routine HL7 message transformations for using a live transform script and also maintain a transform script that is being actively edited and is not live.

The field mapper function resident in the IPS 102 (FIG. 3), revolves around a single object that will: load and hold the live script; permit placing the script in edit mode without losing the live script; permit taking an edited script live; save an edited script; and perform routine HL7 transformations using the live script, modifying the case data as required.

The application running on the illustrative IPS 102 will create a field mapper object when required and will use it primarily to process a received HL7 message, resulting in case data being extracted from the HL7 message as required. The field mapper needs to be very flexible so that it can work with a large variety of HL7 message data structures present at customer sites. To accommodate this, processing of message data is codified in script ‘rules’ that consist of an interpreted list of instructions to follow to transform the message data into case data. The IPS 102 handles these processing rules. The following are the 9 slide data fields defined in an illustrative case:
1) Template;
2) PatientID;
3) PatientNAME;
4) Institution;
5) Requester;
6) AccessionID;
7) CaseID;
8) BlockID; and
9) SlideID.

In this illustrative embodiment these are the only possible output fields that can be altered during field mapping transformations. However, it should be appreciated that in other implementations other fields may be defined and processed. The purpose of the field mapper is to fill these data fields with the proper data extracted from the HL7 message.

Those skilled in the art will appreciate that there are numerous but finite HL7 fields present in the HL7 message that can contain data to be harvested by the script.

### Script Language Components:

The script field mapping language will consist of rules coded into lines in the general form:
<target element>=<source element>
   Taken together, slide data fields, HL7 message elements, internal variables and literal strings will be referred to as ‘data types’. Data types can be present in script lines as follows:

| | Target | Source |
|---|---|---|
| Data Type | (Target Data Objects) | (Source Data Objects) |
| Slide Data Field | x | |
| HL7 Message Element | | X |
| Internal Variable | x | X |
| Literal String | | X |

Internal variables are user definable at the time the script is edited and are used to hold results temporarily during script command processing. Internal variables are created automatically when seen and initially have an empty value.

The language editor is the only way that a user can create script commands. This eliminates development of an elaborate parsing engine to handle user-typed script command lines. Even though script commands will be stored in binary format, they will be presented in a format that makes it easy for a user to view. (This displayed format is used below when discussing syntax of the special functions, even though parsing is not required of the command lines presented.)

### COPY Special Function

This function is used to copy the entire contents of one data object and save it to another. The syntax is as follows:

[target data object]=COPY([source data object])

Examples:

If x=‘1234’

[s]=COPY([x])
results in ‘1234’

### EXTRACT Special Function

This function is a very flexible string extraction function that can be used to mine delimited data from a source data object. Extraction is done using a defined delimiter string and a starting and ending delimiter count. This function allows data to be extracted in various ways such as the left-most, right-most or mid-string. Extraction starts from characters beginning with the starting instance count of the delimiter string, excluding the actual starting delimiter string. Extraction ends with the ending instance count of the delimiter, not including the actual ending delimiter string.

The syntax is as follows:

[target data object]=EXTRACT([source data object], delimiter string, starting index count, ending instance count)

Delimiter strings can be any non-blank string the user types in.

Starting and ending index counts can be any positive integer value. Delimiter counts of 0 have special meaning and depend on where they are found. When a 0 is found in the starting instance count this means to start the extraction from the start of the data object. When a 0 is found in the ending instance count this means to end the extraction at the end of the data object. In other words, using 0 for a starting instance count means take the left part of the data object, which using 0 for a ending instance means to take the right side of the data object.

Examples:

[x]=EXTRACT([‘1234-567-1111-9999’], ‘-’, 1, 2)
results in ‘567’

[x]=EXTRACT([‘1234-567-1111-9999’], ‘-’, 1, 3)
results in ‘567-1111’

[x]=EXTRACT([‘1234-567-1111-9999’], ‘-’, 0, 2)
results in ‘1234-567’

[x]=EXTRACT([‘1234-567-1111-9999’], ‘-’, 1, 0)
results in ‘567-1111-9999’

[x]=EXTRACT([‘1234-567-1111-9999’], ‘-’, 0, 0)
results in ‘1234-567-1111-9999’
(which is the whole field, actually)

CONCAT Special Function

This function is used to concatenate multiple source data objects together to make a long string to assign to the target data object. The syntax is as follows:

[target data object]=CONCAT([source data object 1], [source data object 2], [source data object 3], [source data object 4])

There can be 1-4 source data objects; 3-4 are optional. The contents of the source data objects are simply concatenated together to form the result. If more than 4 source data objects need to be concatenated together, an interim result could be stored in an internal variable and more CONCAT commands could follow to continue the concatenation.

Examples:

If x=‘1234’, y=‘567’, z=‘1111’

[s]=CONCAT([x], [‘-’], [y])
results in ‘1234-567’

[s]=CONCAT([s], [‘-’],[z])
results in ‘1234-567-1111’

### LEFT Special Function

This function is used to extract a certain amount of characters from the left side of the data object. The syntax is as follows:

[target data object]=LEFT([source data object], # characters)

Examples:

If x=‘1234’

[s]=LEFT([x], 3)
results in ‘123’

### RIGHT Special Function

This function is used to extract a certain amount of characters from the right side of the data object. The syntax is as follows:

[target data object]=RIGHT([source data object], # characters)

Examples:

If x=‘1234’

[s]=RIGHT([x], 3)
results in ‘234’

### MID Special Function

This function is used to extract a certain amount of characters from the middle of the data object. The syntax is as follows:

[target data object]=MID([source data object], starting position, # characters)

Starting position is the character position to start extracting characters. The number of characters is how many characters to extract.

Examples: If x=‘1234’

[s]=MID([x], 2, 2)
results in ‘23’

Data Storage

Field mapping scripts will be stored in binary format on disk, and will be retrieved as required and stored as changed. The file format will not be human readable, by design. There will be data integrity features built into the file format such that data corruption will be apparent upon retrieval from disk so that invalid scripts will be readily identifiable and will not be executed. More specifically, data will be stored in encrypted, autowrapped CodeSafe streams.

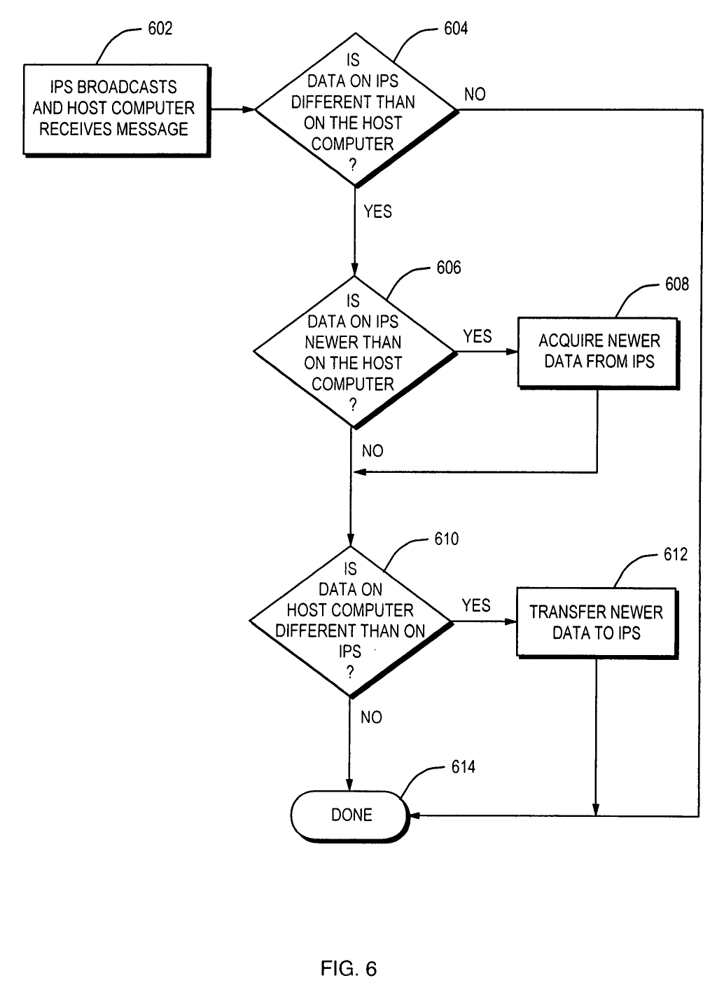

Referring now to FIG. 6, a high-level block diagram generally illustrating a host/IP data synchronization method 600 is shown and described as follows, with respect to the IPN illustrated and described hereinbefore with respect to FIG. 3. As described in more detail below, when IPS 102 first connects to IPN 100, IPS 102 begins to periodically broadcast a message to all of the devices on IPN 100, such as first host computer 108 and second host computer 112, to inform each of these devices that IPS 102 has connected to IPN 100, as shown in block 602. This message is of a User Datagram Protocol (UDP) type that is broadcast globally over the entire IPN 100 and includes information on what data is present on IPS 102. It should be appreciated that once IPS 102 connects to IPN 100 any host computer on IPN 100 that is configured to use IPS 102 services may then perform various functions, such as connecting with IPS 102 to request the latest data elements known to IPS 102, or sharing new data elements with IPS 102, thus making them available to network of host computers 106. The type of data that may be shared among instruments in a laboratory situation includes: staining protocols, user passwords and privileges, reagents (dispensers/vials), bulk fluids, cases/keycodes, templates, panels and 3^{rd} party reagents. Each host computer in network of host computers 106 may be independently set up to either share or not share data elements, responsive to predetermined conditions, such as individual laboratory and/or computer host requirements.

Upon receiving this broadcast message, network of host computers 106 determines if the data on IPS 102 is different than the data on network of host computers 106, as shown in block 604. This may be accomplished by first host computer 108 comparing the data present on IPS 102 with the data present on first host computer 108 and second host computer comparing the data present on IPS 102 with the data present on second host computer 112. If the data present on both first host computer 108 and second host computer 112 is the same as the data present on IPS 102, then the synchronization process is complete, as show in block 614. However, if the dataset on network of host computers 106 is different from the dataset present on IPS 102, then network of host computers 106 initiates a synchronization protocol to transfer a copy of IPS 102's version of the data element to data sets on the hosts. However, if the dataset on network of host computers 106 is newer than the dataset on IPS 102, then the dataset on IPS 102 is updated with a copy of the version of the data elements from the host computers 106.

For example, if the dataset on IPS 102 is different, in whole or in part, from the dataset on first host computer 108, then first host computer 108 determines if its dataset is older than the dataset on IPS 102, as shown in block 606. This may be accomplished by first host computer 108 comparing its dataset with the dataset on IPS 102. If the dataset on first host computer 108 is older than the dataset on IPS 102, then the portion of the dataset on IPS 102 that is newer is acquired by first host computer 108, as shown in block 608. Once this has been accomplished, or if the dataset on first host computer 108 is not older than the dataset on IPS 102, then first host computer 108 determines if its dataset is newer than the dataset on IPS 102, as shown in block 610. As above, this may be accomplished by first host computer 108 comparing its dataset with the dataset on IPS 102. If the dataset on first host computer 108 is newer than the dataset on IPS 102, then the portion of the dataset on host computer 108 that is newer is transferred by first host computer 108 to IPS 102, as shown in block 612. Once this has been accomplished for each host computer on the entire IPN 100, then the synchronization process is complete, as shown in block 614.

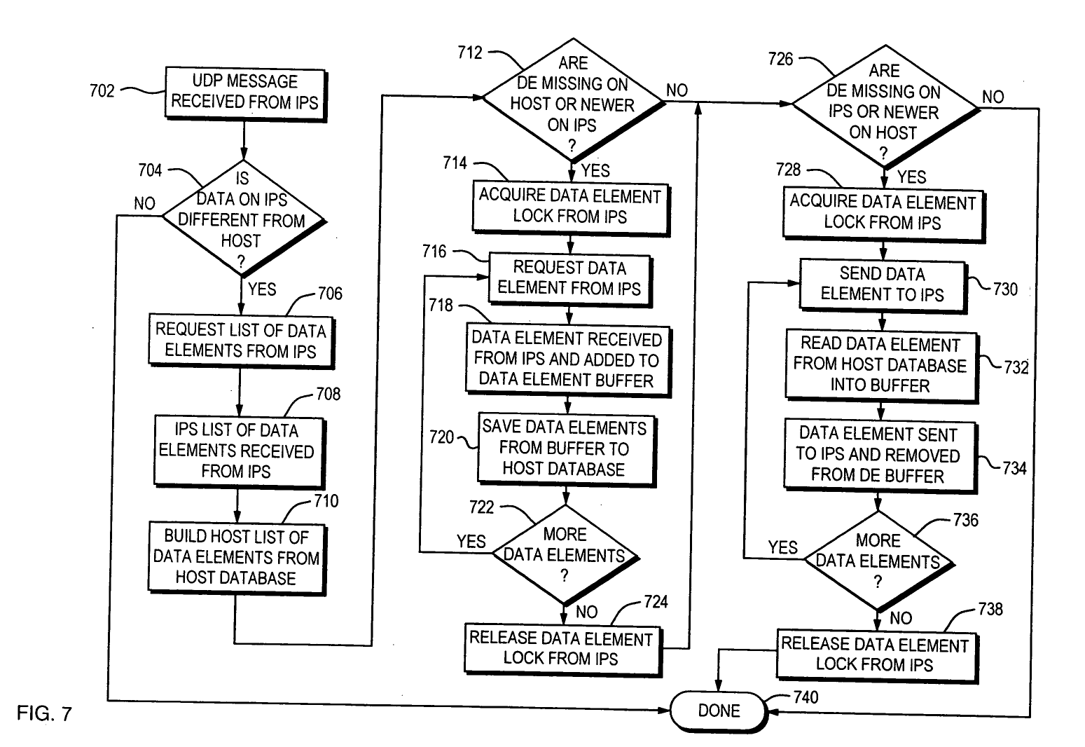

Referring to FIG. 7, a low-level block diagram illustrating a host-side data element synchronization method 700 is shown and described as follows. Although the method of FIG. 7 is described in relation to first host computer 108, it should be appreciated that the method of FIG. 7 applies to each host computer in the plurality of host computers 106. As briefly described above, when IPS 102 first connects to IPN 100, IPS 102 begins to periodically broadcast a UDP message to all of the devices connected to IPN 100 to synchronize the information on all of the devices connected to IPN 100, in this case first host computer 108, as shown in block 702. This UDP message includes an IPS protocol version number as well as information regarding the data present on IPS 102, such as the timestamp or date of that information. When first host computer 108 receives this message, first host computer 108 determines whether its dataset is different from the dataset contained on IPS 102, as shown in block 704. This may be accomplished by comparing the IPS protocol version number contained in the UDP message with the protocol version number on first host computer 108. If the protocol version numbers match then the dataset on IPS 102 is the same as the dataset on first host computer 108 and Host-Side Data Element Synchronization method 700 is completed, as shown in block 740.

However, if the protocol version numbers do not match then the dataset on IPS 102 is different from the dataset on first host computer 108 and first host computer 108 requests the IPS list of data elements (i.e. table of contents) from IPS 102, as shown in block 706. Upon receipt of this request, IPS 102 sends and first host computer 108 receives the IPS list of data elements, as shown in block 708.

First host computer 108 builds a list of host data elements contained on first host computer 108, as shown in block 710 and compares the list of host data elements with the IPS list of data elements to determine if any data elements on first host computer 108 are missing or older than the data elements on IPS 102, as shown in block 712. If there are data elements on first host computer 108 that are missing or older than the data elements on IPS 102, then first host computer 108 requests and acquires a data element lock from IPS 102, as shown in block 714. In the event that there are multiple host computers, this data element lock allows only one host computer, such as first host computer 108, to access the data elements in IPS 102 without having to worry about other host computers simultaneously accessing and changing a particular data element. Once the data element lock has been acquired, first host computer 108 requests IPS 102 to send the data elements in question, as shown in block 716. When first host computer 108 receives the requested data element, first host computer 108 adds the data element to its data element buffer, as shown in block 718. The data element is then saved from the data element buffer to the host database of first host computer 108, as shown in block 720. First host computer 108 then determines if there are any more data elements on first host computer 108 that are missing or older than the data elements on IPS 102, as shown in block 722. If there are, then blocks 716 to 720 are repeated. Otherwise, first host computer 108 sends a request to IPS 102 to release the data element lock, as shown in block 724.

Upon release of the data element lock or if there are no data elements on first host computer 108 that are missing or older than the data elements on IPS 102, then first host computer 108 compares the list of host data elements with the IPS list of data elements to determine if any data elements on IPS 102 are missing or older than the data elements on first host computer 108, as shown in block 726. If there are data elements on IPS 102 that are missing or older than the data elements on first host computer 108, then first host computer 108 requests and acquires a data element lock from IPS 102, as shown in block 728. Once the data element lock has been acquired, first host computer 108 sends the data elements in question to IPS 102, as shown in block 730. First host computer 108 reads the data element from the host database into its data element buffer as shown in block 732 and the data element sent to IPS 102 is removed from the data element buffer, as shown in block 734. First host computer 108 then determines if there are any more data elements on IPS 102 that are missing or older than the data elements on first host computer 108, as shown in block 736. If there are, then blocks 730 to 734 are repeated. Otherwise, first host computer 108 sends a request to IPS 102 to release the data element lock as shown in block 738 and the host-side data element synchronization method 700 is completed, as shown in block 740.

In certain testing situations knowledge of data element location is imperative, such as when dealing with reagents. This situation may be addressed by host side data element marshalling. Referring to FIG. 8, a block diagram illustrating a host-side data element marshalling method 800 is shown and described as follows. When a host computer requires ownership of data elements (e.g. reagents), as shown in block 802, the host computer requests ownership of the data elements by broadcasting a UDP message to IPN 100 requesting ownership of the data elements, as shown in block 804. Each host computer on IPN 100 receives the UDP message, as shown in block 806, and determines if it currently owns the requested data elements, as shown in block 808. The host computer that owns the requested data elements then determines if the requested data element is locked, as shown in block 810. If the requested data element is not locked, then the host computer that owns the requested data element writes information about the requesting host computer into its data element database, including Host ID and Timestamp update, as shown in block 812, effectively transferring ownership of the requested data element to the requesting host.

Once this has been completed or if the host computer does not own the requested data element or if the data element is locked, the host computer determines if all requested data elements have been examined for ownership, as shown in block 814. If not, then blocks 808 to 814 are repeated until all requested data elements have been examined for ownership. If yes, then the host computer determines if ownership of any data elements were transferred to the requesting host computer, as shown in block 816. If not, then host-side data element marshalling method 800 is completed, as shown in block 824. If yes, then the host computer broadcasts the new ownership data elements to the requesting host computer using a TCP/IP message, for example, as shown in block 818. Upon receipt of the new ownership data elements, the requesting host computer sends an acknowledgement message back to the sending host computer, as shown in block 820. The requesting host computer then updates its database with new owner information including incrementing the owner version and resetting the Timestamp, as shown in block 822. Once this has been completed, host-side data element marshalling method 800 is completed, as shown in block 824.

It should be appreciated that this type of direct test ordering performed via HL7 allows for the data entry and labeling functions to be streamlined, thus increasing work flow productivity and quality control. It should further be appreciated that IPS 102 may communicate with LIS 104 and/or network of host computers 106 using standard TCP/IP protocols or any other method suitable to the desired end purpose, such as Internet, Ethernet, Wireless, Local Area Network (LAN), Wide Area Network (WAN), etc. Moreover, the data handled by IPS 102 may be comprised of many types, such as, but not limited to, staining protocols, bar code assignments, reagent dispenser information, user passwords, case management, stain requests from the LIS, staining status and result information sent back to the LIS.

As described above, at least a portion of the methods of FIGS. 6, 7 and 8 may be embodied in the form of computer-implemented processes and apparatuses for practicing those processes. Additionally, at least a portion of methods of FIGS. 6, 7 and 8 may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the techniques described herein. Existing systems having reprogrammable storage (e.g., flash memory) may be updated to implement the techniques described herein. It is contemplated that at least a portion of the methods of FIGS. 6, 7 and 8 may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the techniques described herein. When implemented on a general-purpose microprocessor, the computer program code segments may configure the microprocessor to create specific logic circuits.

It should be appreciated that the network implemented for use with the system and techniques described herein may also allow IPS 102 the ability to provide a web interface to remote operators that may be used for reporting and status updates for network of host computer systems 106 and any laboratory instruments, such as first plurality of laboratory instruments 110 and second plurality of laboratory instruments 114.

An embodiment of a system described herein may use any one or more different encoding technologies to facilitate tracking and identification of slides, reagents and other elements. These technologies include any electromagnetic encodings such as may be used, for example, with optically readable characters such as bar codes, readable and/or writable RFID labels, infrared ID systems, and the like.

As an example, RFID technology may be used in connection with tracking slides, reagents, and the like, and in accessing and managing the information about these elements. An RFID-enabled label may be used in connection with a glass slide, specimen container, or other item or component that may be processed in an automated laboratory environment.

An embodiment may find advantages to using RFID labels over bar codes, as described elsewhere herein. One advantage of RFID labels over bar codes is that RFID does not require line-of-sight to read and write the tag data. Additionally, RF signals are capable of traveling through a wide array of non-metallic materials. Data may be simultaneously captured from many RFID labels within range of an antenna. RFID labels may be encased in different coatings making them extremely durable and able to be tracked through harsh production processes. Also, as described in more detail elsewhere herein, RFID labels are able to support read and/write operations. In an embodiment using writeable RFID labels, real-time information updates may be performed by writing to the RFID label as a tagged item moves through processing steps. In contrast to a bar code which, once printed cannot be re-used, the writeable RFID tags can be re-used with new data.

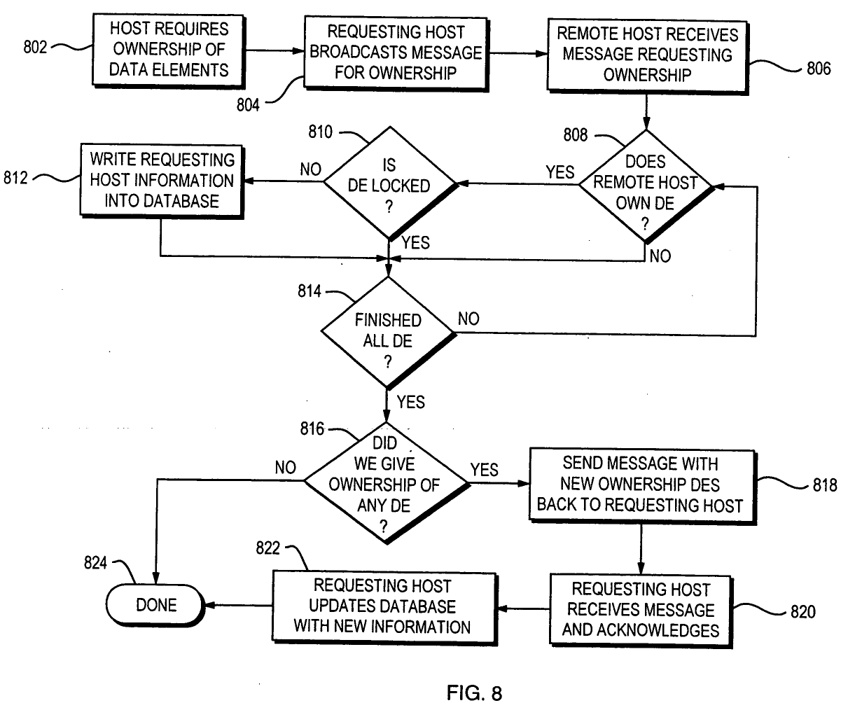

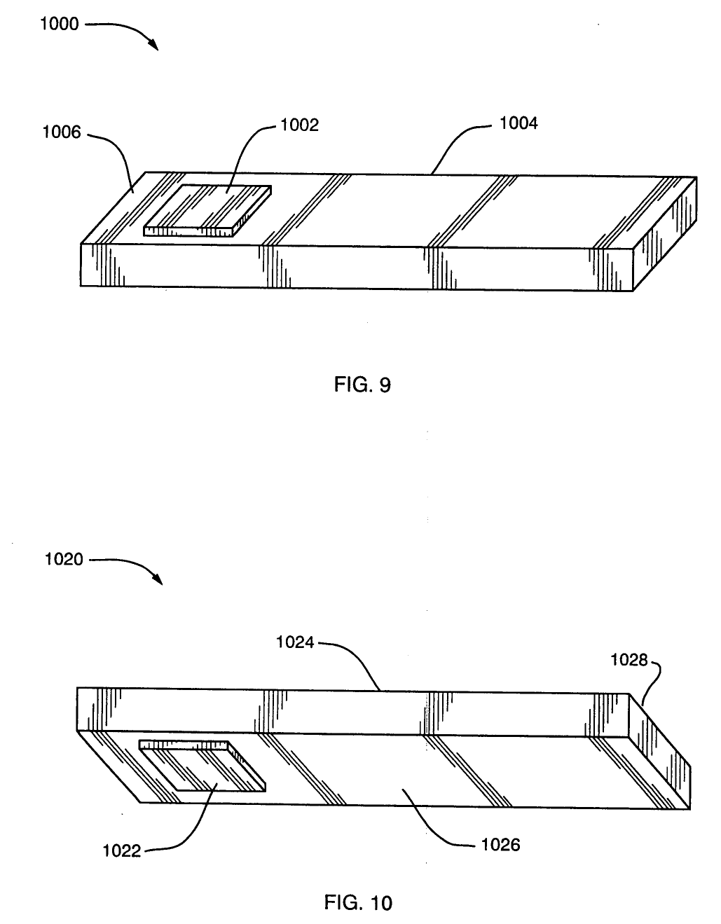

Referring now to FIG. 9, shown is an example of an embodiment 1000 of a slide arrangement. The slide 1004 includes an RFID label 1002. In the arrangement 1000, the RFID label 1002 is affixed to an upper face 1006 of the slide 1004. The slide in this arrangement and others described herein may be, for example, a glass slide. The RFID label 1002 may include information electronically encoded therein as described elsewhere herein. Additionally, a surface of the RFID label 1002 may include printed information such as, for example, human readable text, bar code identifiers, and the like. It should also be noted that an embodiment of an RFID label 1002 may omit the inclusion of text or other type of information on the surface thereof.

Referring now to FIG. 10, shown is a second arrangement 1020 of a slide and an RFID label. In the example 1020, the slide 1024 includes an RFID label 1022 affixed to a lower surface 1026 of the slide 1024. In this example arrangement 1020, the slide 1022 may include information encoded therein based on RFID technology as known to those of ordinary skill in the art. Additionally, on the surface of 1022 affixed to the bottom portion 1026 of the slide, the RFID label may also include information printed on a surface of the RFID label. The printed information may include human readable text, bar codes, and the like, which may be visible when viewing the slide 1024 from a top surface 1028. In this instance, the printed information such as the bar code may be on the surface of 1022 in contact with the bottom surface 1026 of the slide 1024. Additionally, an embodiment may incorporate text or other printed information on the bottom surface of the RFID label 1022. It should also be noted that an embodiment may include the bar code and other information in another label rather than including such optional text on a surface of the RFID label 1022.

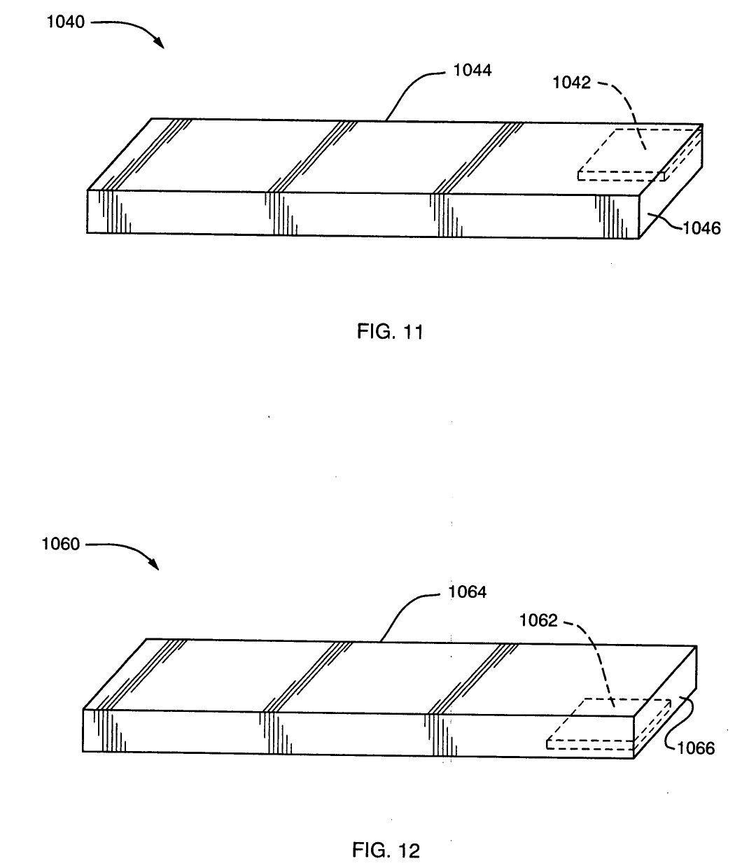

Referring now to FIG. 11, shown is a third arrangement 1040 of a slide in an RFID label. In the arrangement 1040, an RFID label 1042 may be embedded within a layer of the slide 1044. Such an arrangement 1040 may include a prefabricated slide and RFID label that may be provided, for example, by a vendor. In this arrangement, the RFID label 1042 is embedded near the top surface of the glass slide 1044.

Referring now to FIG. 12, shown is a fourth arrangement 1060 of an RFID label and a slide. In the arrangement 1060, the RFID label 1062 is embedded near a bottom surface of the glass slide 1064. It should be noted that the arrangement shown in 1060 may be provided as a prefabricated slide and RFID label arrangement similar to that as described in connection with FIG. 11. The particular location within a slide at which the RFID label, such as 1042 and 1062, may be embedded may include other positions and locations than as described in connection with FIG. 11 and FIG. 12. The particular placement of the RFID label may vary in accordance with the particular slide composition and/or slide manufacturing process.

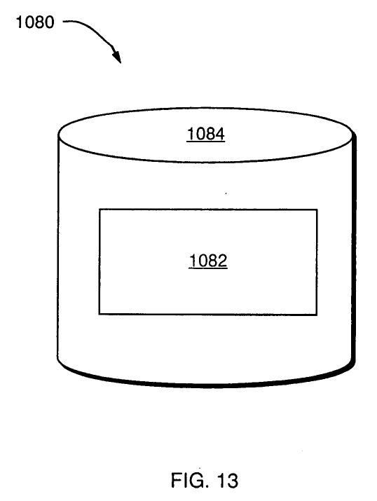

Referring now to FIG. 13, shown is an arrangement 1080 of a specimen container and RFID label. In the arrangement 1080, the specimen container 1084 may include an RFID label 1082 affixed to a surface of the specimen container 1084. The RFID label 1082 may also be in other locations than as illustrated in 1080 and may include additional information imprinted thereon similar to the other RFID labels as described elsewhere herein in connection with other figures. The RFID label may also be embedded beneath a surface of the container such as, for example, beneath a sidewall surface.

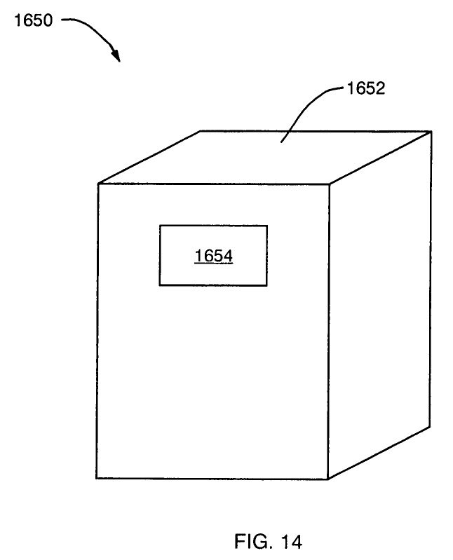

Referring now to FIG. 14, shown is an example 1650 of a reagent container including and RFID label affixed thereto. The example 1650 illustrates a reagent container 1652 that has an RFID label 1654 affixed to a side surface of the container. The RFID label 1654 may be placed on a different surface of the container than as shown in the example 1650. It should be noted that an RFID label may also be embedded in the reagent container beneath a surface of the container, such as, for example, may be performed when initially filling the reagent container. Such an embedded label may prevent misidentification of a reagent in the event that a subsequently affixed label to the surface of the container is removed or otherwise mixed up with another label placed on a surface of the container.

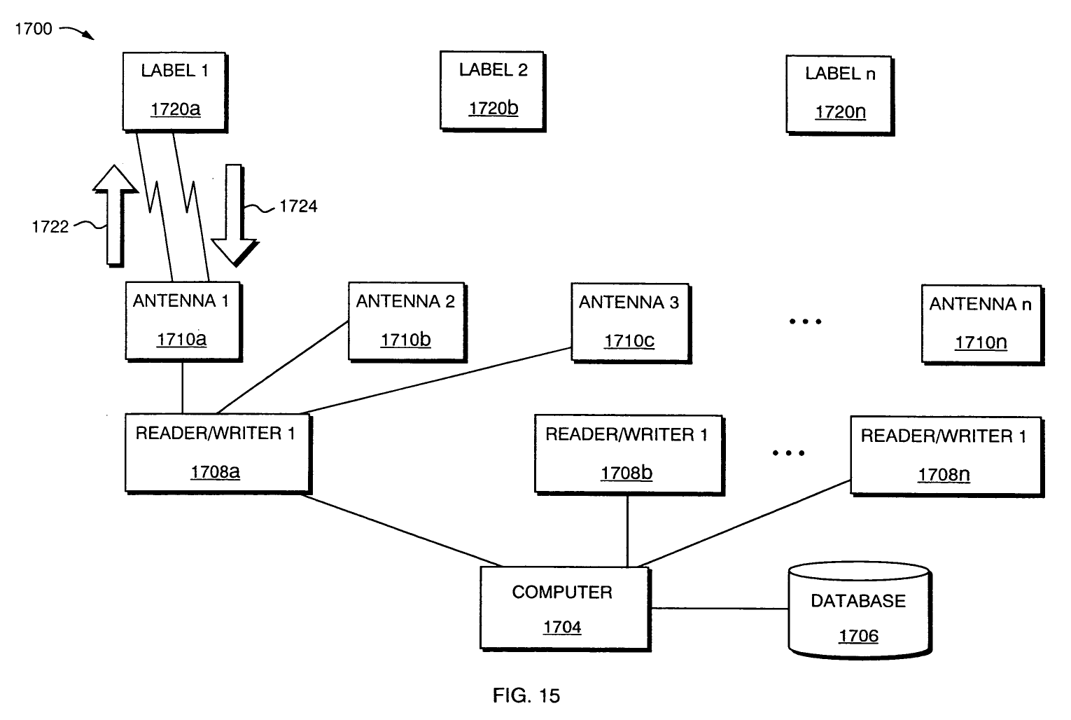

Referring now to FIG. 15, shown is an example 1700 of components that may be included in a system using RFID labels. The components of FIG. 15 may be included in a laboratory and used in connection with other techniques described herein. The example 1700 includes a computer 1704, a database 1706, one or more RFID label reader/writer modules 1708a-1708n, one or more antenna 1710a-1710n, and one or more RFID labels 1720a-1720n. Each of the labels 1720a-n may be affixed to, embedded within, or other associated with, an element used in the laboratory as described herein. A label may be affixed to, for example, each slide and each reagent container. The RFID labels may be used in tracking and identifying the location of slides, reagent containers, and other elements to which the RFID labels are affixed thereto. In operation, an RFID label reader/writer module, such as 1708a, may interrogate one or more of the antenna elements regarding the location of a particular element identified by its RFID label. The module 1708a may do this by transmitting an interrogation signal to one or more of the antenna elements. An antenna element, such as 1710a, may transmit a signal to a label as illustrated by 1722. A label, such as label 1720a, receives this signal and may transmit back a return signal, as illustrated by 1724, which includes a unique identifier corresponding to that RFID label. The module 1708a may obtain (read) this RFID label's unique identifier and other information through this technique. The computer 1704 may communicated with the modules 1708a-1708n to send and/or receive data which may be stored in the database 1706.

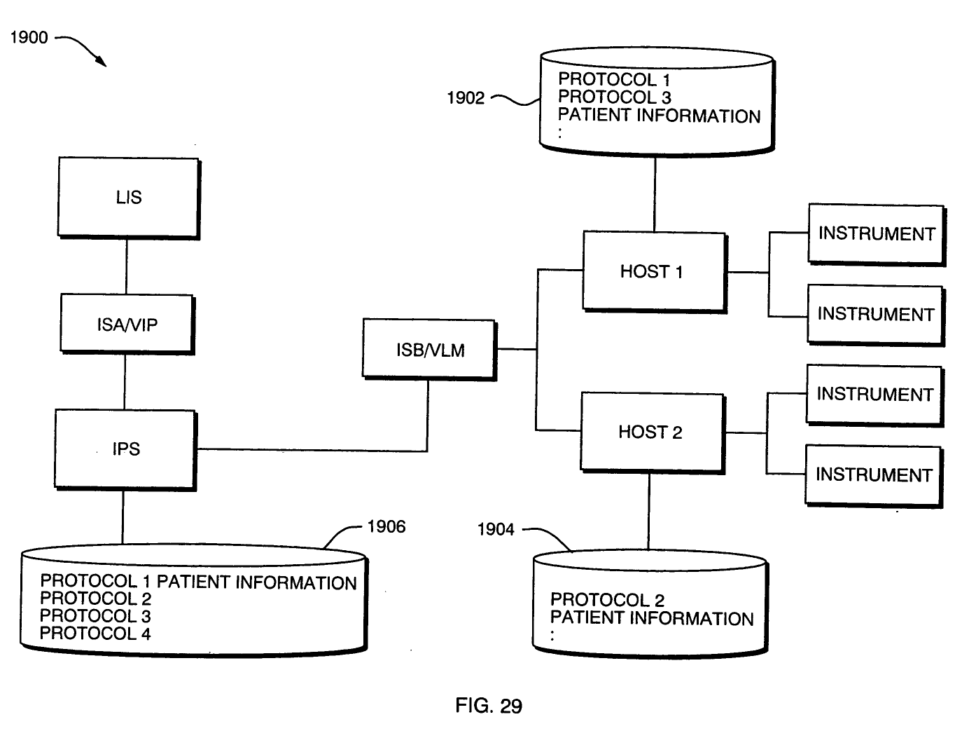

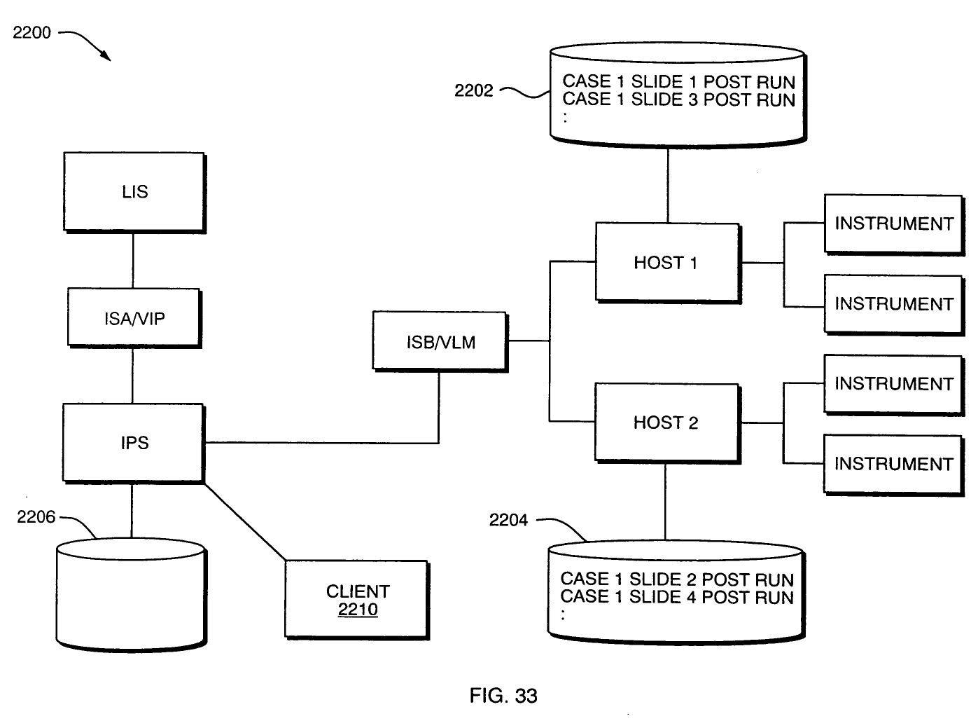

It should be noted that computer 1704 may be, for example, a host or another computer system connected to the IPS. The IPS is included in examples described elsewhere herein such as, for example, in FIG. 3, FIG. 29, and FIG. 33. In one embodiment, for example, the element 1704 may be a host computer. The host may be connected to the RFID reader/writer components as illustrated in FIG. 15. The same host which communicates with the read/writer components may also communicate and control other instruments, such as laboratory instruments. Alternatively, an embodiment may have a dedicated host which does not control laboratory instruments in addition to the RFID components, such as the reader/writer components illustrated in FIG. 15. One or more of the read/writer components may be standalone components as illustrated in FIG. 15. An embodiment may also include one or more of the read/writer components within another instrument. The host may gather the information from the RFID labels or tags. For example, the host may execute code that processes inventory usage and performs RFID event handling. Subsequently, the host may also communicate with the VLM and other components in the laboratory to disseminate any such information gathered via the RFID labels and interrogation thereof. As described elsewhere in more detail information may also be written to the RFID labels using the host.

As also described elsewhere herein, the RFID labels or tags may be encoded, or have information written to the RFID labels. The information included in the RFID labels may be dynamically modified as the label moves through laboratory processing. In contrast to barcodes which contain static information that may identify a record or group of records in a database, RFID labels allow data to travel along with an associated element, such as a slide. Processing may be performed both inside and outside of the laboratory using the data stored on the RFID label, for example, to know how to process the slide associated with the RFID label, and then store other information into the RFID label. In this manner, an embodiment may use the RFID labels as a source of information and the database, for example, may be characterized as a redundant cache or copy of some or all the data that may otherwise be included in the RFID label.

As known in the art, RFID labels may be active or passive. Further, RFID labels may be read-only, write once/read many, and read/write. Any one or more of the foregoing may be included in an embodiment.

Different techniques may be used to determine the location of an RFID label. For example, an embodiment using triangulation to determine the location of an RFID label may use at least three antenna modules. If RFID labels are located on slides stored in a shelving arrangement, antennae may be installed so that each antenna may be responsible for determining the location of slides in one or more particular zones or portions of a shelf. It will be appreciated by those of ordinary skill in the art that the particular arrangement, number, type and orientation of antennae may vary with each embodiment. The antennae may be placed in order to facilitate tracking of, and communication with, the various elements including RFID labels. It should be noted that the antennae may be arranged to provide for locating an individual RFID tag by triangulation techniques within a required accuracy for a particular application and embodiment.

As illustrated above, an RFID label may be affixed or otherwise embedded on a slide, sample, or other element. By affixing or embedding an RFID label, information may be written to and/or read from the RFID label as a slide is processed in connection with the laboratory workflow associated with the processing. As an example, an RFID label may be affixed to a slide at the time a specimen is cut. The patient information and the test to be performed may be encoded by writing to a writeable RFID label. As an alternative to writing some or all of the information to the RFID label, the RFID label may also provide an index similar to the identifier of a bar code label, and the index may be used to indirectly obtain information from a database or other data container. The surface of the RFID label, or other portion of the slide, may include other printed information, such as text, bar code information, etc. The printed information may include a portion of the RFID encoded information and/or other information. As the slide moves through the laboratory, the slide may be checked using any one or more of a variety of techniques to ensure proper processing of the slide at each point. The information obtained at each point may include, for example, the particulars related to a test or processing step to be performed. Such techniques used to read the information may include a technician visually inspecting the slide by reading the text portions thereon, using a bar code reader, using an RFID reader, and the like. As the sample moves through the laboratory processing steps, the slide's RFID label may be encoded with additional information such as, for example, time, date, test parameters, and other information that may be used in connection with quality assurance and control. This information may be written to a writeable RFID label. It should be noted that information may also be added to the database of the host which duplicates some or all of the information in a writeable RFID label. As a QC check, at different points in processing, portions of the information obtained through reading an RFID label may be compared to information stored in a host's database as replicated elsewhere in the system.

The information written to a writeable RFID label may vary with an embodiment. For example, an embodiment may write information in accordance with specified regulations which may be used in the event that a QC failure is detected. Additionally, the information written to the RFID label may be used in determining such a QC failure as well. As an example, such information written to the RFID label may include one or more of the following: information of reagent used (e.g., a catalog number, lot number and expiration date used with a tissue sample)), control information such as information used to characterize staining benchmarks on control tissue samples, chain of custody tracking information (e.g., batch information, where this sample has been processed in the laboratory, by what instrument, when), technician information (e.g., name of technician examining sample, operating instrument, inspecting instrument, physically inspecting sample to ensure that RFID label and sample match and that the RFID label is not separating away from the slide or other associated element), observations of conditions that may be of interest to a pathologist or other person as may be used in connection with ensuring a proper diagnosis.

When the slide reaches the pathologist after slide testing is complete, the pathologist may access any of the encoded information in the RFID label and may further record a diagnosis for that sample. The diagnosis may be recorded by writing to the RFID label and/or writing the data to a database. The information encoded in the RFID label provides a pathologist or other location that may be offsite from the laboratory access to sample information that may otherwise only be accessible with a connection to a database or other data container including information about the sample.

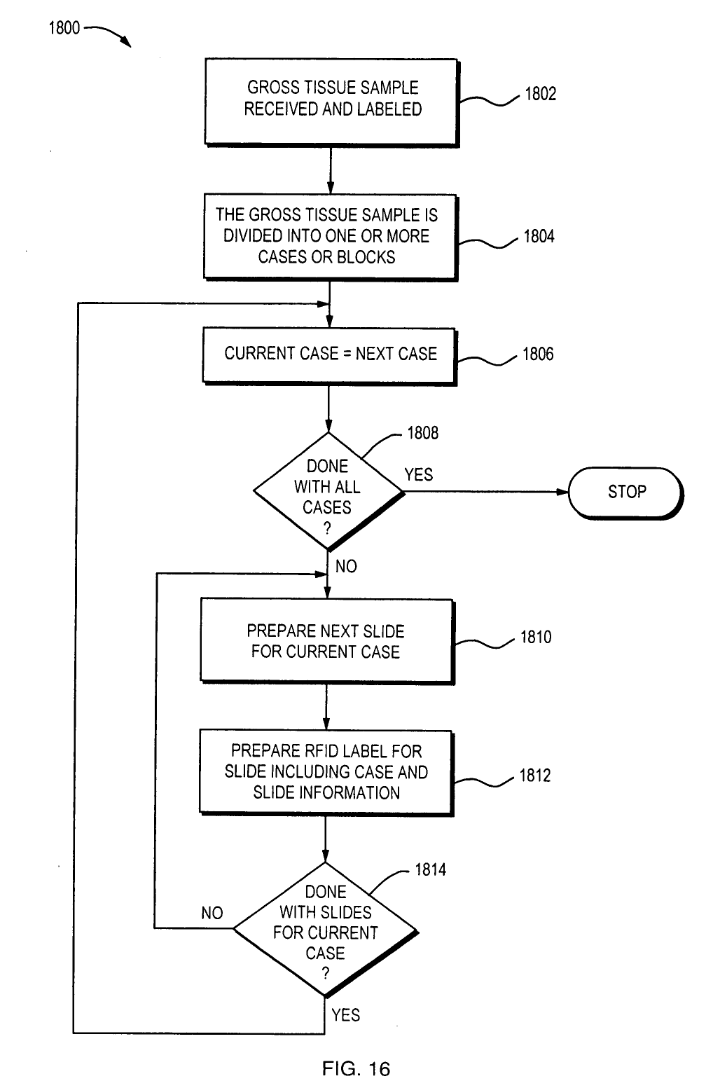

Referring now to FIG. 16, shown is a flowchart 1800 of processing steps that may be performed in an embodiment in connection with RFID labels. The steps of 1800 summarize those described above. At step 1802, a gross tissue sample may be received at a laboratory and may be affixed with an RFID label. The gross tissue sample at step 1804 may be divided into one or more cases or blocks. At step 1806, current case is a variable that represents the current case being processed. At step 1808, a determination is made as to whether all cases are processed. If so, slide preparation stops. Otherwise, control proceeds to step 1810 to prepare the next slide for the current case. At step 1812, the RFID label for the current slide is prepared including the case identifier and slide specific information. The case identifier may be used, for example, to later retrieve all slides of a particular case. Similarly, a unique identifier associated with the gross tissue sample may be used in connection with determining all slides associated with a particular tissue sample. Step 1812 may be performed by writing the information to a writeable RFID label. Step 1812 may also be performed using a read-only RFID label that is produced on-site at step 1812 and then affixed to the slide. At step 1814, a determination is made as to whether processing of all slides for the current case is complete. If so, control proceeds to step 1806 to process the next case. Otherwise, control proceeds to step 1810 to prepare the next slide for the current case. It should be noted that the steps of 1800 may be performed manually and/or in an automated fashion, such as with an automated slide preparation apparatus. In the event that one or more of the steps of 1800 are automated, software and/or hardware may be used to issue instructions to control the particular component performing the steps. It should be noted that the processing steps of 1800 may be performed using writeable or non-writeable RFID labels.

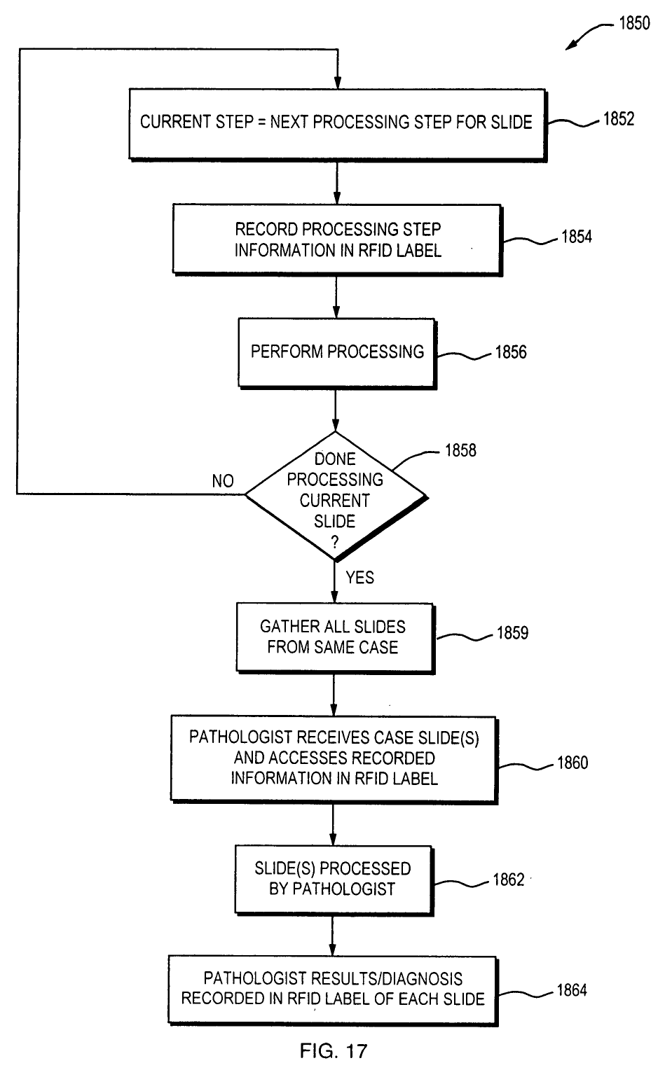

Referring now to FIG. 17, shown is a flowchart 1850 of processing steps that may be performed in connection with processing prepared slides including writeable RFID labels. The steps of 1850 may also be performed manually and/or in an automated fashion. For example, in the event that the slides are to be stained, the steps 1852, 1854, 1856, and 1858 may be performed using one or more automatic staining apparatus. At step 1852, a variable current step represents the next processing step for the current slide. At step 1854, processing step information is written to the RFID label. This information may include, for example, date/time information, the reagent used, information about the reagent such as batch number, lot number, etc. The information written may vary with each processing step. For example, one processing step may be to take an image of a resulting stain and store the resulting image in a file, such as a JPEG file. An identifier of the location of the resulting image file may be written to the RFID label. As described elsewhere herein, the slide identifier and other slide information associated with the data element may be stored in the OBX segment as described elsewhere herein. At step 1856, the current processing step for the slide is performed. At step 1858, a determination is made as to whether processing of the current slide is complete. If not, control proceeds to step 1852. Otherwise, control proceeds to step 1859 where the slides of a same case may be gathered. Step 859 may be performed after one or more runs of slides have been processed on one or more instruments. The RFID label of each slide included in a particular case may be used to perform step 1859 by sending out interrogation signals to determine all RFID labels with a particular case identifier. After all the slides of a same case have been gathered, the pathologist receives the one or more slides associated with the case at step 1860. It should be noted that step 1860 may happen at some time period after one or more slides of a case have been processed. At step 1860, the pathologist receives the one or more slides and accesses recorded (written) information in the RFID label. At step 1862, the pathologist processes the slide. Any subsequent results or diagnosis by the pathologist may be written to the RFID label at step 1864. As described elsewhere herein, the results or diagnosis being recorded in the RFID label and/or database may trigger a status update to be communicated. In an embodiment which uses non-writeable RFID labels or bar code labels, processing steps of 1850 may be varied so that processing information is recorded in a database rather than written to the RFID label, such as at steps 1854 and 1864.

RFID labels may be used to track and/or collate slides associated with a particular case or batch in connection with other processing steps than as illustrated for purposes of example above. As another use of the case identifier in collating, a first set of staining may be performed on a group of slides. At some later point, the slides may be subjected to additional staining or other processing. RFID labels may be used to locate all slides of a particular grouping which may be temporarily stored between processing steps, such as staining, imaging, and other steps.

In connection with recording information at steps of 1800 and 1850, it should be noted that information may be recorded in other locations besides the RFID label. For example, information may also be recorded in the database of the IPS 102 and one or more of the hosts. As additional data is written to the RFID label, the additional data may be stored in the database of the IPS 102 through subsequent interrogation of the RFID label. Further replication of these data updates may be made to other databases of other hosts using techniques described elsewhere herein.

By recording order, processing, and/or result information about each slide on the associated slide or other specimen using writeable RFID labels, each slide carries with it various pieces of identifying information. The information may be used to identify each sample or specimen in the laboratory. Such information may provide an added check, for example, in identifying one or more samples of a single batch of case cut from an initial specimen. Use of the writeable RFID labels may provide for quickly accessing and identifying up to date information about a sample locally with only access to the sample itself. As also described above, an RFID label may be used in physically identifying a location of one or more stored slides without requiring the slide to be within line of sight. Such identification may be performed, for example, to verify if a slide, reagent, and the like, is physically resident at a location as may be expected, such as, for example, as identified in a database record field, verifying if the slide is/is not within the physical site of the laboratory.

An embodiment may also utilize an RFID label in connection with only reading data therefrom. Such an embodiment may use an RFID label similar to a bar code in which data included in the RFID label remains static. However, such an embodiment still has advantages over bar codes and other forms of encodings, such as optical readers or electromagnetic scanners requiring that the RFID label be within line of sight of the reader or scanner. Information may be read from the RFID label without being subject to such restrictions. The RFID label may be conveniently read from other locations within the laboratory with restrictions in accordance with the antenna and other equipment of the RF system.

RFID labels may be used in connection with, or as an alternative to, other types of manual and/or automated techniques. For example, RFID labels may be used in combination with bar code labels. It should be noted that an embodiment using writeable RFID labels to dynamically store information, for example, as a result of processing a slide or other sample, may omit some or all of the information stored in the database. This may be used to reduce storage requirements on one or more of the hosts and/or IPS databases or other data containers.

In one embodiment, glass slides may be provided with a label on the slide when a sample is placed thereon. The slide, for example, may be provided for sale by a vendor with an RFID incorporated into each slide at the time of sale. Alternatively, a vendor may also provide an automated slide labeling system which may be used in placing RFID labels on the slides at other points.

The RFID label may also serve a functional purpose in connection with the slides. For example, in one embodiment, the label may serve as a “dam” on the slides for a sample stored thereon.

In an embodiment using a writeable RFID label, what will now be described is an example of data that may be encoded in the RFID label. The data that is described may be used to generate a pathology report sent to the LIS in connection with a pathology test. Other data than as set out below may also be encoded in the RFID label in accordance with the one or more report formats may be used in an embodiment. As described herein with reference to FIG. 3 and 3A, the VLM, which is executing on the IPS, may gather one or more data elements from one or more hosts and provide them in a report format to be sent to the LIS. The following information may be encoded in the RFID label for inclusion in the pathology report sent to the LIS:

### Patient Demographics

Patient name
Date of Birth
Hospital accession number
Specimen site
Date collected
Referring Physician

### Results Summary

Test Name
Staining Intensity
% cells Positive

### Case Summary Report

The Case Summary Report may include, for example, photos or images and summary information for any assay run.

It should be noted that use of RFID technology for object tracking and identification is described, for example, in U.S. Pat. No. 6,150,921, Article Tracking System, Werb et al., Nov. 21, 2000, and U.S. Pat. No. 6,600,420, Application for a Radio Frequency Identification System, Goff et al., Jul. 29, 2003, both of which are incorporated by reference herein.

In connection with encoding information that may be read optically from labels of slides, reagents, and the like, different types of characters or glyphs and associated symbologies may be used. One way of encoding information which may be read optically is using bar codes. Bar codes may be characterized as parallel arrangements of varying bars and spaces. Additionally, bar codes may also include symbols expressed as width modulated symbols and height modulated symbols. Bar codes may be of varying dimensions and other varying physical attributes as described elsewhere herein and known to those of ordinary skill in the art. In connection with the width modulated symbols, a parallel arrangement of varying width bars and space may be used to represent a symbol. Similarly in connection with height modulated symbols, a parallel arrangement of varying height bars may be used to represent a particular symbol. A symbology describes how information may be encoded into physical attributes of bars, spaces, and other optically read characters. Symbology also refers to a set of rules for a particular type of code. For example, in connection with bar codes, bars may be thought of as darker elements of the symbols whereas spaces are characterized as the lighter portions there in between. Any one of a variety of different symbologies as may be included in standard, or in vendor specific, definitions may be used in an embodiment to represent a bar code.

It should be noted in connection with codes, such as bar codes, as known to those of ordinary skill in the art, reading and printing equipment use a compatible symbology so that a device reading a bar code of a first symbology is capable of understanding and interpreting the first symbology as may be produced, for example, by printing equipment producing labels in the first symbology. A bar code or other type of character may be used to encode information. Such information that may be encoded may include, for example, a part number, a serial number, a transaction code, an index into a database, or other type of data. A symbol as used herein in connection with bar codes or other codes may refer to the actual arrangement of characters such as parallel bars, spaces, and the like, used to encode information.

Techniques for encoding information, as may be used in connection with optical detection in an automated laboratory environment, are known in the art and described, for example, in U.S. Pat. No. 5,449,895, to Hecht et al., entitled Explicit Synchronization for Self-Clocking Glyph Codes, which is incorporated by reference herein, and The Bar Code Book: Comprehensive Guide to Reading Printing, Specifying, and Applying Bar Code and Other Machine-Readable Symbols, by Roger C. Palmer, Revised and Expanded Fourth Edition.

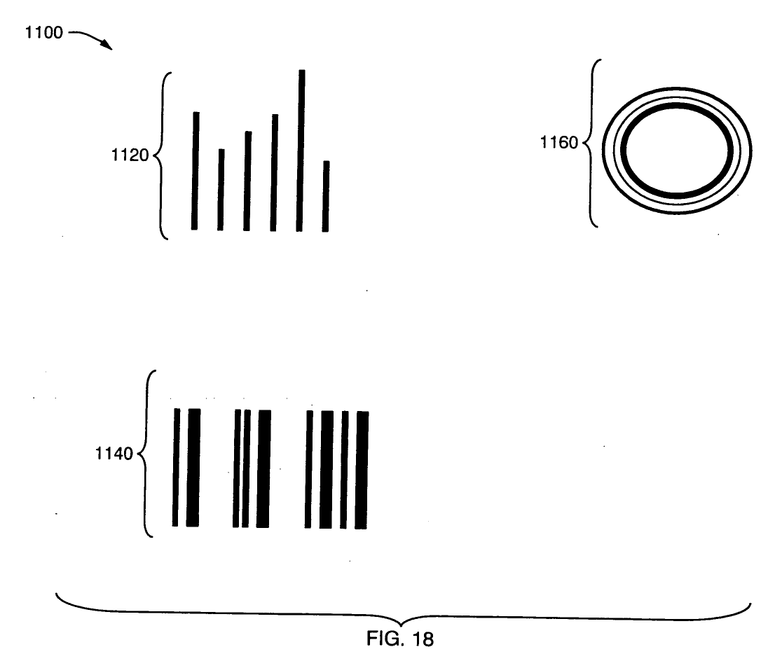

Referring now to FIG. 18, shown are some example representations of embodiments of different types of bar code symbologies that may be included and used in connection with the techniques described herein. FIG. 18 includes a first linear bar code symbology 1120. In the representation 1120, single rows of bars and spaces may be varied with height modulation to encode data. Referring to element 1140, shown is a bar code symbology where width modulation of the linear symbols is illustrated. In connection with the representations 1120 and 1140, different linear symbologies may use the combination of both the width modulation and height modulation techniques in order to encode data. The different patterns represented by the different bar codes of varying widths and/or heights may be used to represent different characters corresponding to encoded data. Referring to element 1160, shown is an example of a circular symbology representation. By varying the width of concentric circles, different characters may be represented.

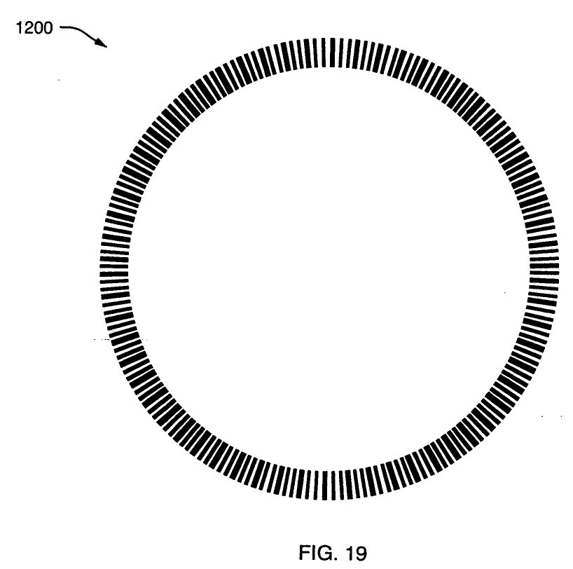

Referring now to FIG. 19, shown is an example 1200 illustrating another circular symbology. The circular symbology in 1200 represents a circular arrangement of linear symbologies or segments thereof used to represent one or more different characters and encodings.

In connection with both the linear symbologies illustrated in 1120 and 1140 and the circular symbologies illustrated in connection with 1160 and 1200, one or more characters may be represented by one or more of the corresponding detectable symbols which may be represented, for example, as a linear element or as a circular element. One or more of the linear or circular elements may correspond to a particular character representing an encoding. More generally, each of the different optically detectable symbols, such as a line or a circle described above, may be referred to as a glyph. The techniques of bar coding as known to those of ordinary skill in the art rely upon the order of the glyphs as may be detected, for example, by an optical reader in which a specified ordering of the glyphs represents encoded data.

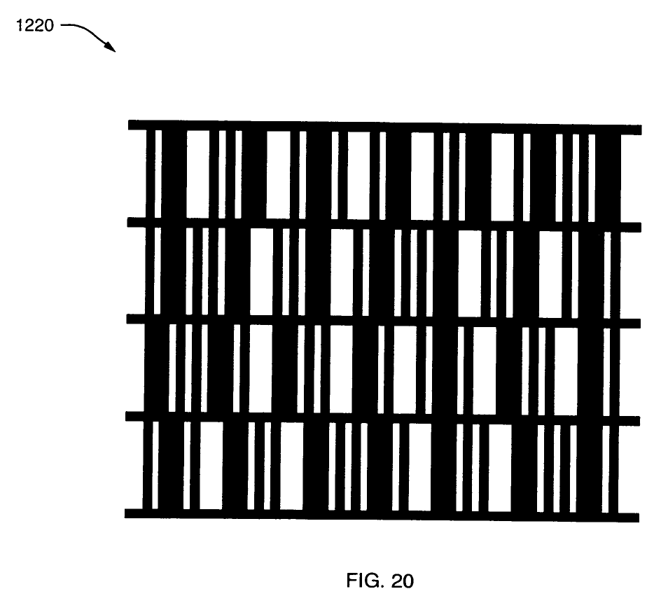

In connection with the use of bar codes, other types of symbologies may also be used. Referring now to FIG. 20, shown is a representation 1220 of a two dimensional (2D) stacked bar code symbology. In a 2D stacked bar code symbology, multiple rows of width modulated bars and spaces are used to represent one or more characters. Each row is the same physical length and looks like conventional linear symbology. Adjacent rows touch each other and may include separator bars for delineation. In connection with the representation 1220, multiple rows of linear bar codes are stacked together to form a single symbol. The representation 1220 may correspond to a single symbol.

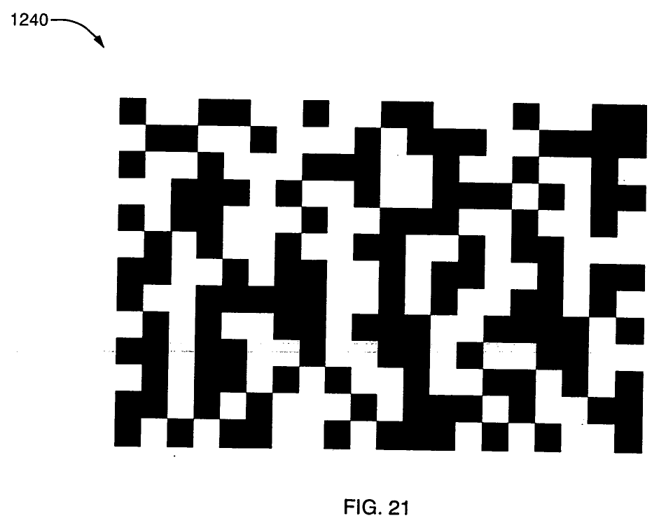

Referring now to FIG. 21, shown is an example 1240 representing a two dimensional matrix symbology used to encode information into a two dimensional pattern of data cells. The data cells may have different colors, such as black or white, and different shapes, such as squares dots or polygons, which may be separated by spaces containing no information.

It should be noted that although 1-D and 2-D bar code arrangements are described herein, bar codes may be of other higher dimensions (e.g., 3D, etc.) in accordance with the particular bar code readers and printers in each particular embodiment.

Different types of characters may be encoded in accordance with different symbologies. For example, a symbology may encode only numbers. Other symbologies may encode alphanumeric information and others may provide encoding for the entire ASCII character set as well as a range of user defined characters, printable characters, and the like. Different symbologies may be used in representing different character sets encoded, such as, for example the character sets used for different foreign languages. An optical reader may also recognize other types of characters or glyphs besides the foregoing bar-like codes.

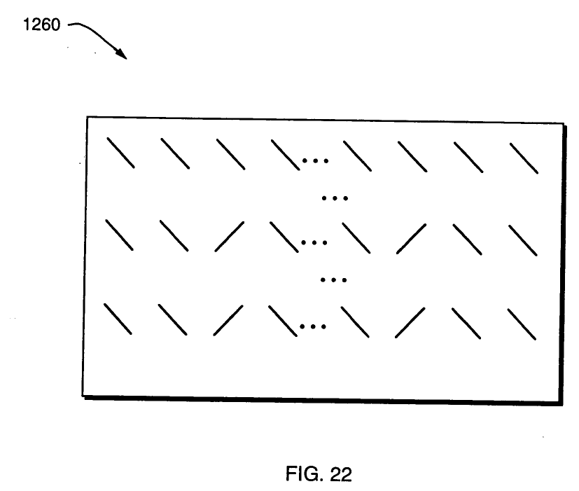

Referring now to FIG. 22, shown is a representation 1260 of glyph codings that may be used to represent encoded information. It should be noted that the representation in FIG. 22 includes as glyphs slash-like symbols rather than bars where the slash-like symbols are oriented at different 45° angles with respect to a vertical axis. Each of the different slash-like symbols may correspond, for example, to the values of one and zero. The different varying patterns of ones and zeroes may correspond to an encoded character or data. A symbol may be represented by a predefined number of these slash-like symbols defining an array that may be characterized as a symbol cell. For example, an array may be defined to the size of the number of bits representing a character in a particular character set, such as the ASCII character set. A different array size may be appropriate for representing other character sets. The foregoing is another representation of how optically detectable characters may be used to encode information.

An embodiment may use any one of a variety of different symbologies and characters which may be optically read and/or recorded (e.g., such as by printing) in connection with encoding information. The recorded data may be included on a graphic recording media, such printed on paper, which may then be used as a label for a slide or other specimen.

What will now be described are examples of different arrangements in which labels including optically readable characters may be used in a laboratory as described herein. Although bar codes are used, it should be noted that other types of characters and different symbologies may also be used. The particulars of the following examples should not be construed as a limitation.

In an anatomical pathology laboratory, as an example, a bar code on a slide may be used in connection with accessing a common set of data that may be stored in one location or duplicated at various sites. In one embodiment, the bar code identifier associated with a slide may be a globally unique identifier used in accessing the data elements associated with that slide. The slide's unique identifier may be formed so that the identifier is unique with respect to slides that may be processed by the laboratory for a time period of years. As such, the slide's unique identifier may be formed, for example, based on at least partial date information. As described herein with reference to FIG. 3, use of the VIP provides for connections to an LIS from instruments, other hosts, and other systems that may be connected to the VIP. The VIP may serve as a common connection integrating different components in a system. Each of the components may be at the same or different sites. They may be connected through any one or more different types of connections including wireless connections, network connections, hardwired direct connections, and others known to those of ordinary skill in the art. Using the VIP, information may be communicated between the LIS and the instruments. The data that is transferred may include, for example, order and result information. The order information sent from the LIS may include a request for a particular operation or test to be executed by an instrument (e.g., request for staining, request for imaging protocol to be executed on a resultant slide). The result returned to the LIS may include a description of fulfillment of an order. Information in connection with one or more orders and results associated with a particular slide may be accessed in connection with the bar code identifying that particular slide. It should be noted that this unique identifier used as the encoded bar code value uniquely identifying the slide may also be used as the unique identifier associated with a slide's RFID label as described elsewhere herein.

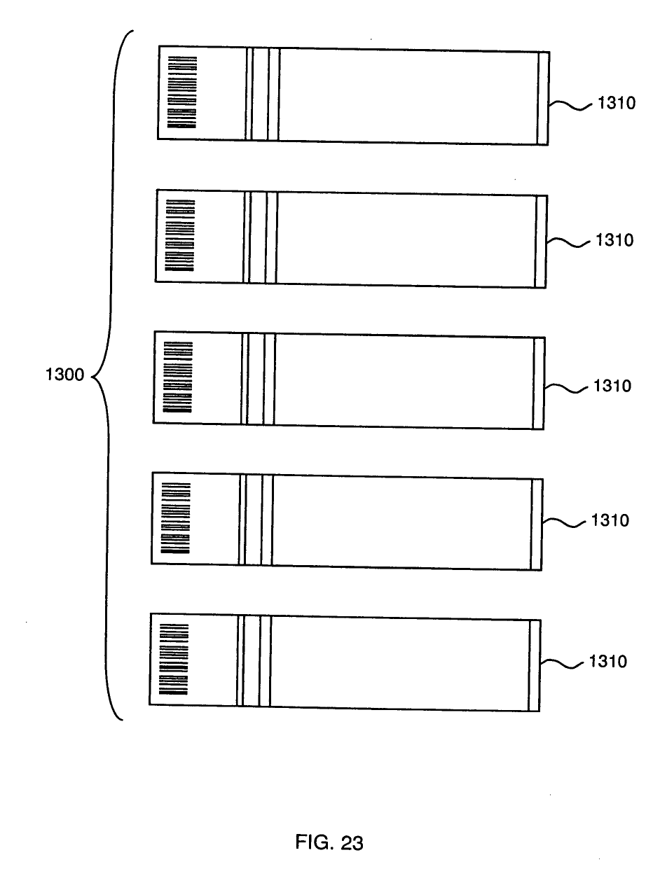

Referring now to FIG. 23, showing is an example 1300 illustrating the placement of bar codes on individual slides. The arrangement of the slides 1310 included in the illustration 1300 may represent an arrangement of slides, for example, included in a slide tray for processing by a laboratory instrument such as a stainer. It should be noted in connection with the illustration 1300, bar code information may be included on the surface of the slide at one end of the slide, such as, for example, the left hand side of the slides as illustrated in 1300. However, techniques described herein for bar coding and other forms of encoding of information are not limited to placement of the bar code at this particular location of the slide or in a particular surface area of the slide. A label may be placed on more than one surface of a slide. The information encoded by the bar code may be an identifier serving as an index, for example, into a database for other information about the associated slide.

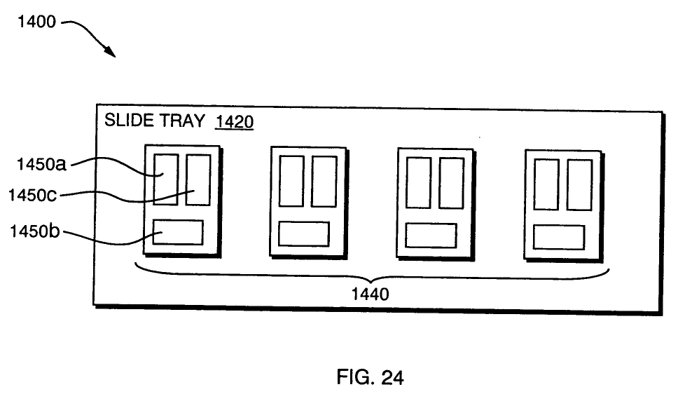

Referring now to FIG. 24, shown is another arrangement 1400 of slides as may be included in a slide tray. Each slide in 1400 includes a plurality of bar code portions on each slide. Each of the slides 1440 may include a first portion 1450a, a second portion 1450b, and a third portion 1450c. Each of the portions 1450a and 1450b may include bar code information oriented, respectively, in the vertical and horizontal directions. A bar code label may be placed in each of the portions 1450a and 1450b respectively. In one embodiment, the label included in 1450b of a slide may be an index to information common to more than one slide, such as information in connection with a particular patient, batch, and the like. The area 1450a may include another index to other information that varies with each particular slide and may indicate, for example, more test specific information such as, for example, a particular reagent used, time at which a particular test or staining has been performed, and the like. Portion 1450c may include another label with human readable or other forms of machine readable information.

The illustration 1400 includes one particular arrangement of how each slide may include more than one bar code or other type of encoding. Other arrangements are possible than as shown in FIG. 24. It should be noted that one or more of the portions 1450a-c may also be an RFID label used in conjunction with a bar code label in another of the portions.

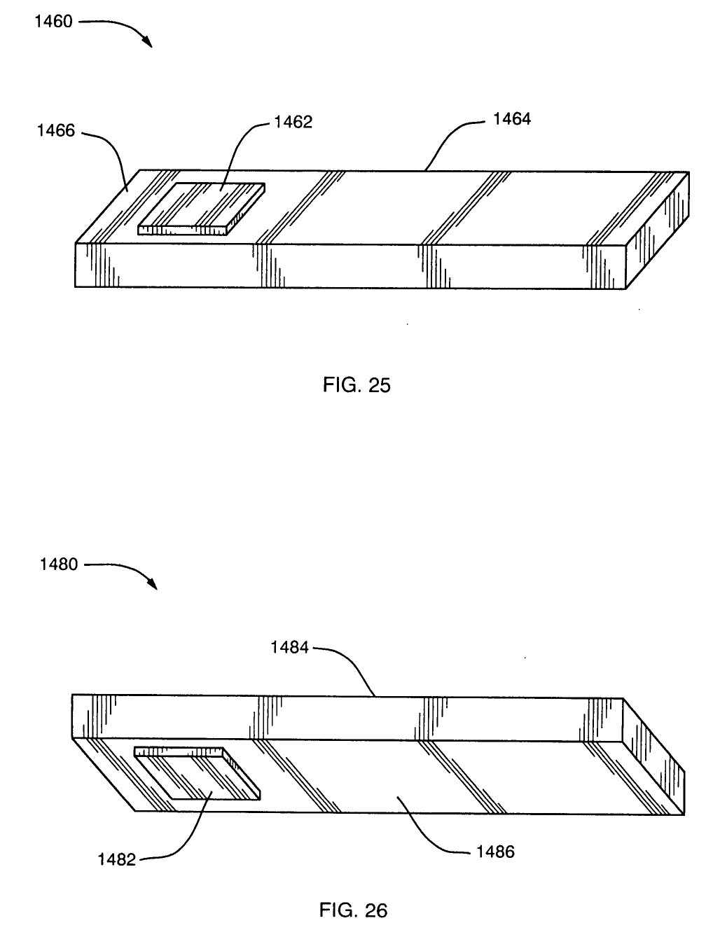

Referring now to FIG. 25, shown is an arrangement 1460 of a slide with a bar code label affixed thereto. In 1460, bar code information may be included on a label affixed to a top surface 1466 of a slide 1464. A single slide such as 1464 may include one or more bar code labels 1462 affixed to a top surface thereof.

Referring now to FIG. 26, shown is another arrangement 1480 of how bar code labels may be affixed to a slide. In this arrangement 1480, a bar code label 1482 may be fixed to a bottom surface 1486 of a slide 1484. In this example, the bar code information may appear on the surface of 1482 in contact with the lower surface 1486 of the slide. If a slide 1484 is made of glass, for example, the bar code information included on the surface of 1482 in contact with the lower surface 1486 of the slide may be optically read through the glass 1484. It should be noted that a slide 1484 may include more than one bar code label affixed to the bottom portion of a slide 1484. Bar codes or other optically-recognized characters may be placed on a bottom surface of the label 1482. Through the use of mirrors, for example, the characters on the outer surface of 1482 may be reflected and interpreted by an optical reader. It should be noted that an embodiment may include one or more labels such as bar code labels including optically-recognizable characters on one or more surfaces of a slide. For example, the slide may include bar code labels affixed to the top surface and bottom surface thereof.

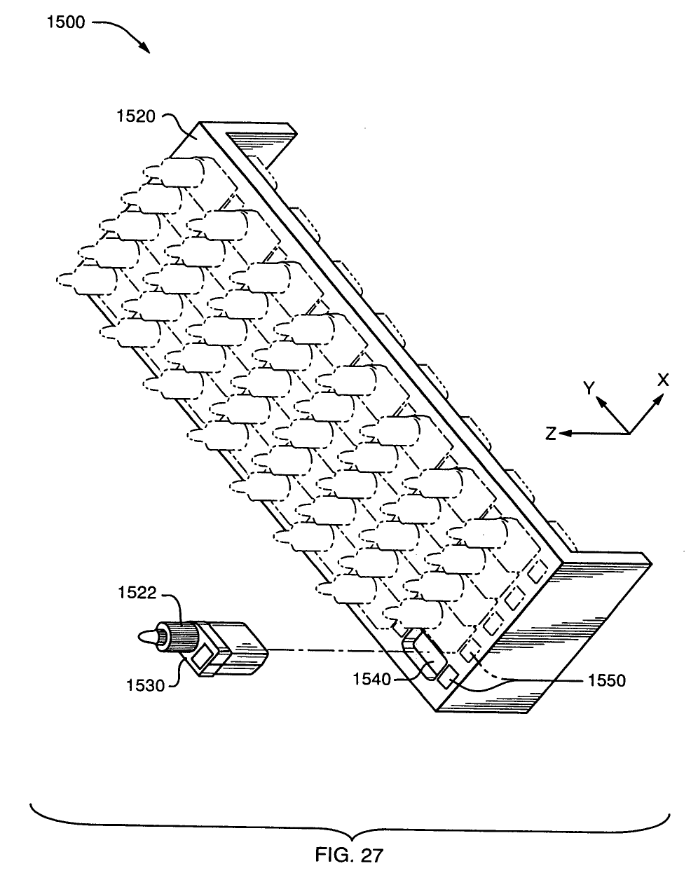

Referring now to FIG. 27, shown is an arrangement 1500 of a reagent holder that may be used in connection with labeling techniques described herein. The illustration 1500 includes a reagent dispenser tray 1520 for holding a plurality of dispensers such as those that may include reagents. Included in the illustration 1500 is a reagent dispenser holder opening 1540 into which fits a reagent container 1522. Included on each of the reagent containers 1522 is a label 1530. The label included in 1530 may be, for example, an RFID label affixed to a surface of the container 1522. It should also be noted that the reagent containers included in the illustration 1500 may also include a bar code label on the container in addition to the RFID label 1530. It should be noted that the RFID code label 1530 may also be embedded within a container surface such as may be performed when the container is initially filled by a supplier, or other location. Included at locations 1550 may be a bar code label or other type of label which should correspond to the reagent container placed therein.

Bar codes, and the use in connection with slides and reagents is described, for example, in U.S. Pat. No. 6,352,861, Mar. 5, 2002, Copeland et al., entitled Automated Biological Reaction Apparatus, which is incorporated by reference herein.

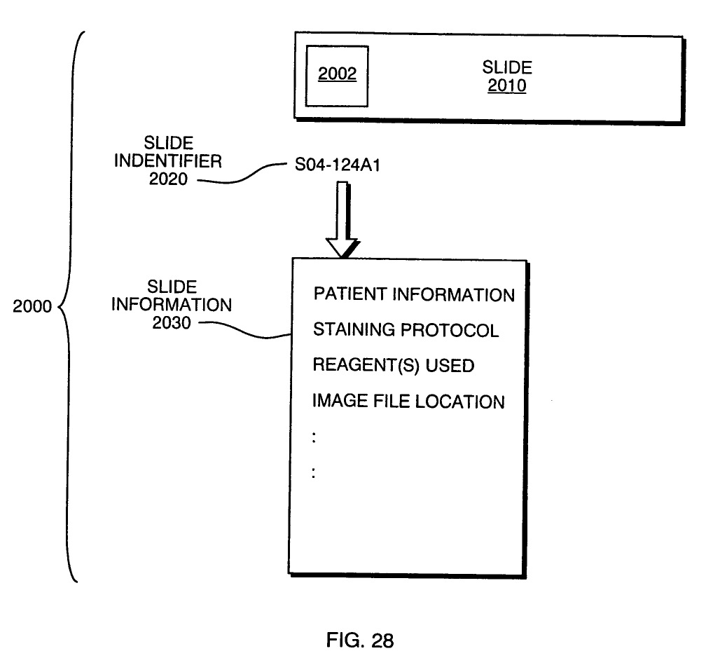

Referring now to FIG. 28, shown is an illustration 2000 of how a bar code or an RFID label with an identifier may be used to obtain case information in an embodiment. The representation in 2000 illustrates an embodiment in which a unique slide identifier may be encoded in the bar code label or an RFID label in area 2002 of slide 2010. If 2002 includes a bar code label, the bar code in 2002 may be read by an optical reader to obtain the slide identifier 2020. In the event that element 2002 includes an RFID label, the unique identifier of the slide 2020 may be read using an RFID reader. The identifier of 2020 may be used as an index into a database to obtain information associated with a slide data element 2030. The information included in a slide data element 2030 may include, for example, patient information, staining protocol, reagents used, test results/post run information (e.g., information about which instrument performed a staining, information about when the staining was performed, a location of an image file), and the like. An embodiment may include other information in a slide data element that may vary with each embodiment, sample, and processing performed on each sample. The slide's information in the database may be updated at various points in processing as new information about a slide or other sample is acquired.

It should be noted that the information encoded in bar codes, RFID labels, and the like, may also be encrypted using any one of a variety of different encryption techniques.

Referring back to FIG. 3, the hosts may each operate autonomously with respect to the other hosts. This autonomous host operation may be characterized in connection with several aspects. A host of the IPN 100 may go offline from the IPN 100 and may later come back online as a member of IPN 100 rejoining the other hosts. When a host comes online as a member of the IPN 100, a synchronization process may be performed to synchronize data elements between the host and other components of the IPN 100. One embodiment of this process is described, for example, in FIGS. 6 and 7. By having the resynchronization functionality described herein, a host may operate offline with respect to the IPN 100 to perform other tasks, and then operate to perform tasks associated with the IPN 100. For example, a first host may perform processing associated with the IPN 100. Additionally, the first host may include other software to perform other tasks not associated with IPN 100. When performing the other tasks, the first host may be offline with respect to the IPN 100. Later, the first host may rejoin the IPN 100 and the first host may have its IPN data elements resynchronized.

While offline with respect to the IPN 100, a host may perform any one or more different operations that may vary with embodiment. For example, a host may create and edit protocols that may be later shared with other hosts. The protocols may also be only used by the host locally rather than be shared with other hosts and the VLM. The host while offline may also register new reagent packages, perform runs, create and edit user privileges, perform QC procedures, print reports and the like. The processing performed by the host while offline may result in new or updated data elements that may be subsequently used by other hosts and/or the VLM when the offline host rejoins the IPN. Alternatively, the processing performed by the host while offline, and resulting data elements, may be used only locally by the host for particular operations that may be performed by that host. The host may also perform processing offline, for example, when complex processing or processing requiring a lot of network resources is being performed. Such processing may include, for example, performing a system wide backup and/or archive of the VLM data in which it may not be desirable to also consume system resources to engage in VLM-host synchronization. The host may also perform processing offline, for example, when the host is using a data element and is relying on a constant data value or state of a data element that may be updated by another host. A host may define local data elements known only to the host. Such local data elements may subsequently be published or made global (e.g., made known to other components besides the local host) by communicating the local data elements to the VLM and other hosts. Such local data elements may also remain local with respect to a host if, for example, the local data elements are only used by that particular host. The local data element definitions and values may be known only to a particular host in contrast to other data elements which may take on a global characteristic in the IPN 100, for example, by having a host publish a data element through communication and synchronization with the VLM making the data element definition and value available to other hosts. The particular configuration of the host and its data elements may be performed on a host-by-host basis and may vary with embodiment. It should be noted that an embodiment may include hosts which perform a same set of operations and/or different operations that may vary with each embodiment.

In accordance with another aspect of host autonomy, a host of the IPN 100 may also elect to share/not share one or more data elements defined and used within the IPN 100. A host may modify its share/not share status with respect to one or more elements during operation. When a host elects to share data elements with others components of the IPN 100, the host may obtain the latest version of the data element of interest from the VLM. Also, a host may be using a data element locally and may choose to publish this data element for use by other hosts. Thus, a host may also send an updated version of a data element to the VLM which is, in turn, propagated to the other hosts. As described herein, code may be executed by each host to ensure that, for each data element of interest, each host has the most recent copy of the data element. A synchronization may be performed by each host to ensure that each host interested in a particular data element operates on the most recent version of the data element. As described elsewhere herein, a timestamp value may be used to determine a most recent copy of a data element.

In one embodiment, a host may elect to share data on a data element-by-data element basis. This allows the host to control its own use of each data element. Each host controls whether a particular data element is used at all by that host. If a data element is used, the host controls whether this data element is locally (e.g., on only this host) or globally defined (e.g., available to other hosts). The particular data elements shared among one or more hosts may reflect the functionality of the hosts and/or its associated instruments. An embodiment may have the same or different functionality associated with each of the hosts. For example, in a first embodiment, the functionality may be the same on each host. A first host and a second host may elect to share the same data elements when the first and second hosts support the same set of instruments and operations. In another embodiment, the functionality of each host may vary, for example, if the first and second hosts support different instruments and/or perform different operations. In this instance, the first host may use a first set of data elements, such as staining protocols, and the second host may use a second different set of data elements. A host may also elect to share some data elements and not others. For example, all hosts may elect to share common data elements such as case and patient information but elect to share different data elements, for example, regarding protocols used by instruments associated with each host.

When each of the first and second hosts perform synchronization processing, the synchronization processing may be performed only for those data elements of interest to each host. In the foregoing example where the first and second hosts use different staining protocols but the same case and patient information, both the first and second hosts may perform data synchronization with respect to case and patient information, but not with respect to all staining protocols.

Referring now to FIG. 29, shown is an example of an embodiment of a system that may be used in connection with performing techniques described herein. The example 1900 includes components similar to those as described and illustrated, for example, in FIG. 3. Also included in 1900 are elements 1902, 1904, and 1906 illustrating the data containers or stores that may be included in an embodiment. It should be noted that these additional components are included in the example 1900 to illustrate selective data synchronization. Included in 1902 are staining protocols 1 and 3. In this example, only staining protocols 1 and 3 are of interest to host 1. Host 1 is executing a version of software supporting its lab instruments which only perform these two 20 protocols. Host 2 includes a different version of software supporting its lab instruments which perform only staining protocol 2. The master database 1906 includes information on all staining protocols. Although the host databases may include only particular staining protocols, both host databases include the same patient information.

When performing the resynchronization processing, for example, as in FIGS. 6 and 7, the processing may be performed only with respect to those data elements of interest to a host which may vary with each host. In one embodiment, the particular data elements of interest that may vary with each host are defined in accordance with a subscription list of data elements of interest on each host. This list may be stored on each host and/or in the master database, for example, element 906.

In connection with monitoring reagent use, a concept of reagent ownership may be included in an embodiment as described elsewhere herein. A reagent may be characterized as a resource that may be shared by more than one instrument connected to more than one host. In processing of slides or other samples, the reagent use and supply may be monitored. In one embodiment, a data element may be defined and associated with each set of one or more reagents that may be used together. When using reagents, it is desirable not to start a run to process a batch of slides or other samples if there will not be a sufficient amount of the one or more reagents to complete the run. In order to make this determination, an embodiment may track the amount of the reagents. A host having ownership of the data element associated with one or more reagents may update the recorded amounts of each of the reagents as may be included in an attribute or other field of the reagent data element. In other words, in order to write or update a data element of a reagent, the host has ownership of this data element. One method for acquiring ownership that may be performed in an embodiment is described, for example, in FIG. 8.

Ownership of a reagent may also be used to represent and control which instrument and host has a set of one or more reagents. For example, it may be desirable to physically move a set of one or more reagents from one lab instrument associated with a first host to another lab instrument associated with a second host. Where the set of reagents may physically reside may be represented by which host owns the data element associated with the set. Generally, a host which owns a reagent data element will be using the associated reagent and thus need to update the quantity as recorded in the associated data element.

As an example, a new set of reagents may be used on a first instrument associated with a first host. Processing may be performed to register the data element for the new set of reagents on the first host. Using the techniques described elsewhere herein, the data element definitions as known to the first host may be automatically replicated in the database of the IPN 100 and also locally on each host through data synchronization processing. The first host may be the recorded owner of the reagent data element. A problem with a first instrument may occur and the new set of reagents may be moved from the first instrument to a second working instrument connected to another host. In this example, the reagents may physically be moved to the second host and the second host may request and obtain ownership of the new set of reagents. While in use by the first instrument, the first host accordingly updates any associated amounts of the associated data element for the new set of reagents. While in use by the second instrument, the second host similarly updates any amounts for the new set of reagents in the associated data element. In another example, the first instrument may be processing a set of slides using the new set of reagents. While the first instrument is working, a request for ownership of the new reagents is made by a second host so that the new set of reagents can be moved for use in a second instrument associated with the second host. The ownership request by the second host will be denied while the first instrument is still using the new set of reagents. While the first instrument is using the reagent, the first host updates amounts of the new set of reagents in the associated data element. When the second host acquired ownership of the reagents, the second host updates the amounts to reflect consumption by the second instrument.

The movement of reagents to different physical locations may be performed manually and/or in an automated fashion.

The foregoing illustrates how reagent ownership may be used to monitor the supply and location of the reagent and also facilitates sharing of reagents among different hosts and instruments. The ownership of a reagent data element may be characterized as a software locking technique for control of the associated reagent. It should be noted that in the foregoing, ownership cannot transfer unless the owner host is online and elects data sharing. For example, a host may be offline and use a set of one or more reagents which it owns. Another host cannot successfully obtain ownership, for example, by executing the steps of FIG. 8 while the host is offline or while the host refuses to transfer ownership (e.g., because the reagent is in use by one of the host's instruments).

In one embodiment, before a run of slides is started, a determination can be made as to how much reagent or other supplies are required for the run to complete. In the event that there are insufficient supplies, the run may not be allowed to commence. The foregoing determination regarding the sufficiency of a reagent may be performed by code executing on the IPS 100, such as by the VLM component residing on the IPS in an example embodiment.

In the event that reagent reaches a predetermined threshold level or is otherwise empty, an order may be automatically generated for reordering the reagent. Additionally, as described elsewhere herein, orders may be placed on a regular basis in accordance with previous use history of reagents and other supplies. This is described elsewhere herein in more detail.

In connection with the system described herein, for example, in FIG. 3 and FIG. 29, functionality may be included for user or customer configurable options. In one embodiment, one or more of the hosts may include code to display menu screens to obtain one or more user configurable options. Configuration options may be communicated using the messages described elsewhere herein as may be sent from the host to other hosts and for storage in the master database, for example, as element 1906 of FIG. 29.

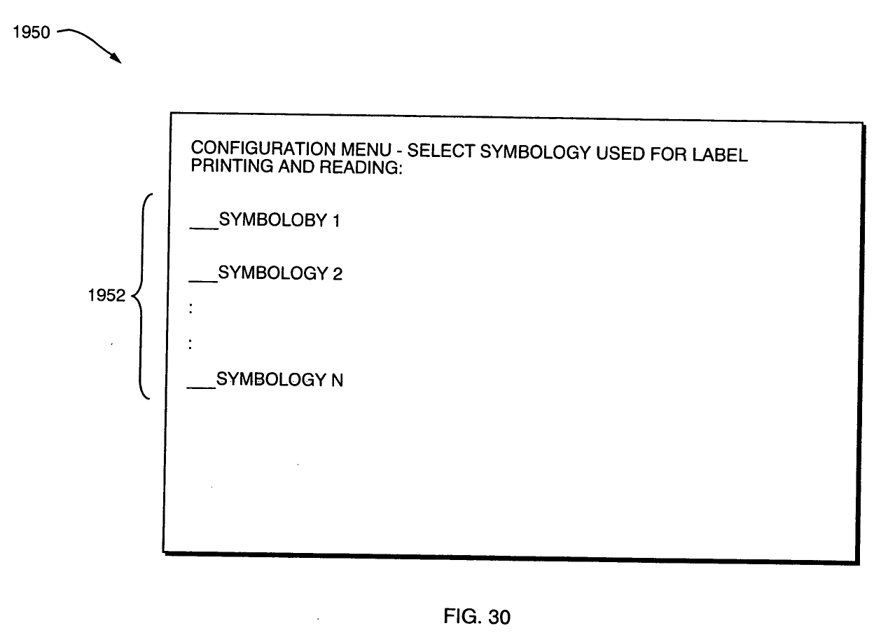

Referring now to FIG. 30, shown is an example representation of a configuration screen shot that may be displayed on a host in connection with selection of configuration options. In the example 1950, one or more symbologies may be displayed as included in 1952. Element 1952 may include all available symbologies from which a user may perform a selection. The symbology selection made may be used in connection with reading and/or printing any bar code labels that may be included on slides, or other samples. In other words, the configuration option causes each bar code reader on each instrument of every host, and each label printing device in a system such as 1900 to operate in accordance with the symbology configuration selection. It should be noted that the configuration options may also be subsequently modified and the update may be replicated to the one or more hosts and other databases in a system using the messaging techniques as described elsewhere herein. Configuration options may also be specified using other techniques in addition to, or as an alternative to, those described herein. It should be noted that an embodiment may also include functionality for configuration option selection on other components of a system besides the host. For example, the IPS may also execute code to perform configuration option selection.

An embodiment may also include functionality that limits the ability to perform configuration updates. For example, configuration options may only be configurable from a particular host, or in accordance with an authorization level of a particular user id, and the like.

It should be noted that in connection with configuration data and other data that may be replicated in a system, a timestamp or other time indicator may be associated with a set of data. When performing synchronization, the most recent copy of a data set in accordance with the most recent timestamp may be used.

In one embodiment, label printing may be performed by one or more hosts at the time slides are formed. A label printer may be an instrument connected to a host, for example, as illustrated in FIG. 3 and FIG. 29. It may be desirable to place the label onto each slide as early as possible with the slide identifier. The label may include, for example, a bar code identifier and other human readable and/or machine readable information.

The unique identifier associated with a slide may be formed using any one of a variety of techniques. In a system in which the identifier is associated with the slide being archived for a long time period, such as for several years, the identifier should be unique for this duration. In one embodiment, the following is an example format that may be used in connection with forming identifiers. A gross tissue sample may be obtained and associated with an identifier with the following root format:

LYY-nnn . . . nnn

where

L may be a letter representing a source of the tissue (e.g., S for surgery, B for bone marrow);

YY may be the last two digits in the year in which the sample arrived (e.g., 04 for the calendar year 2004); and

nnn . . . nnn may represent a series of integers in which the next integer in a current sequence is associated with the current tissue.

Subsequently, this tissue sample may be divided into case blocks. For each case block, one or more slides may be cut from the tissue sample. Each case block may be assigned an identifier. For example, in one embodiment, each case block may be associated with a next single character as occurring in the alphabet so that the first case block is associated with A, the second with B and so on. Each slide within a case block may be associated further with a next integer in a sequence beginning with 1. The case block identifier (e.g., A, B, . . . ) and the slide sequence number (e.g., 1, 2, 3, . . . ) may be placed as a suffix on the above gross tissue sample identifier so form the slide identifier. For example, the following may be a slide identifier: S04-1234A1. This slide identifier may be encoded, for example, using one of a selected bar code symbologies on a label. The slide identifier may also be used in forming the RFID label identifier as well. One or more slides associated with the same case may be identified by the root portion concatenated with the case block identifier (e.g, case identifier S04-1234A, slides in the case may be S04-1234A1 and S04-1234A2). An embodiment may use other techniques in connection with forming the identifiers for slides, cases, and the like.

In connection with forming a unique identifier for each slide or a batch of slides, an inherent property of the slide, container, and/or tissue sample may be used to generate a unique identifier.

As described elsewhere herein, an embodiment may store the unique slide identifier in fields ORC-2, 3, and/or 4 of messages used in communications described elsewhere herein. The unique slide identifier may be used with the bar code and/or RFID identifiers as described elsewhere herein. In one embodiment, each of the ORC-2 and ORC-3 fields may uniquely identify the slide. Slide information may be included, for example, in the OBX segment. In addition to the slide identifier, the slide information may also include, for example, the JPEG or other image file location that may result from imaging, staining protocols, reagents to be used, and the like.

It will be appreciated by those of ordinary skill in the art that the particular steps performed in connection with forming an identifier used in connection with bar codes, RFID labels and the like, may vary in accordance with an embodiment and also the particular tissue sample and slides to be formed.

The complexity in configuring and scheduling runs of samples may increase as the number of reagents, instruments, and overall size of a laboratory increases. Different factors may be considered when scheduling runs of samples for processing by laboratory instruments. For example, the configuration may need to take into account certain quality control (QC) requirements. Some QC requirements may be specified in rules and regulations such as a number of positive and/or negative controls as may be required in accordance with the College of American Pathologists (CAP), Clinical Laboratory Improvement Amendments (CLIA), and the like. Some QC aspects may also be those desired or preferred by pathologists or as may be otherwise expected in an industry. Another factor is the supply of reagents and other supplies in scheduling a run. An embodiment may determine the amount of reagents and other supplies to be consumed by a run and then allow or not allow a run to occur in accordance with this determination. An embodiment may also consider configuring one or more runs which process slides in different groupings in an effort to maximize throughput. A different instrumentation and reagent configuration may be considered, for example, to maximize throughput and laboratory performance. As another consideration in scheduling, if a new reagent or other element used in processing is being used, different controls (e.g., positive and negative controls) may need to be scheduled in order to certify that particular element in accordance with different certification requirements.

An embodiment may use software executed on one or more of the hosts included in the system illustrated, for example, in FIG. 29 and FIG. 3, in scheduling batches or runs of samples, such as slides, for processing.

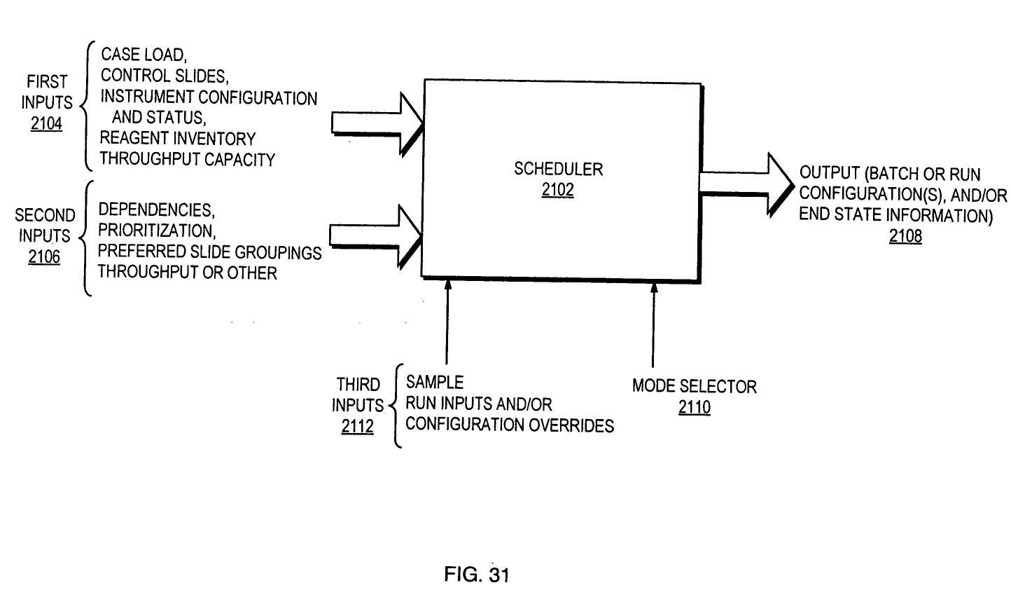

Referring now to FIG. 31, shown is an example 2100 illustrating a batch scheduler. In 2100, the batch scheduler 2102 may have one or more first inputs 2104. Additionally, an embodiment may also include one or more second inputs 2106. Generally, the first inputs 2104 may include information about the current state of the laboratory to enable the batch scheduler 2102 to evaluate and/or generate one or more particular runs. An embodiment may also use other information than as described herein. The first inputs 2104 may include information input from the database, such as may be stored in the IPS. The information may include, for example, the current case load or case samples to be processed, control slides to be processed in accordance with system requirements and the number of case slides, instrument configuration and status information, reagent inventory, and throughput capacity. The instrument configuration and status information may include which machines are up and running or otherwise unavailable for processing a run, which reagents are on which instruments, and the like. The reagent inventory information may include information about the types and current quantities of each reagent. Throughput capacity information may include the rate at which different instruments perform certain processing steps in connection with the slides. The second inputs 2106 may include one or more optional inputs used in connection with the scheduling and evaluation thereof. Second inputs may include, for example, dependencies, prioritizations, preferred slide groupings, and other scheduling criteria such as throughput. Dependencies may specify an ordering dependency of certain slides or other samples. For example, a slide may require a first staining prior to performing other processing by another instrument. Prioritizations may be specified and may include, for example, designating which one or more slides should be given priority than others. Preferred slide groupings may include, for example, an indication of how slides should be grouped in the runs. For example, it may be preferrable to group slides by antibody for processing rather than by case. One or more performance criteria may be specified such as, for example, throughput. The scheduler may use this in determining which run configuration may be preferred. For example, it may be desirable to maximize throughput. Accordingly, a different scheduling algorithm or different rules may operate in determining one or more runs for processing the current case load. Additionally, third inputs 2112 may be input to the scheduler 2102. The third inputs 2112 may include sample run input and/or configuration override information. The override information may be input alone or in combination with other elements of 2112. The override information may include different configuration options, such as if a particular instrument was online rather than offline, if a particular reagent was on a different instrument with a different capacity, and the like. Generally, the override information may be used to generate run configurations and/or evaluate a run configuration in accordance with a variation to the laboratory configuration. When the scheduler 2102 operates in accordance with a first mode, as may be selected with the mode selector 2110, the scheduler 2102 may output one or more runs of slide configurations in accordance with the specified input(s).

The scheduler 2102 may also run in a second mode where a particular set of sample run configurations included in third inputs 2112 may be scheduled. The run configurations in this second mode may be given as an input to the scheduler. In other words, rather than operate in a first mode which produces run configurations, the scheduler 2102 may operate in a second mode to simulate the state of the laboratory at the end of a proposed set of sample runs included in 2112. In this second mode, the scheduler may produce as an output the end state of the system for a given set of one or more input runs. Generally, the end state information may include one or more pieces of information describing the end state of the system if the input runs are performed given a current state of the laboratory. The end state information may be used to evaluate which one of a particular set of input runs may be preferred. The end state may include, for example, the end time of processing the samples, the reagent inventory, whether there was an insufficient reagent supply, and the like. In one embodiment, if the scheduler runs in the second mode, the sample run configurations of 2112 may be required. The configuration overrides may be optionally specified when the scheduler operates in accordance with the first or second mode.

An embodiment may also not include a mode selector and may only operate in accordance with the first mode or the second mode described herein. Other variations of the scheduler are possible as will be appreciated by those of ordinary skill in the art.

The foregoing may be used to dynamically configure and/or evaluate a given set of runs prior to actually executing the one or more runs. As the complexity of a laboratory increases, the usefulness of such a scheduler may also increase since manually scheduling and determining runs using empirical knowledge becomes more difficult.

In one embodiment having multiple hosts, software and/or hardware may be included on each host to communicate necessary information for scheduling operations to a master scheduler module. The master scheduler module may also include hardware and/or software to perform scheduling across multiple hosts and associated instruments. The master scheduler functionality may be performed by a designated host, the IPS, or other component in communication with other hosts to obtain lab-wide instrument information, case load, reagent information, and the like. Scheduling uses information about all laboratory instruments to be scheduled and their associated capabilities. One component, characterized above as the master scheduler, may obtain all necessary scheduling inputs and may be in communication with the hosts similar to the way the VLM is in communication with the hosts. Each of the hosts may include software for supplying such necessary information. An embodiment may also include a component on each host to perform some scheduling processing for instruments connected to that particular host. Such scheduling components included on each host may also be in communication with a master process coordinating scheduling tasks among the different hosts. In this latter configuration, the scheduling division of labor may be partitioned among the hosts and a master scheduler. Alternatively, an embodiment may have a single master scheduler gather scheduling information (e.g., instrument and reagent information, other laboratory configuration information, and the like), as may be reported by each host. The master scheduler may then use this information to perform all scheduling tasks. In yet another embodiment, each host perform its own scheduling of instruments controlled by each host.

An embodiment may also include a scheduling option to produce a number of scenarios to best process the case load in accordance with specified criteria such as, for example, instrument utilization optimization, throughput maximization of an instrument and/or laboratory, consumption of a particular reagent by a certain date, and the like. The scenarios produced in accordance with the criteria, case load and other information as may be included in an embodiment may result in a work list designating a processing order to be executed in a manual and/or automated fashion. An embodiment may also include a feature for scheduling to handle new incoming orders, and/or existing orders, designated as priority orders requiring processing priority over other orders. The scheduler may include a feature to process such priority orders, for example, by specifying priority orders as another input to the scheduler. The scheduler may produce a processing order in accordance with the designated priority orders and in accordance with other criteria. The scheduler may include functionality, or communicate with other components in the laboratory, to provide reagent locating support, such as may be implemented using the RFID or other technology, to assist technicians in manually assembling a staining run. The scheduler may including functionality, or may communicate with other components in the laboratory, to also analyze historical trends of reagent use and manage reagent inventories to aid in scheduling preventative maintenance on instruments, placing restocking orders, and the like. The scheduler may also assist in determining runs in accordance with regulatory compliance such as, for example, by scheduling control tissue samples/slides in staining runs. Such regulatory compliance information and requirements may be communicated as an input to the scheduler and the scheduler may produce scheduled output runs in accordance with this, and other criteria as may be specified.

It should be noted that the functionality associated with the scheduling operations may be performed by any one or more components in a system. Some example configurations, such as those which are a partnership of host computers and/or other components, are described herein but should not be construed as a limitation of the techniques described herein.

In processing slides or other samples, slides of a particular case may be broken up so that each of the slides is processed by different instruments. For example, in order to maximize throughput, slides may be processed in accordance with a particular antibody. Slides associated with a first antibody from a first set of cases may be processed in a first run. Other slides associated with a second antibody from the first set of cases may be processed in a second run. After all slides of the first set of cases have been processed, an embodiment may include a post run slide sorting step to re-collate slides of each case back into their respective case folders. In other words, for efficiency in processing, cases of slides may be separated. After processing (e.g., staining) of the slides is complete, the slides may be regrouped by case. In an embodiment, this collating step may be performed in a manual and/or automated fashion. For example, the slide information as may be included in a bar code label, RFID label, or other form on each slide may be used in this collating step. The bar code label of each slide, for example, may include the encoded case information used to group together slides of the same case. The slides of each case may then be placed into a single case folder.

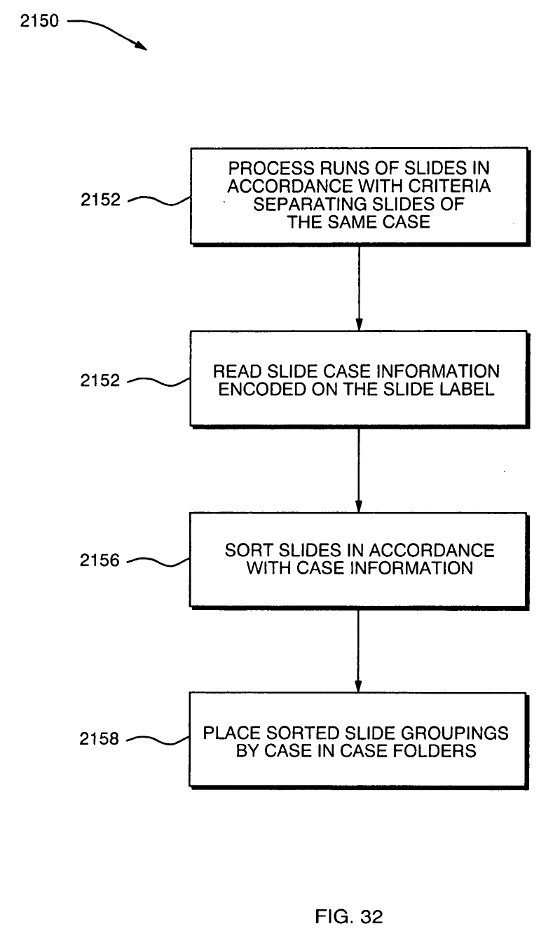

Referring now to FIG. 32, shown is a flowchart 2150 of processing steps that may be performed in an embodiment in connection with processing slides or other samples for collating. The steps 2150 generalize those just described in using encoded slide or sample information to sort the slides. At step 2152, the slides are processed in runs determined accordance with one or more criteria. As described above, slides may be separated in accordance with antibody in order to have more efficient processing maximizing throughput. The runs processed at step 2152 may be determined manually or in connection with using the scheduler described herein. At step 2154, case information about each slide is read from the encoded information, such as for example may be encoded in a slide's bar code label. The case information may be read using a machine, such as an optical reader, an RFID reader, or manually, by a person reading a printed label. Slides having the same case information may be grouped together at step 2156. At step 2158, slides of the same case are placed in the appropriate case folders. Processing of steps 2156 and 2158 may also be performed manually and/or using automated techniques. It should be noted that slides of a same case may be, for example, all slides produced from a gross tissue sample as may be identified using the case identifier described elsewhere herein. In one embodiment, as slides are processed, they may be placed into one or more collection locations. The slides from these collection locations may be sorted automatically in accordance with case identifier using a reader for the particular type of label. Those slides having a common case identifier may be placed in a same output grouping which are subsequently placed in a case folder.

In another embodiment, location information about where a slide is being processed in a lab may be tracked as the slide's location varies. The information may be entered manually and/or automatically. The information may be collected automatically, for example, by having the laboratory instruments report information about slides as they are processed or loaded into the instruments using a bar code or other reader. The information may be manually entered, for example, with a user interface on a host. The information may then be replicated in other locations, such as the database of the IPS and other hosts. At some later point in time, processing may be performed, for example, by a host or remote operator of the LIS system, to query the VLM database (as may reside, for example, on or connected to the IPS), to determine the location of all slides included in a same case. The information may be used to locate and combine slides of a same case.

Referring now to FIG. 33, shown is another example of an embodiment of a system illustrating remote access and cross host case reporting from a client. In the example 2200, included are components similar to those described in connection with other figures. Also included in 2200 are an IPS data store 2206, host 1 data store 2202, host 2 data storage 2204, and a client 2210. The client 2210 may be client software that may execute on a system connected to the IPS. The client 2210 may be remotely or otherwise connected to the IPS using any one of a variety of connections described herein and as known to those of ordinary skill in the art. The client 2210 requests of the IPS, acting as a server, certain information. The software and/or hardware providing this service may be, for example, included as functionality in the VLM, an additional component, or functionality embodied in multiple hardware and/or software components. For example, the IPS may include a Webserver which serves web pages including requested information. The Webserver may communicate with the VLM to obtain the necessary web page and information requested by the client. The VLM may control access to, and produce information used in connection with, web pages served by the Webserver. Alternatively, the VLM may control access to a web page and may obtain data values from a data base. However, the VLM may communicate with another component to query the hosts and/or perform any further processing on raw data values obtained from the database in order to produce the necessary data to populate a served web page. The VLM or other component may issue a request, such as a UDP request, to all hosts to report back any information (e.g., case, service, etc.) in accordance with a client request.

The hardware and/or software components used in the foregoing client reporting processing as illustrated in FIG. 33 may be on one or more different computer system configurations that may vary with each embodiment. For example, the Webserver may be on the same or different computer system than the VLM. In an embodiment, the Webserver, VLM and any additional components may also be located on the same computer system. In one embodiment, the request made by the client 2210 may be made in accordance with a query entered using an interface, such as a graphical user interface, through the client. For example, a request may be made to view all data associated with a particular case. This data may include case information associated with the order as may be communicated from the LIS to the IPS, post run information such as staining protocols, reagents, and the like, used in connection with processing the order. The example 2200 represents a snapshot of the system at a point in time after the order for case has completed processing to satisfy the order. In one embodiment, an order that has not yet been completely processed is stored in the data store 2206.

At any point in time, 2206 includes information representing the current caseload of orders in progress that have not yet completed. As the order is processed, post run information about the different processing steps can be returned from host to the IPS. This post run information may also be stored locally in each host and in 2206 while an order is in progress. When order processing is complete, information may be removed from 2206 with the postrun information remaining in each host's respective data store. It should be noted that as described herein, the postrun information may be a superset of some or all of the original order information, case information, and the like. The information maintained at each host after order processing has completed also includes case information in order to identify and collate all information associated with each case. With reference to FIG. 33, a client may request all information about Case 1. Since the order for Case 1 in this example has completed processing, no information is found in 2206 by the IPS. The IPS then communicates with each of the host, such as host 1 and host 2, to obtain all information on Case 1 as maintained on each host. The IPS may then gather this information received from the one or more hosts on Case 1 and return it to the client, for example, in the form of a web page that may be displayed by Internet Explorer. In the event that processing for Case 1 was still in progress at the time of the query, the database 2206 also includes information about Case 1 and such information may also be returned in response to a query.

The client 2210 may be used to obtain report information in accordance with a query. The information may be in connection with an order that is in progress, or has completed processing. An embodiment may similarly provide report information for any one or more purposes to a client. The IPS may act as a server serving up report information in the form of HTML, XML, and the like, to a client for operations in connection with reporting. It should be noted that the report generating functionality may be provided by the VLM or other component. In one embodiment, the VLM may manage the web pages which are in XML. As known to those of ordinary skill in the art, XML may be transformed into a variety of different formats and styles using, for example, XSLT Transforms. The transformed and populated web page may be returned to the client.

The IPS, such as the VLM and/or other component(s) executing on the IPS in one embodiment as described herein, may also perform product inventory and tracking. Code may be executed on the IPS to obtain historical data, for example, about historical use of reagents over time, detect re-order threshold limits, and maintain just-in-time product inventory. The IPS may include a background thread that runs in a continuous manner monitoring reagent inventory and determining, based on historical usage and/or expiration dates, when one or more reagents fall below a threshold level triggering a reorder. For example, based on historical usage, expiration information of reagents, and the amount of time it may take to obtain a reagent, reorders may be automatically generated by the IPS. The IPS, such as the VLM and/or other component(s) executing on the IPS in one embodiment described herein, may be connected to another system providing pricing models. Based on expiration date of a particular reagent, it may be determined automatically to reorder in a particular quantity to obtain a discount currently being offered by a reagent supplier. Such pricing information, discounts and the like may vary over time. In one embodiment, the foregoing functionality of product inventory and/or tracking may be performed through a cooperative and communicative effort of one or more components such as, for example, inventory management functionality for each host (e.g., historical data), RFID tracking (e.g., more current reagent information than may be available otherwise), and a component such as the VLM and/or Webserver serving reports.

Reagents may include modifiable or writeable RFID labels that may be updated to reflect a current quantity. Such information may be read from the RFID labels of the reagents and other supplies to provide real time inventory information. The inventory information may be sent to a host or other system in communication with the RFID components. The host or other system may then relay such information to the IPS, such as the VLM within the IPS, and/or other component(s) that may be used in an embodiment in performing inventory management.

The VLM or other component, when performing inventory and tracking, may communicate with one or more other systems (not shown) to provide further integration of operations in connection with ordering and tracking. For example, in one embodiment the VLM and other components performing the inventory and tracking may execute on the IPS. In connection with performing inventory and tracking operations, these components may communicate with an accounting system to streamline order approval process. The IPS may also communicate with an electronic system of the reagent supplier, for example, to electronically place an order for supplies. The IPS may further communicate electronically with a system of a selected delivery service, such as UPS, Federal Express, and the like, to provide information about the progress of delivery. Information about an order, inventory, and the like, may be provided through reporting functionality to a client from the IPS acting as a server as described above.

The foregoing are some examples of different functionalities that may be provided through integration of one or more systems. The particular functionalities may vary with each embodiment.

QC processing may be performed in an embodiment in a variety of different aspects as described herein. As another form of QC, the IPS may include a component such as the VLM or other component which communicates with the hosts to perform QC processing in accordance with aggregated test results from one or more slides or other sample in a case and with a template. In one embodiment, the hosts may perform QC testing in accordance with the template. Each host's QC testing information may be replicated to other hosts using the VLM and other techniques described herein. The template may define, for example, certain expected combinations of test results. In the event that the aggregated test results do not fit one of the expected combinations, the IPS or one or more of the hosts may automatically reorder one or more tests. In addition to, or as an alternative to defining acceptable test results, the template may define an action to be taken if the aggregated test results are one of the defined erroneous QC patterns.

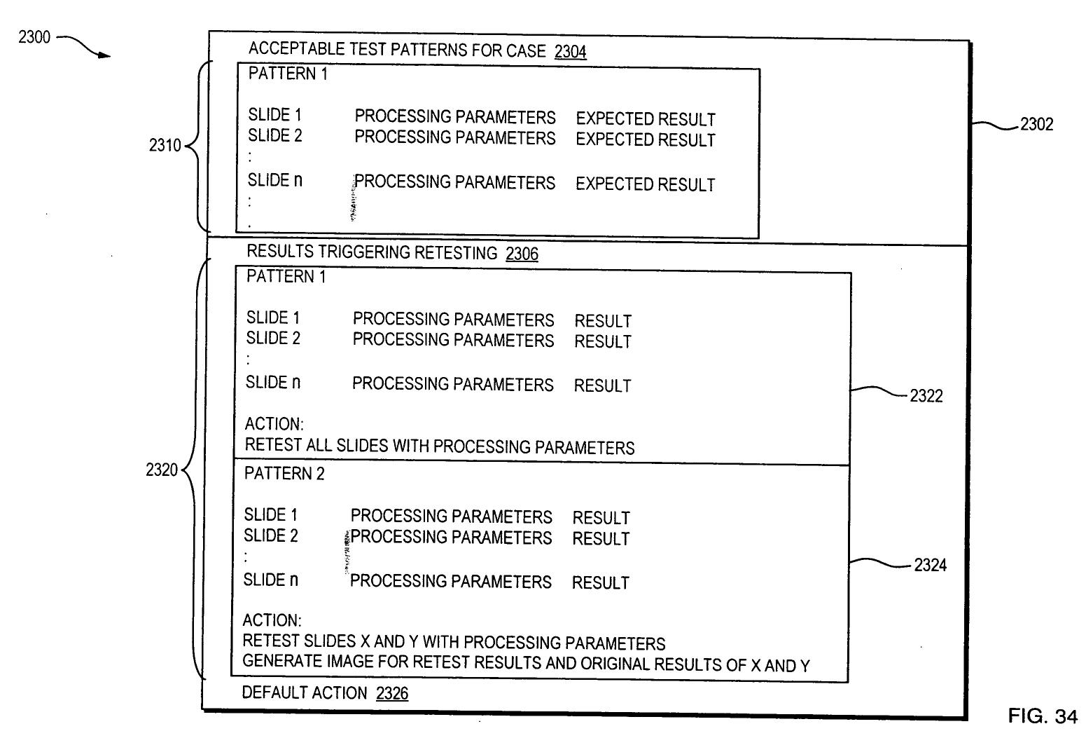

Referring now to FIG. 34, shown is an example representation of a template that may be used in automating QC processing for retesting. The template may be stored, for example, in the database of the IPS. The example 2300 includes a template 2302 with a set of acceptable test result patterns in area 2304 and a set of results triggering retesting in area 2306. The area 2302 includes one or more test result patterns. The area 2306 includes a set of test results and one or more actions to be taken if the defined test result is determined. For example, if pattern 1 in area 2306 is determined, all slides are retested. The particular information for retesting may also be included in the template. An embodiment may also include a template which includes only area 2306. If a case meets one of the specified patterns in section 2306, then retesting is performed. Otherwise, it may be determined that the results are acceptable. In an embodiment including both sections 2302 and 2306, a test pattern may be specified in section 2326 which covers all remaining conditions. In the event that one of the conditions in sections 2304 and 2306 are not met, the default action in 2326 may be performed. An embodiment may use any one of a variety of different formats and techniques for the template specification and evaluation. This automated retesting may be performed, for example, by each host, by the IPS, on another system on which the VLM is executing in one embodiment, or on other components in the system described herein. In one embodiment, a QC failure as detected by one host using a particular reagent, for example, on a rejected stained slide may cause other hosts to place on hold any further processing of all reagents used on the rejected stained slide. In other words, any further use of all reagents used on the rejected slide may be put on hold. The QC failure may be determined by a host. Upon detection of this failure, the host, VLM, or other component in communication with the detecting host, may determine which other reagents were used on the rejected stained slide. The data within the database as maintained by the VLM may be updated to reflect that further processing for the one or more suspect reagents is on hold. This information may then be replicated to the other hosts via the VLM.

In connection with a QA failure, the failure may involve one or more instruments and/or one or more elements used in connection with processing such as, for example, a reagent. In response to the detected QA failure, an embodiment may perform any one or more different actions. In one embodiment, a lockout process may be performed such that, for example, further processing involving the instrument, reagent and/or other component associated with the failure is disallowed. An embodiment may also take other actions, besides a lockout, in connection with the QA failure. The actions may be of varying degrees of severity, for example, that may vary in accordance with the particular QA failure. For example, an embodiment may allow subsequent use of an instrument, reagent, and/or other component associated with a QA failure coupled with notification of the detected failure. An embodiment may, for example, output a notification to any one or more output devices regarding the QA failures detected. To continue to use the instrument, reagent, or other element associated with the QA failure, a technician may have to acknowledge the QA failure and positively indicate approval (e.g., input through a graphical user interface) to continue to use the elements associated with the QA failure. It should be noted that a QA failure may be associated with any one of a variety of different criteria and qualifications. For example, certain QA requirements may be specified by a first set of regulations for certifying or qualifying a reagent, instrument, and the like. A QA failure may be associated with one or more of these regulation sets and/or elements (e.g, reagent, instrument, and the like).

In response to the detection of a QA failure, a report or other notification message may be automatically generated and sent to a lab manager, technician, and the like. The notification may take the form of an electronic notification such as, for example, an e-mail message, pager notification, and the like. Such notification and/or report generation may occur with all QA failures, or a portion of detected failures meeting predetermined criteria such as, for example, a particular severity level, if a certain number and/or type of failures are detected in a defined time period, and the like.

An embodiment may also include a report generation functionality which allows a user, for example, to selectively request certain information regarding QA failures and generate a report in response to the particular user criteria.

The reports and/or notifications may include varying levels of detailed information. the varying level of detail may be in accordance with specified criteria including, for example, user specified criteria, a severity level, regulations or other compliance criteria, and the like.

It should be noted that the foregoing system, may include any one or more different types of instruments. In one embodiment with reference to FIG. 3 elements, an instrument 114 may be an imager. The imager may produce an image file as described elsewhere herein. As a result of processing performed by the imager, image information may be produced. The image information may include image data stored in a particular file type and/or format. The image information, or portions thereof, may be stored locally in a memory on the imager, uploaded to the host controlling the imager, and/or replicated on the other hosts using techniques described herein in accordance with the particular configurations of each host and the system. In one embodiment, the image file may be stored on a storage device, for example, attached to the instrument and/or host. The image file name and/or all or a portion of the image file data may be uploaded from the instrument. In an embodiment as described elsewhere herein using writeable RFID labels, the image file name and/or a portion of the image file data may be written to the RFID label. It should be noted that the image file data, or portion thereof, as may be written to the RFID label may be stored in a format, such as a compressed or other format. The imager, or other instrument as may be included in an embodiment, may also report the identity of slides, or selected samples being processed at certain times, to the host. Such information may be replicated to the other hosts and/or database and used, for example, to locate one or more particular slides, samples, and the like.

The foregoing describes a system in which hosts can be networked to communicate with each other to form an integrated laboratory environment. The components of the systems described herein, such as in FIG. 3, may all be physically located in a same location, or may be located in one or more different locations. Components that are in different locations may communicate with other components using any one of a variety of different connections as known to those of ordinary skill in the art. For example, the LIS may be remotely located from the IPS and hosts. It should also be noted that although example embodiments described herein may be fully integrated and connected, those of ordinary skill in the art will appreciate that techniques described herein may also be used in embodiments in which not all the components are connected or as described herein. For example, the techniques described herein using RFID labels to track slides in a laboratory may also be used in an embodiment having only IPS-host connectivity without LIS-IPS connectivity.

A system as described herein may provide configurable data sharing between one or more hosts using the VLM that may be included in an embodiment. Data may be automatically replicated on each host. Reagents, protocol assignments, user privileges, and the like, that may be registered on different hosts may be replicated automatically to all hosts. For example, the VLM may act as a data repository for the latest version of data by having hosts constantly send updated data to the VLM and additionally having the hosts request and receive any data updated from the VLM. As a benefit of data sharing and replication, slide label printing can be performed on any host. Slide labels can be configured to print automatically when an order is received from the LIS when using optional VIP software. In one embodiment, this may be performed in connection with order placement. For example, when an order is placed in the VIP via HL7 messaging, an embodiment may include one or more fields in a message to facilitate label printing options. A configuration data element may be used to indicate a particular host and associated printer is to be used for label printing. Additionally, the same or different data element may include a printing mode indicator. In one embodiment, the printing mode indicator may be queued or pass through. The queued mode indicates that any labels for the associated order remain in the label printing queue until a subsequent request, such as by a user, is made to print the labels. In queued mode, the label printing is not automatic. If pass through mode is specified, once the designated host and printer is aware of the new order, the label(s) associated with that order print automatically. The printing option may be specified on a per order basis in an embodiment. Alternatively, an embodiment may also include a configuration option, such as the site bar code symbology configuration option described elsewhere herein, that may be used for new orders. The configuration option may include the particular host and/or printer designation as well as the particular printing mode. The foregoing also provides for communication via messaging between the LIS and components of the laboratory through the a single interface point, the VIP. A bidirectional interface is described that provides for orders to be sent to the laboratory and status and report information to be sent back to the LIS. As part of the order information, case data including patient information and other data is communicated from the LIS to the laboratory eliminating the need for manual patient data entry and possible re-entry. The benefits of the features described herein, such as the LIS connectivity for slide ordering and label printing, may be more apparent in larger laboratory environments.

In existing A/P laboratories, the process to place a tissue sample on a slide may be characterized as highly manual with redundant data entry and the introduction of errors at multiple points in the workflow process to obtain the marked slide. Techniques are described herein that may be used to facilitate the workflow process by eliminating redundancy and reducing the potential for introducing errors. The techniques as described above and in following paragraphs may be used to facilitate and automate the workflow process in the A/P laboratory as well as other laboratories with their associated workflow process.

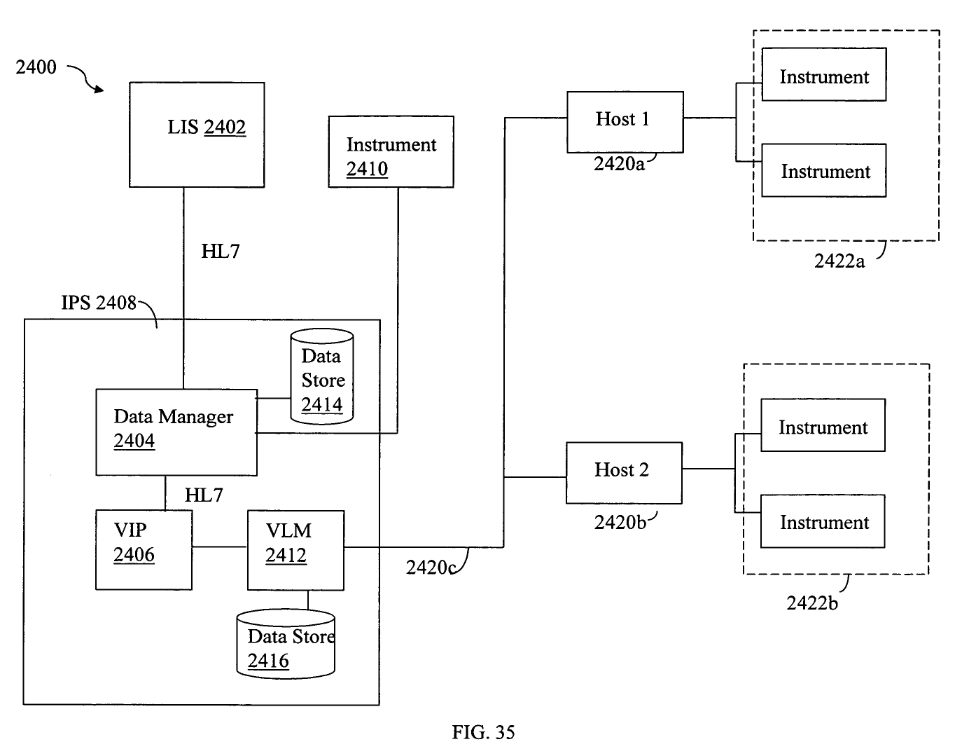

Referring now to FIG. 35, shown is an example of an embodiment of a system that may utilize techniques herein. The example 2400 includes an LIS 2402, an IPS 2408, hosts 2420a-b, and instruments 2422a-b and 2410. The IPS 2408 may include a data manager 2404 with data store 2414, VIP 2406, and VLM 2412 with VLM data store 2416. Some of the components, such as the IPS, VIP and VLM, illustrated in the example 2400 are described elsewhere herein, for example, in connection with FIG. 3. As described in more detail in following paragraphs, the processing of communications sent from the LIS 2402 to the IPS 2408 may be partitioned between the data manager 2404, VIP 2406 and VLM 2412.

In one embodiment, the VIP 2406, VLM 2412 and VLM data store 2416 may be used in connection with processing communications for only secondary staining instruments, such as special or advanced staining instruments 2422a-b controlled, respectively, using hosts 2420a-b. The VLM may perform a first set of processing operations for test orders and communications with respect to the special or advanced staining instruments 2422a-b. The special or advanced staining instruments 2422a-b may include, for example, an immunohistochemistry (IHC) slide staining instrument, such as a BenchMark® system by Ventana Medical Systems, Inc., of Tucson, Ariz., or other secondary or special staining instrument (e.g., NexES® SS stainer by Ventana Medical Systems, Inc.) such as those using chemical dye stains that localize to microorganisms found in tissue and to specific tissue types. The embodiment 2400 may also include other types of instruments besides the special or advanced staining instruments. The other instruments may include, for example, a primary staining instrument 2410 that performs hematoxylin and eosin (H/E) staining, such as a SYMPHONY™ System by Ventana Medical Systems, Inc. The instrument 2410 may not be controlled using one of the hosts 2420a-b. Rather, the primary staining instrument 2410 may control its own operation using one or more processors included therein. In such an embodiment as illustrated in 2400, the data manager 2404 may receive all incoming communications from the LIS 2402 such as, for example, test and case information for tests to be performed by the instruments 2422a-b and 2410. Communications between the LIS 2402 and the IPS 2408 may be in accordance with the HL7 protocol as described elsewhere herein and also known in the art. The data manager 2404 may receive the incoming data from the LIS 2402, handle all processing for communications relevant to instruments 2410, and additionally pass on those communications to the VIP 2406 relevant to the special or advanced staining instruments 2422a-b for the first set of processing operations. The data manager 2404 may also perform a second set of processing operations on received communications relevant to the specialized/advanced stainers, primary stainers, and possibly other instruments that may be in the example 2400. For example, as described in more detail in following paragraphs, the data manager 2404 may provide for checkpoint notification and other processing for all instruments in the laboratory. Checkpoint notification provides for notification in the event that an entity in the laboratory, such as a slide, tissue specimen, and the like, is not processed by a particular workflow point by a specified time. The data manager 2404 may utilize harmonized identifiers also used by the LIS 2402. Harmonized identifiers are identifiers used to differentiate between different entities, such as patient samples, control, and the like, in the workflow process. The harmonized identifiers are used by one or more consumers, such as within the laboratory and by external consumers, such as hospitals and the like. Additionally, the data manager 2404 may perform processing to improve the workflow process of the laboratory. The data manager 2404 may communicate with the VIP 2406 in accordance with the HL7 protocol. The data manager 2404 may also perform any mapping or translation of identifiers, such as mapping a harmonized identifier to another identifier that may be used by the VIP and VLM. Additional detail regarding the harmonized identifier, checkpoint notification, and processing to improve the workflow that may be performed in an embodiment are described in more detail elsewhere herein.

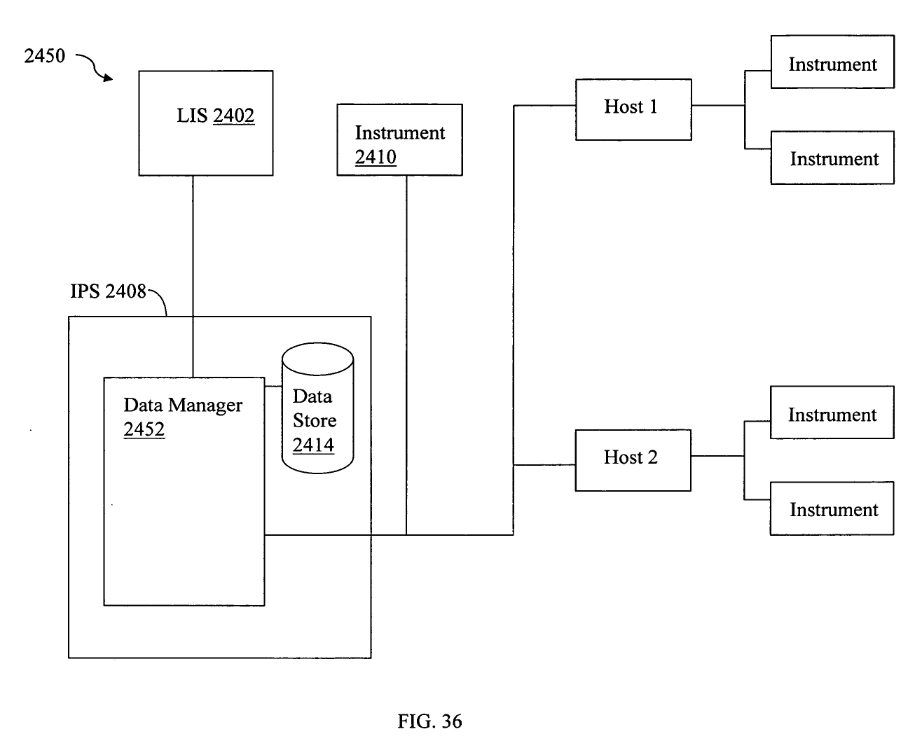

It should be noted that the instruments in FIGS. 35 and 36 may be stainers or other instruments that may be used in connection with laboratory processing. Stainers as described herein for illustrative purposes only as will be appreciated by those skilled in the art.

In one embodiment, the VIP and VLM may be existing components of the IPS 2408 performing the first set of processing operations for special/advanced staining instruments 2422a-b. At a later point, the processing performed by the IPS 2408 may be expanded in two aspects. The processing may be expanded so that other processing tasks besides those included in the first set of processing operations are performed for the instruments 2422a-b. Additionally, the processing operations performed by the IPS 2408 may also be expanded to apply to other types of instruments 2410, such as a primary stainer, besides those included in 2422a-b. In the example 2400, the data manager 2404 may perform the additional processing, such as the checkpoint notification, for the instruments 2422a-b. The data manager 2404 may also perform all processing tasks for the new or additional instruments, such as 2410. In such an embodiment, the data manager 2404 and its data store 2414 may be added as a new component to an existing IPS 2408. The new or additional instruments, such as 2410, may communicate directly with the data manager 2404. As described above, all incoming communications are received by the data manager 2404 which then filters out and passes on those communications of interest to the VIP 2406, such as those communications for the test orders, case information, and the like for the instruments 2422a-b. Communications received by the VIP from the VLM and hosts connected thereto may be communicated to the data manager 2404. Communications between the hosts 2420a-b and the VLM may be over a communication connection 2420c as described elsewhere herein.

The data stores 2414 and 2416 may be databases or any other type of data container used for storing data in accordance with any of a variety of different organizations known in the art.

It should be noted that although the additional instrument 2410 is shown as communicating directly with the data manager 2404, an embodiment may also utilize a device interface, such as an API (Application Programming Interface) between 2404 and 2410 to facilitate communications therebetween. For example, there may be a variety of different additional instruments for which the data manager 2404 performs processing as described herein. A different interface may be used for each of the different instruments to facilitate communications with the data manager 2404.

Referring now to FIG. 36, shown is an example of another embodiment of a system that may utilize the techniques herein. The example 2450 includes components similar to those described and illustrated in FIG. 35. The data manager 2452, in contrast to the data manager 2404 of FIG. 35, may perform processing for all instruments in the laboratory rather than partition the processing operations between the data manager and other components, such as the VIP and the VLM, of the IPS 2408.

It will be appreciated by those skilled in the art that the exemplary embodiments of FIGS. 35 and 36 are just two ways in which functionality performed by the IPS 2408 may be partitioned among various components on the IPS. For example, FIG. 35 is an exemplary embodiment of how functionality of the IPS may be expanded by adding new components, such as the data manager 2404. At a first point in time, customers of the VIP and VLM may have a configuration as illustrated in FIG. 35. At a subsequent point in time, such customers may then migrate to a later version of the data manager 2452 and utilize a configuration as illustrated in FIG. 36.

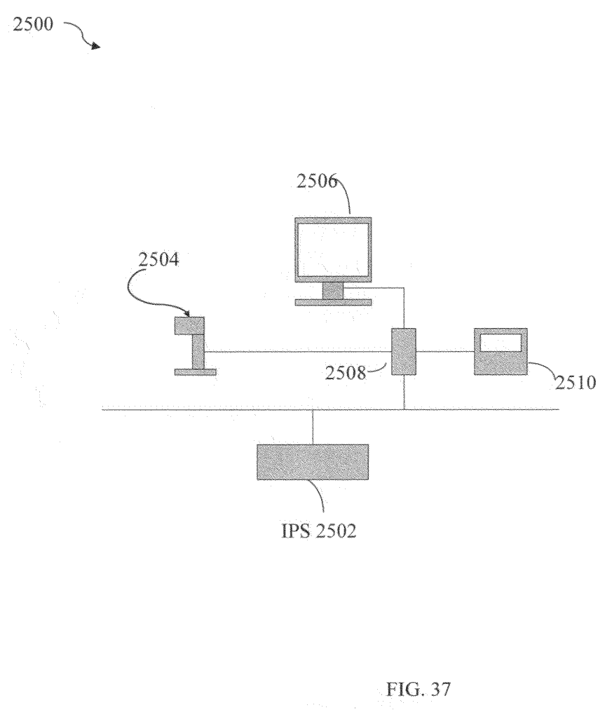

Referring now to FIG. 37, shown is an example representation of a workstation configuration. Workstations may be utilized in a laboratory at the various workflow processing points that will be described in more detail in following paragraphs. As known in the art and described in more detail elsewhere herein, the workflow process associated with producing a tissue sample on a glass slide includes multiple steps. One or more workstations may be used in connection with processing at each step in the workflow process. Workstations connected to the IPS, directly or indirectly through an intervening host (e.g., host 2420a-b), may be positioned at various points in connection with processing the tissue specimen. For purposes of simplicity in illustration, the workstations are not explicitly included in the illustrations herein, such as FIGS. 35 and 36. FIG. 37 shows a simplified view of a single workstation configuration connected to the IPS 2502. A workstation site may include a computer system, such as a thin PC client 2508 and the touch screen 2506. An embodiment may also include an all-in-one PC and touch screen combination device as an alternative to the components 2506 and 2508. The computer system 2508 may have one or more other devices connected thereto for use at the workstation. Such devices may include a bar code imager 2504 and printer 2510. The printer 2510 may be a label printer, such as a thermal transfer printer, a printer capable of printing on glass slides, and the like, in accordance with the different printing that may be performed at the workstation. In one embodiment, the computer 2508 may execute a browser to interface with a server component on the IPS 2502. The particular devices connected to computer 2508 may vary with embodiment. For example, if bar codes are used for labeling the different entities in the laboratory, then a bar code reader and/or printing device may be used at the workstation. If RFID tags are used, then the appropriate reader/writer may also be included at the workstation. The different types of tags or labels (e.g., RFID tagging, different types of bar codes, other forms of machine readable identifiers, and the like) that may be used in connection with different entities (e.g., specimens, slides, blocks or cassettes) are described elsewhere herein.

It should be noted that the software and hardware of the IPS as described herein may be included in a server computer system with software executing thereon as well as an appliance or other component(s) capable of performing the processing described herein.

The different devices, such as computer peripherals, bar code reader, and the like, of the workstation configuration, may communicate with the computer 2508 over a USB or other type of communication connection. The computer 2508 of the workstation configuration 2500 may communicate with the IPS 2502 over an Ethernet, wireless or other communication connection.

As will be described in following paragraphs, workstations may be positioned at various locations in the laboratory for use in connection with processing a tissue specimen, block or slide.

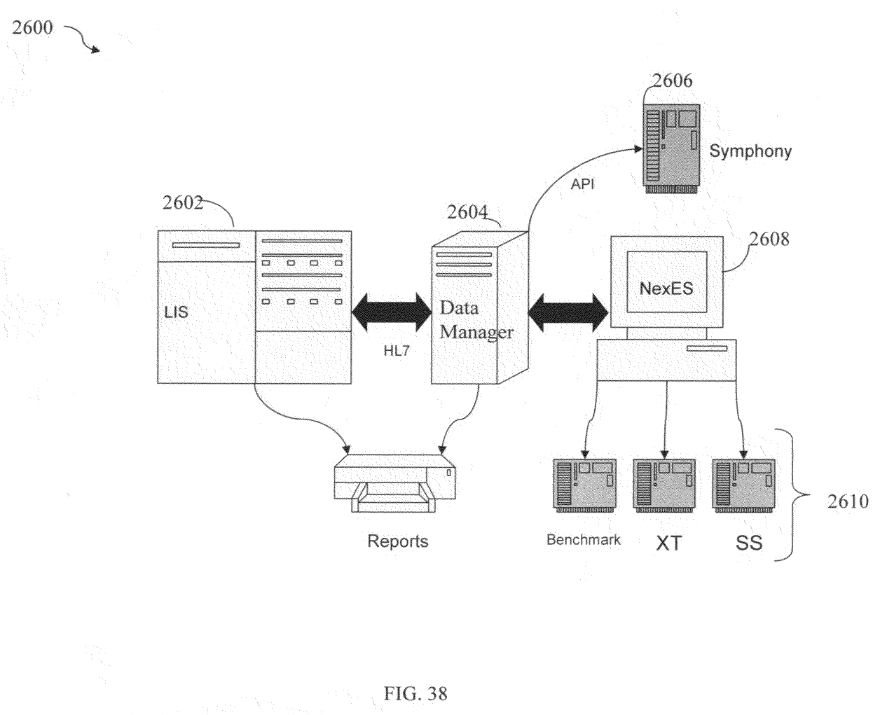

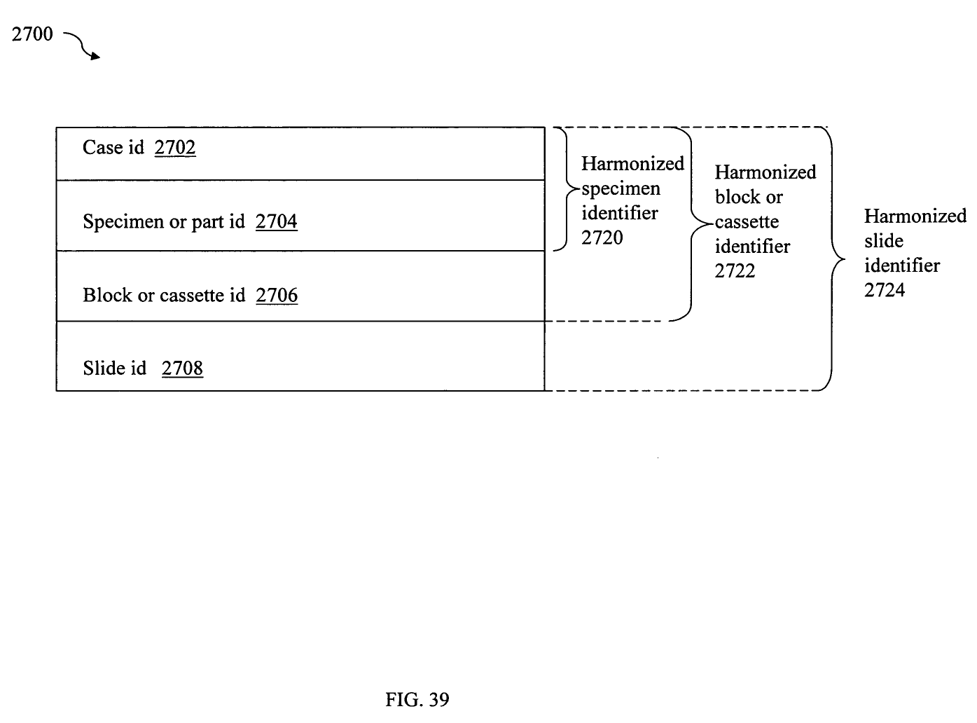

Referring now to FIG. 38, shown is another representation of components that may be included in an embodiment using the techniques herein. The example 2600 may be another representation of components included, for example, in FIG. 36. The LIS 2602 may communicate in accordance with the HL7 protocol with the data manager 2604 as may be included in the IPS. The data manager 2604 may communicate with one or more hosts 2608 each executing a version of software, such as Ventana Medical Systems' NexES® software. Each host 2608 may communicate with instruments, such as specialized or advanced stainers 2610. Other instruments, such as primary stainer 2606, may communicate directly with the data manager 2604 without utilizing an intervening host. The primary stainer 2606 may be, for example, a SYMPHONY™ System by Ventana Medical Systems, Inc. The advanced or specialized stainers 2610 may include, for example, a NexES® IHC stainer, NexES® SS stainer, BenchMark®XT stainer, and the like, all from Ventana Medical Systems, Inc.

The harmonized identifier will now be described in more detail.

The harmonized identifier is an identifier which may be utilized by the LIS, within the laboratory, and other information systems in communication thereto, to uniquely identify an entity. A harmonized identifier is harmonized with respect to one or more consumers or users of the harmonized identifier such as, for example, the LIS, the A/P laboratory, hospital information systems communicating with the computer systems and databases of the laboratory, and possibly other sites remote from the A/P laboratory. The harmonized identifier has a level of uniqueness with respect to the consumers thereof to allow for identification and tracking of an entity by the consumers. The level of uniqueness may also be with respect to a time frame such as an expected usage time of an entity by the consumers. There may be more than one type of harmonized identifier for the different entities. For example, there may be a harmonized slide identifier used in connection with tracking and identification of a slide for the expected lifetime of the slide as stored in the laboratory. The harmonized slide identifier may be recognized and used by the LIS, A/P laboratory, and one or more other vendors for uniquely identifying a slide for a time period such as, for example, the amount of time that the slide may be used and stored in the A/P laboratory slide archive. A harmonized case identifier, harmonized specimen or part identifier, and harmonized block or cassette identifier may also be used as described in following paragraphs.

Each of the different harmonized identifiers may be characterized as locally unique among those facilities sharing the same information. For example, 3 laboratories and 3 hospitals having information systems in communication with one another may use the same harmonized identifier for an entity to allow the entity and associated harmonized identifier to be differentiated from others by each of the consumers (e.g., the hospitals and laboratories).

Referring now to FIG. 39, shown is an example of different data portions that may be used in connection with forming the different types of harmonized identifiers described herein. The example 2700 includes a case id (identifier) or case number 2702, specimen or part id (identifier) 2704, block or cassette id (identifier) 2706, and slide id (identifier) 2708. Each of the foregoing ids may be assigned as part of accessioning, for example, when the one or more tissue specimens of a patient are received at a lab. The ids may be used in forming the different harmonized identifiers which are utilized at various workflow processing points. For example, for a first specimen, the case id 2702, specimen id 2704, and one or more block ids may be assigned as part of accessioning and then used in forming the harmonized block identifiers 2720 for blocks formed from the first specimen. The harmonized block identifiers may be used in connection with labeling or marking cassettes for the respective blocks at grossing.

The case id 2702 is an identifier associated with a patient, patient related information, one or more specimens, all blocks or cassettes and slides produced therefrom, test orders and results, and the like. In an embodiment using harmonized identifiers, the case id may also be referred to as the harmonized case identifier. The specimen or part id may be assigned when the specimen is received at the laboratory as part of accessioning. Collectively, the combination of case id 2702 and specimen or part id 2704 may form the harmonized specimen or part identifier 2720. The block or cassette id 2706 may be assigned as part of accessioning at the laboratory and used at grossing when partitioning a specimen. Collectively, the combination case id 2702, specimen or part id 2704, and block or cassette id 2706 may form the harmonized block or cassette identifier 2722. The slide id 2708 may be assigned as part of accessioning and used when the tissue blocks are cut and placed on slides. Collectively, the combination of the case id 2702, specimen or part id 2704, block or cassette id 2706, and slide id 2708 may form the harmonized slide identifier 2724.

The case id or number 2702 may have the format:

LYY-nnn . . . nnn

where

L may be a letter representing a source of the tissue (e.g., S for surgery, B for bone marrow, CY for cytology specimen, B for biopsy, CB for cell block). L may also be one or more letters representing a facility from which a specimen arrived from (e.g., NW for Northwest Hospital).

YY may be the last two digits in the year in which the case id 2702 is generated (e.g., “07” for the calendar year 2007); and

nnn . . . nnn may represent a series of integers in which the next integer in a current sequence which may start over at 0 for each year. nnn . . . nnn may also be any element within a sequence of elements, such as an element in a sequence of alphanumeric characters where the sequence is incremented for each case for the year denoted by YY. The sequence may be reset at its start with each new year denoted by YY.

As an example, a case id 2702 may be “S07-12345” in accordance with the above format although other formats may be used in forming the case id. A case id may be associated with one or more specimens of a patient for which tests are to be performed on those specimens. For example, a surgical patient or an outpatient may have multiple tissue biopsies done. Each biopsy may be a specimen associated with the same patient that is associated with the case id 2702. It should be noted that a different number and type of character may be used to represent the source of the tissue (L) and the year (YY) when forming the case id 2702.

The specimen or part id 2704 may be one or more alphanumeric characters included in a sequence assigned to each specimen of a case. As an example, a specimen id 2704 may be a single letter (e.g, “A”) in the sequence of elements “A” . . . “Z” if there are no more than 26 specimens per case, single digit in the sequence of elements “0 . . . 9” if there are no more than 10 specimens per case (e.g., “1”), or a single letter and a number in combination (e.g., “S1” or “P1” for Part 1) of a defined sequence of elements. Each specimen associated with the same case id may have a different specimen or part id assigned. Each next specimen may be assigned a next element in a sequence of elements.

The cassette or block id 2706 may be one or more alphanumeric characters included in a sequence assigned to each block formed from a specimen. As known in the art, each specimen may be partitioned as part of the tissue processing at the laboratory into one or more partitions.

Each partition of the tissue specimen may be included in a different cassette or block. As also known in the art, a partition of the tissue specimen at grossing may be placed in a cassette. The cassette may refer to the tissue entity prior to embedding. After embedding, the tissue entity included in the cassette may be referred to as a block. As an example, a block or cassette id 2706 may be a single letter (e.g, “A”), single digit (e.g., “1”), or a single letter and a number (e.g., “B1” for block 1 of a particular specimen). Each block associated with a same specimen may have a different block or cassette id assigned. Each next block produced from a specimen may be assigned a next element in the sequence.

The slide id 2708 may be one or more alphanumeric characters, such as a series of one or more digits or letters in a sequence. For example, a slide id may be “001”, “002”, “A”, B”, “AA”, “AB”, “S1”, “S2”, and the like. Each slide produced from a same block may have a different slide id assigned as a next element in the sequence.

Each of the harmonized identifiers may be formed as a combination of different portions of ids 2702, 2704, 2706, and 2708 as described above in accordance with the point in the workflow process of the entity being processed, such as the specimen, block or cassette, and slide. In one embodiment, multiple ids of FIG. 39 may be concatenated to form the different harmonized identifiers. For example, based on the foregoing format, a harmonized slide identifier will be “S07-12345,1,A,01” for slide 1 of block A of specimen 1 from case id “S07-12345”. The harmonized block identifier for the block A is then “S07-12345,1,A”, the harmonized specimen identifier for specimen 1 is “S07-12345,1”, and the harmonized case identifier is “S07-12345”.

Based on the foregoing, a hierarchical representation with respect to the different tissue entities at different points in the workflow process may be viewed and used in forming the different harmonized identifiers.

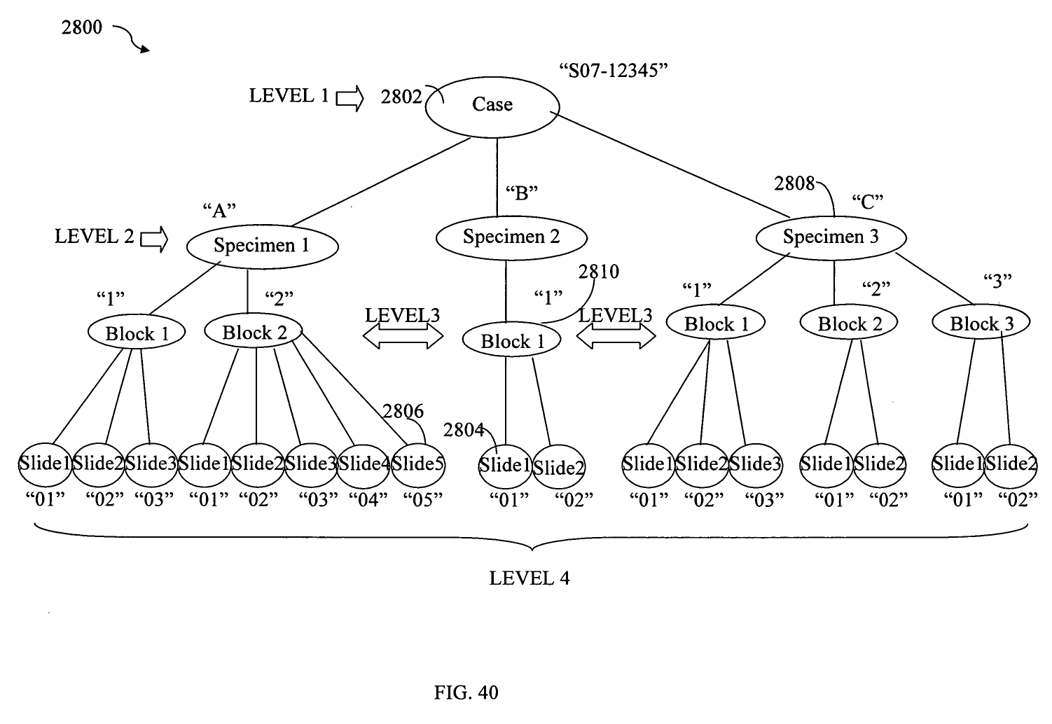

Referring now to FIG. 40, shown is an example illustrating the hierarchical representation that may be used in forming the different harmonized identifiers described herein associated with the tissue processing workflow. The example 2800 includes a hierarchical representation with a first or root level 2802 having a single node corresponding to the case id 2702. The second level includes a node for each specimen represented as a child node of the case node. In this example, there are 3 specimens denoted “A”, “B”, and “C”, respectively. The third level includes a node for each block produced from a specimen represented as a child node of the specimen from which the block is produced. In this example, there are 2 blocks for the first specimen, a single block for the second specimen and three blocks for the third specimen. The blocks are denoted by single digits (e.g., “1”, “2”, “3”) incremented for each next block produced from a specimen. The fourth level of leaf nodes includes a node for each slide produced from a block represented as a child node of the block from which the slide is produced. In this example, there are 3 slides for block 1 of specimen 1, 5 slides for block 2 of specimen 1, 2 slides for block 1 of specimen 2, 3 slides for block 1 of specimen 3, and 2 slides for each of blocks 2 and 3 of specimen 3. The slides in this example are denoted by digits (e.g., “01”, “02”, “03”) incremented for each next slide produced from a block.

Each id associated with a node in the hierarchy of 2800 may be associated with a point or processing step in the workflow process. Each level in the hierarchy may be associated with generating a different id (e.g., case id, specimen id, block id, slide id) from FIG. 39 in accordance with a workflow processing point of a tissue associated with a case and generating a different harmonized identifier. A harmonized identifier of a node in the tree may be formed by a combination of the foregoing ids included in a path from the root node to the node in the tree. To further illustrate, the harmonized slide identifier for node 2806 in this example is “S07-12345,A,2,05”, and the harmonized slide identifier for node 2804 in this example is “S07-12345,B,1,01”. Each of the foregoing harmonized slide identifiers may be formed using the ids associated with each node on the path from the root node 2802 to the respective leaf node at level 4. As described in more detail below, the harmonized slide identifier may be included on a slide marked or labeled at the cutting workstation. The harmonized specimen identifier for node 2808 in this example is “S07-12345,C”. The foregoing harmonized specimen identifier for node 2808 is formed using the id of the root node at level 1 and the id of node 2808. As described in more detail below, the harmonized specimen identifier may be included on a specimen container that is marked or labeled at a receiving station in the laboratory.

The data store of the data manager, for example, as illustrated in FIGS. 35 and 36, may include the information and relationships as represented in FIG. 40 allow for querying, retrieval and indexing of information included in the data store. Additional information, such as the various protocols, reagents, patient information, and the like, may also be stored in the data store and associated with the various elements illustrated in FIG. 40. The data store may be organized so that information associated with one of the harmonized identifiers may be retrieved. Based on a particular harmonized identifier associated with a node, information about one or more ancestors and/or descendants from the node may be retrieved depending on the operation being performed. For example, at a point in the workflow process, the harmonized case identifier may be entered to retrieve all information about a particular case or associated with the corresponding root node and its children in the hierarchy. As another example, the harmonized specimen identifier of node 2808 may be used to retrieve information about the particular specimen. If the specimen is currently at the grossing station prior to being partitioned, the information retrieved for the harmonized specimen identifier may indicate the number of blocks or cassettes to be formed. If a block is at the microtome, the harmonized block identifier may be used to determine the number of slides to be generated and thus the number of tissue samples to be cut for the block. As another example, when assembling a case folder of slides after slide processing is complete, each slide's harmonized slide identifier may be used to determine the appropriate case or root node to ensure that only slides of a same case are included in the case folder. Additionally, the foregoing may be used to verify, for a particular case associated with each slide included in the case folder, that all slides for the case are included therein, that no slide for the case is missing, and no other slides for other cases are included.

The information retrieved based on a harmonized identifier may also relate to other paths in the tree associated with the same case. As an example, a workstation may allow a logged-in user to perform a database query operation. The user may scan in a specimen label to read the harmonized specimen identifier and retrieve information about the case (e.g., ancestor node), blocks and/or slides produced from the specimen having the specimen label (e.g., children or descendant nodes), other specimens for the same case, (e.g., sibling nodes of the same case), slides of the other specimens, and the like.

An embodiment may also omit an identifier for a node at a level in the hierarchy if that node is the only child of its parent. For example, node 2810 is the only child of its parent node, specimen 2. As a result, an embodiment may form a harmonized block identifier for node 2810 that is the same as the harmonized specimen identifier which is “S07-12345,B”. Based on the foregoing, the harmonized slide identifier for the slide corresponding to node 2804 may be “S07-12345,B,01”. If node 2810 had only a single child (e.g., only 1 slide generated from block 1 for 2810), the harmonized specimen identifier may also be used as the harmonized slide identifier.

It should be noted that although the foregoing represents use of harmonized identifiers with tissue processing and associated workflow processing, it will be appreciated by those skilled in the art that the techniques herein for harmonized identifiers may be used with processing other samples and specimens besides tissues. For example, the techniques herein where samples are divided for further analysis, may be used for processing blood and other samples in the clinical chemistry, cytology, and other testing laboratories.

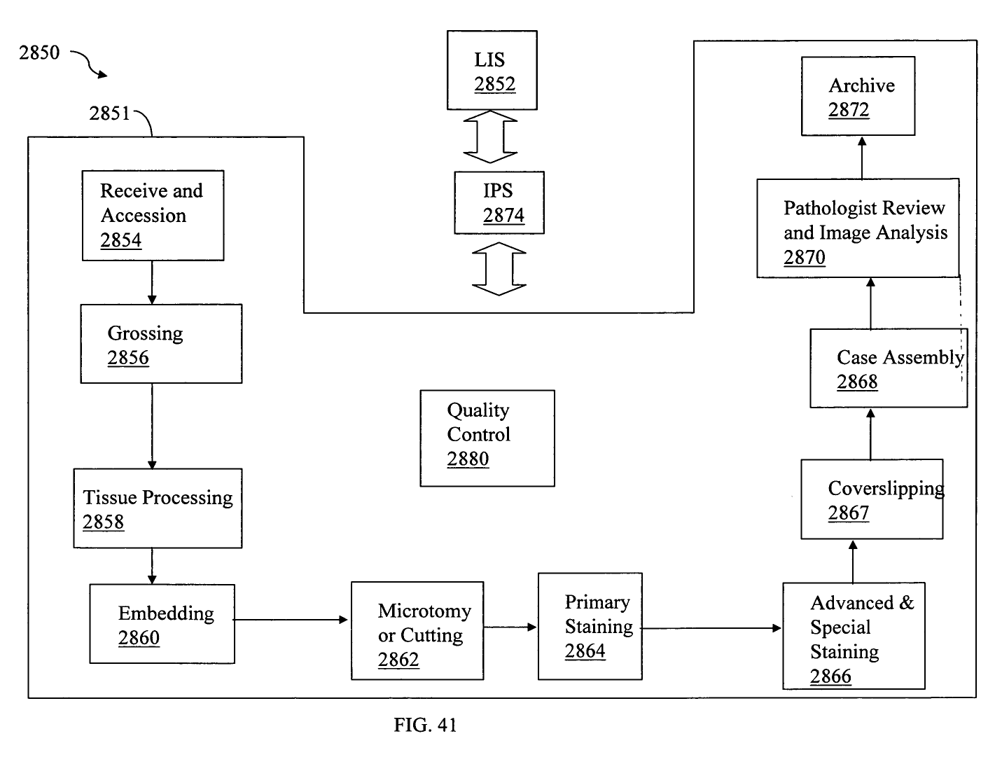

Referring now to FIG. 41, shown is a representation of different steps of the workflow process that may be performed with respect to one or more tissue samples. The example 2850 includes an LIS 2852, the IPS 2874, and a representation of the various workflow processing steps 2851 that may be performed in connection with one or more specimens. Although not illustrated in FIG. 41, the LIS 2852 may also be in communication with one or more other information systems as described elsewhere, for example, in connection with FIG. 3A. In an exemplary embodiment, the LIS 2852 may be a hospital's LIS where the tissue specimen(s) may be obtained from the hospital. A request for one or more tests may be entered into the LIS along with patient data as part of the receiving and accessioning process for the specimens in 2854 once the specimens are received at the laboratory. As part of the receiving and accessioning 2854, the LIS 2852 may generate a case id as a harmonized case identifier as described elsewhere herein. The LIS 2852 may also assign the other ids and generate the other harmonized identifiers of FIG. 39 associated with the tissue specimen(s) and samples to be derived therefrom in connection with laboratory processing. The IPS 2874 and the LIS 2852, as consumers of the same information, may use the same harmonization scheme in connection with the harmonized identifiers as described elsewhere herein. Typically the LIS is a networked software enterprise that links requesters and providers with test request and test status and result information. The LIS 2852 may store test requests and test data for patients within the hospital, and submitted from outside on an out-patient basis as well. The LIS may utilize a database for tracking the test for each patient having tests performed. The LIS assigns a case id or number to the patient and correlates the case id with data such as the treating physician, other physicians involved in the case, inpatient/outpatient status, insurance information, requested tests, status of tests, results of tests, etc. The LIS 2852 may be in communication with the IPS 2874 included in the network of the laboratory that will process the one or more specimens of the case id. The case id and other ids of FIG. 39, and thus harmonized case identifier and other harmonized identifiers, test orders, and other information initially entered at 2852 may be communicated to the IPS 2874. One or more workstations having a configuration as illustrated in FIG. 37 may be included for each of the elements denoted 2854, 2856, 2858, 2860, 2862, 2864, 2866, 2867, 2868, 2870, and 2872. Although not explicitly illustrated in FIG. 41, each of the workstations in connection with the workflow process may have connectivity to the IPS 2874 for retrieving and updating information stored thereon. For example, different ones of the harmonized identifiers may be retrieved from the database of the IPS 2874 for use at different workflow processing points such as retrieving the harmonized block or cassette identifiers when labeling or marking cassettes, and retrieving the harmonized slide identifiers when labeling or marking slides.

It should be noted that in connection with FIG. 41 and others herein, examples of a particular type of machine readable tag or identifier, such as a bar code, may be used. However, it should be noted that any type of machine readable tag or identifier may be used as described elsewhere herein in more detail and also known in the art.

In connection with the foregoing, all of the patient information, test information, and the like, may be entered as part of accessioning of the specimens when received at the laboratory. In other words, the one or more tissue specimens may arrive at the laboratory without having any existing information in the LIS for communication to the IPS 2874. For example, the tissue specimens may arrive at the laboratory receiving and accessioning 2854 with a paper requisition attached including the patient information, test orders, and the like. The case id and other ids, and thus the harmonized identifiers of FIG. 39, may be generated as part of accessioning and receiving 2854 when the specimen(s) are received at the laboratory. In this latter instance when a specimen arrives at the laboratory without information already existing in the LIS system, the patient information and test order information included on the paper requisition may be initially entered when the specimen is received at the laboratory as part of receiving and accessioning 2854. As a variation to the foregoing, a portion of the patient information, such as patient name, insurance information, demographics, and the like, may be entered using another external system connected to the LIS. In such instances, the portion of information is communicated to the LIS from the external system where the remainder of the information as described above may be entered as part of accessioning and receiving 2854 when the specimens are received at the laboratory.

As part of receiving and accessioning 2854, a harmonized specimen or part identifier is generated for each specimen. A label is also generated for each specimen including the harmonized specimen identifier. The label may be any one of a variety of different labels as described herein. For example, the label may include a machine-readable bar code identifier or other machine readable identifier with the harmonized specimen identifier encoded thereon along with a human readable form of the same. It is important in the workflow process that the container including the tissue specimen be labeled and tagged at this point in the process when received at the laboratory in accessioning and receiving to ensure proper identification and to reduce the possibility of specimen mislabeling.

It should also be noted that the ids of FIG. 39, and thus the harmonized identifiers, may be generated once the specimens are received at the laboratory as part of receiving and accessioning 2854.

After accessioning and receiving 2854, each tissue specimen in a labeled container is then delivered to a grossing station 2856 for processing. At the grossing station, the tissue specimen is partitioned. Each partition may be included in a different labeled cassette. The number of partitions, and thus cassettes, formed from the tissue specimen at the grossing station may be determined using the database of the IPS. In one embodiment, the tissue specimen label includes a machine readable bar code of the harmonized specimen identifier. The tissue specimen label may be scanned by a bar code reader at the grossing station to obtain the harmonized specimen identifier. The grossing workstation may then retrieve information related to the specimen from the database of the IPS based on the harmonized specimen identifier. The information retrieved may include the number of cassettes for the specimen. In response to scanning the tissue specimen label, information may be displayed on an output device, such as a computer terminal screen. The operator at the workstation may visually confirm that the displayed information matches the human readable form of information on the tissue specimen label. The operator may then select an option to mark a number of cassettes as indicated on the display. The grossing workstation may be integrated with a cassette marking device. In response to selecting the option to mark the cassettes, the process of marking the designated number of cassettes is commenced and each cassette is marked with a different harmonized block or cassette identifier. As described elsewhere herein, each of the harmonized block or cassette identifiers, as previously generated, may be retrieved from a database of the IPS 2874. Any one of a variety of different cassette marking devices may be used. For example, the cassette may be formed from hard plastic and the cassette marking device may form a harmonized cassette or block identifier encoded by a bar code on a surface of the cassette such as, for example, by performing a hot foil transfer. As another example, the cassette may be marked with a laser device which etches a bar code on the cassette. As yet another example, the cassette may have an RFID label affixed to a surface of the cassette. The specimen is partitioned into the appropriate number of partitions and each partition is placed into a labeled or marked cassette.

As a variation to marking or labeling the cassettes at the grossing station, the one or more cassettes may be premarked or prelabeled such as by the LIS. In one embodiment, the pre-marked cassettes that are associated with a container and specimen are delivered to the grossing station. Once at the grossing station, the premarked or prelabeled cassettes are scanned to verify that the cassettes are associated to the container.

An operator at the grossing station may enter special instructions, remarks, quality assurance issues, and/or notes which are then stored in the IPS database for the particular cassette and associated with the harmonized cassette or block identifier. The special instructions may be retrieved at a later workflow point. Special instructions may include, for example, notes regarding the state of the sample at grossing. For example, the specimen may be a very small or delicate tissue sample which may not survive subsequent processing. The foregoing may be noticed and recorded at the grossing station. At a later point, such as at tissue processing 2858, the special instructions, remarks or notations may be retrieved. Special instructions may also indicate, for example, a particular position or orientation as to how the specimen partition should be embedded to provide for improved cutting at a later processing point. The quality assurance issues entered at this point are related to the sample and may describe characteristics that could impact the quality of work performed in subsequent steps of the histology process.

It should be noted that the foregoing is in contrast to processing that may be performed in existing laboratories as part of the workflow process. In existing systems at the accessioning station, one or more cassettes and associated cassette labels may be generated and delivered to the grossing station for use. In other words, the cassettes are marked at the accessioning or receiving station and then delivered to the grossing station. By generating the labels or otherwise marking the cassettes at a different workflow point other than grossing, additional error, such as mislabeling or mishandling of cassettes and blocks, may be avoided.

As known in the art, cassettes are small, perforated plastic containers having hinged doors for holding tissue samples for subsequent chemical processing and paraffin infiltration and embedding. The cassettes have the harmonized block identifier written or encoded upon them, for example, in the form of an indelible ink, or in a machine-readable label such as a bar code or RFID for tracking the tissue while in the cassette.

The tissue in each cassette is then submitted to tissue processing 2858 and embedding 2860 where the tissue is embedded in paraffin. Tissue processing 2858 may include, for example, the cassettes being immersed in multiple baths of progressively more concentrated ethanol to dehydrate the tissue, followed by a clearing agent such as chloroform, xylene or Histoclear™ and finally hot molten paraffin wax (infiltration). During this process, paraffin wax replaces the water so that the tissue in the cassette is turned into a hard paraffinized tissue sample. At embedding 2860, the paraffinized tissue is removed from the cassette and placed in a well that allows the tissue to be oriented to support proper sectioning. Once the tissue is oriented correctly, the cassette is placed over the tissue and molten wax is then poured over the cassette and tissue well which is then cooled and hardened. The resulting tissue sample is in the form of a hardened block by having its water replaced with paraffin. The resulting block of tissue is hard enough for cutting into thin, essentially transparent slices or “sections” of the tissue.

As part of processing at embedding 2860, the marked cassette may be scanned to read the harmonized block or cassette identifier, and then retrieve from the IPS database any remarks previously entered for the cassette at grossing. For example, the previously entered remarks at the grossing station may indicate that the sample may not survive tissue processing because of the fragility of the sample. After tissue processing, the contents of the cassette may be examined to determine the state of the tissue sample therein. A subsequent note regarding the state of the tissue sample after tissue processing may also be made at the embedding workstation and then communicated to the IPS for storage in the database thereon.

The blocks then proceed to microtomy or cutting 2862 where the block is sectioned. As known in the art due to the fragility of the sections, the sections may be first manually cut and then floated onto the surface of a water bath, where the sections flatten out and remain afloat. Each section may then picked be up from beneath by raising a slide below a floating section so that the section settles onto the slide surface. After drying and baking a section onto a slide, the slide may then be stained.

When the block arrives at microtomy or cutting, the harmonized block identifier of embedded tissue sample may be scanned and used to retrieve information from the IPS database for the particular cassette. The retrieved information may be displayed on an output or display device at the cutting workstation. The retrieved information may include the number of slides to be cut from the tissue block and the specific test information for each slide. Such information may include the staining protocol, reagent(s) to use, and the like, and may be sent directly to the slide marking or printing device located at the cutting station. For each slide, a harmonized slide identifier may be retrieved from the IPS 2874 and each slide is marked to include its harmonized slide identifier and optionally staining information thereon. An embodiment may mark or label each slide with the harmonized slide identifier and staining information (e.g., staining protocol, reagent to use, and the like) at the cutting station as each tissue section for the slide is cut from the block. As known in the art, a slide may be labeled using a variety of different techniques. For example, each slide may be labeled by generating a label, such as with a label printer, which is then placed on the slide. A slide may also be labeled by marking directly on the slide itself. By labeling each slide as the tissue placed thereon is cut, lean single piece workflow processing is employed to improve efficiency and quality by reducing the chance for error. One arrangement for labeling slides is described, for example, in AUTOMATED LEAN METHODS IN ANATOMICAL PATHOLOGY, filed Dec. 15, 2006, as U.S. patent application Ser. No. 11/639,586, Attorney Docket No. VMS-003US, which is incorporated by reference herein.

It should be noted that in existing laboratories, a clerk may generate slide labels for a block prior to the block arriving at the cutting station. Similar to the situation described elsewhere herein with the grossing station, the slides and slide labels in existing laboratories may be generated at a location and point in time prior to the actual cutting of the block at the cutting station. Thus, in existing laboratories, there is the possibility of introducing additional error into the workflow process in that slides may be more easily mixed up, lost, mislabeled, and the like.

After cutting 2862, the slide proceeds to staining. The particular staining performed on each slide may vary so that the slide may proceed to primary staining 2864 and/or advanced and special staining 2866. At each staining point, a slide label may be scanned to read the harmonized slide identifier and to record, for the slide, staining processing start date/time information, the particular stainer, and the like, to the IPS 2874. The foregoing information may be catalogued in the database of the IPS 2874 and associated with the harmonized slide identifier. In one embodiment in which the slide label also has encoded thereon staining information, such as the staining protocol, reagent to use, and the like, scanning the slide label results in reading the staining protocol and any other staining information encoded thereon. The workstation may then retrieve information for the particular staining protocol from the IPS database for use in performing the staining. In another embodiment in which the slide label does not include the staining protocol and other staining information encoded thereon, the staining protocol and other staining information may be retrieved from the IPS database based on the harmonized slide identifier.

The slide is then stained. When complete, the staining processing end time may be recorded in the IPS database for the slide based on the harmonized slide identifier. This may be performed, for example, by scanning the slide label to read the harmonized slide identifier and then storing in the IPS tracking information (e.g., stainer, operator, current date/time) associated with the harmonized slide identifier.

After staining, the slides may proceed to coverslipping 2867 where glass coverplates are glued onto the tissue section to create a more permanent, coverslipped slide. After coverslipping, the slides may proceed to case assembly processing 2868 where the slides are grouped in accordance with a same case id or harmonized case identifier. Slides of a same case may be collated and placed in the same case folder which is then delivered to the pathologist for review at 2870. Using the techniques herein, all slides having the same case number as included in the harmonized slide identifier of each slide are assembled in the same case folder. The operator at the case assembly workstation is able to verify that the case folder includes the appropriate slides by communicating with the IPS. Each slide label may be scanned to determine the appropriate case to which the slide belongs. Furthermore, for this case, the operator may also retrieve information from the IPS to determine the total number of slides that should be included in the case folder for the particular case. For example, the operator is able to determine if a slide has been lost, if an incorrect slide from a different case has mistakenly been included in a case folder, and the like.

In the example 2850, a laboratory may also optionally perform quality checkpoint screening of the case folder prior to forwarding the case folder to the pathologist for review. Such a quality check may occur prior to 2870. As part of this screening or quality check, a technician may view slides prior to delivery to a pathologist to ensure that there are no high level process problems such as may be introduced by A/P laboratory processing. For example, the case slides may be examined under a microscope to determine if the tissue thereon has been improperly folded (i.e., problem introduced at cutting), if there is background staining (i.e., staining problem may be due to stainer, antibody, protocol setting, and the like). The foregoing quality check may be performed to catch any such processing errors. If a problem is determined, the slide having the quality issue may have its label scanned to determine the harmonized slide identifier, and record information regarding the quality problem for the slide in the IPS database. The recorded information may also include any instructions to address or resolve the quality issue such as, for example, recut and restain, check the staining instrument, check the reagent, and the like. The quality check may be performed at a QC (quality control) workstation 2880. It should be noted that additional quality control processing may be performed at QC 2880 to determine, record and/or document other QC issues associated with other workflow processing points.

QC processing may be performed as an integrated portion of processing at a workflow processing point, such as described elsewhere herein in connection with grossing 2856. Additionally, an embodiment may have a dedicated QC workstation 2880 for performing QC processing associated with one or more workflow processing steps. A dedicated QC workstation 2880 may be desirable to perform QC processing in order to make other workstations and associated personnel available. For example, performing QC at 2880 after case assembly 2868 and prior to pathologist review 2870 makes available the case assembly workstation for performing case assembly for a next case.

The case folder of slides may then be delivered to the pathologist for review 2870. The pathologist may scan each slide label to read the harmonized slide identifier. Information regarding the pathologist performing the review and associated review date/time information may be recorded in the IPS database. The pathologist may then view the slide using a microscope and any information regarding the review may be entered and recorded in the LIS database and associated with the harmonized slide identifier of the slide being processed. At this point, the pathologist determines the next appropriate processing step such as, for example, whether to perform image analysis, additional staining, and the like. If image analysis is performed, the pathologist may enter image analysis information, comments, and the like, which is stored in the LIS. The pathologist may also order additional staining of a slide if needed. In one embodiment, the pathologist, or other individual ordering the additional staining for the slide, may enter a test order for the additional staining by communicating with the IPS 2874 or LIS 2852. The slide label may be scanned to determine the harmonized slide identifier. The test order may then be created for the existing slide based on the harmonized slide identifier. If one or more new slides are needed, the original block associated with the harmonized slide identifier may be determined using information stored at the IPS 2874. The foregoing may be indicated in the test order allowing the new slides to be produced from the same original block. The slides, and any remaining tissue of the blocks, may then be archived at 2872.

As part of the workflow process, the steps may be performed manually and/or using automated techniques involving several individuals. As such, a received specimen may proceed through a chain of custody in the laboratory. Each tissue entity, from specimen to slide produced therefrom, may have its associated chain of custody within the laboratory and the workflow process tracked and maintained by recording information at workstations. Using techniques herein, the tissue entities are each labeled and may be scanned while proceeding through the workflow process. For example, a specimen's label may be scanned at a grossing workstation 2856 to determine the harmonized specimen identifier, and record start and/or end date/time information, person processing the specimen, the location, and the like, for the harmonized specimen identifier. The person processing the specimen or other tissue entity may be identified by having the person scan his/her badge having a machine-readable identifier with the operator's identifier encoded in the bar code. This may be part of the login process of the person prior to commencing processing at one of the workstations. Subsequent to login, the individual may scan in the label of the tissue specimen and tracking information may be recorded to indicate that the individual processed the tissue at the date/time the label was scanned.

A block's label may be similarly scanned at tissue processing 2858, embedding 2860, and/or cutting 2862 to determine the harmonized block identifier and record start and/or end date/time information, person performing the processing, the location, and the like, associated with the harmonized block identifier. A slide's label may be similarly scanned at staining, by the pathologist, at case assembly, and other processing points that may be included in the workflow and chain of custody information similarly recorded for the harmonized slide identifier. The foregoing chain of custody information may be stored in a database of the IPS 2874.

In an embodiment, the foregoing tracking of information by scanning the harmonized identifier of the tissue entities may be performed at one or more workflow processing points. For example, in one embodiment, the tracking information may be recorded at each processing point. In another embodiment, the tracking information may be recorded at a selected portion of the workflow processing points. At each of the workstations having connectivity to the IPS that may be included at a workflow processing point, information stored in the IPS may be retrievable for the different harmonized identifiers. The information retrieved may be specific to the workflow processing point as well as additional information for the related case. The information may be retrieved from the IPS by scanning the labels included on the different tissue entities to obtain the harmonized identifiers encoded on the labels. Tracking information may be entered by scanning the appropriate label of the tissue entity upon arrival and/or completion at a workflow processing point's workstation.

It should be noted that as described herein, each label or other marking placed on a specimen container, cassette, or slide may include a human readable form of the machine readable information also encoded. An individual processing the tissue entity may also visually confirm that the human readable information on the label matches the information retrieved from the IPS that may be displayed in response to the scanning. For example, a specimen container may arrive at grossing. An individual may log into the workstation at grossing by scanning in his/her badge and entering other authentication information to access the IPS. The specimen container's label may be scanned and tracking information regarding arrival at grossing, the individual processing the specimen, and the like, recorded in the IPS. The scanning process may read the harmonized specimen identifier used by the workstation to retrieve information from the IPS for the associated case id and also retrieve specific grossing information. The information retrieved and displayed on an output device to the individual performing the processing may include the case id and the specimen number. The individual may be prompted by a dialogue displayed on the output device to examine the human readable specimen identifier, including case id, on the specimen's label and to confirm that the information of the label matches that as displayed. After the individual visually confirms the foregoing, he/she may use an input device to proceed to the next step. The number of cassettes to be labeled may be displayed and each cassette labeled and then filled with a cut portion of the specimen. After grossing is complete, the individual may make any appropriate notes or remarks and again scan the specimen container label and/or each cassette label to record tracking information in the IPS as to when grossing was completed for the specimen and/or cassettes.

It will be appreciated by those skilled in the art that the particular processing steps performed as part of the workflow process may vary with each laboratory. Additional optional steps, such as the quality control to screen the case folder of assembled slides, may be performed. Furthermore, the particular steps may vary with the processing performed by the laboratory, such as the particular staining or other specimen processing.

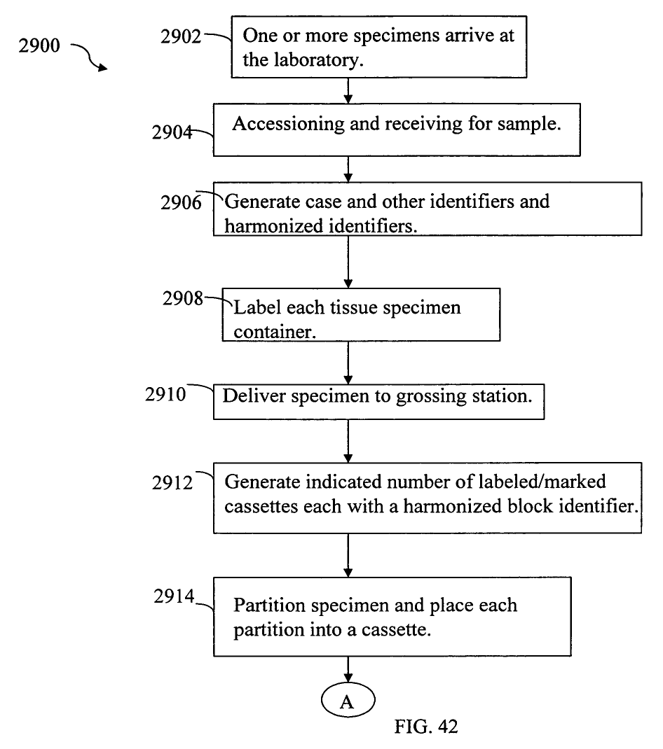

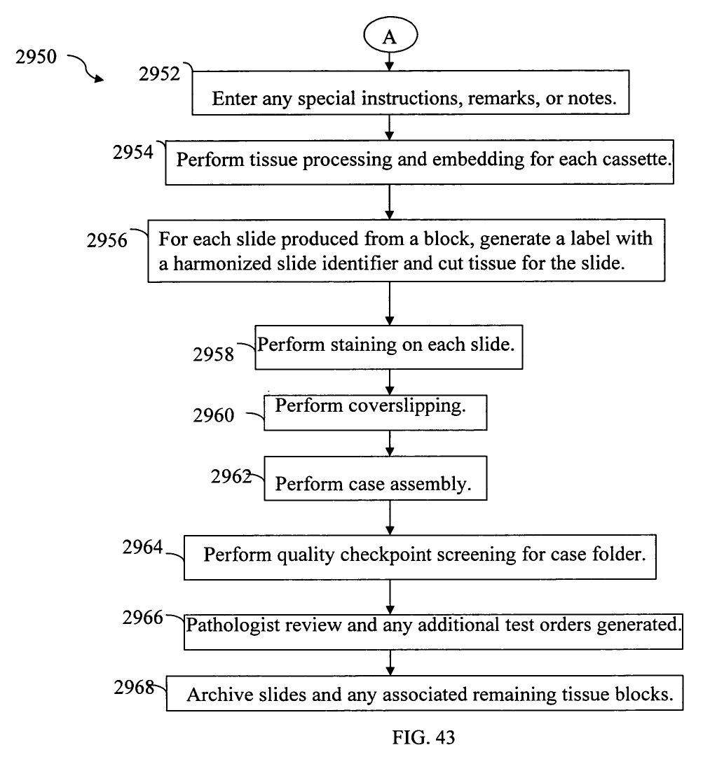

Referring now to FIGS. 42 and 43, shown are flowcharts of processing steps that may be performed in connection with the techniques herein. The steps of the flowcharts summarize processing as described above that may be performed in connection with the workflow processing. The flowchart 2900 illustrates an example in which the one or more specimens of a patient are received at the laboratory and there has been no previously entered information into the information system. Although not explicitly indicated in the flowcharts, each tissue entity (e.g., specimen, block, and slide) may have the label associated therewith scanned to record in the IPS tracking information for the chain of custody of the tissue entity as described elsewhere herein. At step 2902, the one or more specimens arrive with an associated paper requisition including patient information and test information which entered as part of accessioning and receiving at step 2904. At step 2906 as part of the accessioning and receiving processing, a case id, also referred to as the harmonized case identifier, may be generated by the LIS and communicated to the IPS. As described herein, the harmonized case identifier may be used by the LIS and other information systems accessing the same data. As part of step 2906, each of the different ids and associated harmonized identifiers of FIG. 39 may be generated and used in connection with various subsequent workflow processing points. As part of step 2906, a harmonized specimen identifier is generated for each specimen container and included in a label as part of step 2908 which is affixed to the specimen container. At step 2910, the specimens are delivered to a grossing station for processing. The specimen label of each specimen may be scanned, information retrieved from the IPS to label or mark the appropriate number of cassettes each with a harmonized block or cassette identifier at step 2912. At step 2914, the specimen is partitioned and each partition is placed in a labeled cassette. With regard to FIG. 43, at step 2952, an operator may enter any special instructions, remarks, quality assurance information, or notes that may be relevant to subsequent processing steps. The foregoing may be stored in the IPS and associated with the appropriate cassette based on the harmonized block or cassette identifier. By scanning in the label containing the harmonized block identifier at a later processing point workstation, the foregoing may be retrieved. At step 2954, the tissue processing and embedding are performed for each cassette. The blocks proceed to cutting where tissue for each slide is cut from a block. At step 2956, for each slide, the harmonized slide identifier previously generated at step 2906 is included on a label or other manner of marking the slide. The staining protocol and other staining information may also be obtained from the IPS and also encoded on the slide label. At step 2958, the appropriate staining is performed for each slide. As described elsewhere herein, the staining performed for a slide may be determined by scanning the slide's label to read the harmonized slide identifier, staining protocol and other information encoded thereon, and then retrieving information from the IPS. The retrieved information may include, for example, processing steps for the staining protocol, what reagent(s) to use, and the like. It should also be noted that some of the information, such as the staining protocol to be used for a slide, may be directly encoded on the slide label. At step 2960, slide coverslipping may be performed. At step 2962, received slides may be collated to assemble all slides of a particular case based on those slides having the same associated case id, or harmonized case identifier. As described elsewhere herein, the individual assembling a case folder may scan the slide labels to read the harmonized slide identifiers encoded thereon. Information may be retrieved from the IPS to determine whether all slides of a same case id have been received and included in the case folder, and also to verify that no slides from another case have been mistakenly included. At step 2964, the quality checkpoint screening of the slides in the case folder may be performed to ensure that there are no problems with the slides as introduced by the laboratory processing. At step 2966, the case folder is sent to the pathologist for review. Additional or new test orders may be generated based on the pathologist's review. At step 2968, the slides and any associated remaining tissue blocks for the case id or harmonized case identifier, may be archived.

As part of laboratory processing, techniques may be used to ensure that a specimen and other tissue entities are processed in a timely fashion, are not misplaced within the laboratory, and the like. One technique that may be used may be referred to as checkpoint notification and will now be described. Checkpoint notification involves associating a time checkpoint with each of one or more workflow processing points. In the event that the tissue entity does not reach the workflow processing point by the time checkpoint, a notification may be generated, for example, such as an electronic notification to alert a technician, lab manager, and/or other personnel. The tracking information described above that may be obtained by scanning a label upon arrival at a workstation may be used to disarm or stop the checkpoint notification for a workflow processing point associated with the workstation. For example, each operator may be required to scan a specimen when the specimen reaches a grossing workstation for processing. The IPS may receive the tracking information related to the chain of custody for the specimen. A checkpoint notification time may be stored in the IPS and associated with the specimen's harmonized specimen identifier. Receipt of the current date/time information included in the tracking information may disable sending any checkpoint notification messages regarding grossing.

As another example, if a cassette is generated as an output of grossing at 8 a.m., an embodiment may determine that the cassette should complete embedding processing within 4 hours, or by 12 noon on the same day. The cassette's label may be scanned upon completion of embedding. If, for example, the cassette's label is scanned at 11:30 a.m., the corresponding checkpoint notification may be removed from the IPS. Alternatively, if no scanning for the cassette has occurred at embedding by 12 noon, an alert is generated causing a notification.

Upon initialization of the IPS or data manager component residing thereon, a set of default checkpoint notifications may be defined which are associated with a tissue entity tracked in the laboratory. For example, a set of default checkpoint notifications may be defined for each specimen with respect to the workflow processing performed in the laboratory. When accessioning and receiving at the laboratory is performed for the sample received at the laboratory, the default checkpoint notifications may be associated with the specimen. The default checkpoint notifications may define default relative time periods between workflow points. In the event that processing of a particular workflow processing point associated with the specimen does not complete by the specified time, a notification may be generated. The notification may be, for example, an email message or page sent to appropriate lab personnel, writing information to log the incident in a system file, and the like. An embodiment may provide an override for the default checkpoint notifications. The override may allow for tailoring the default checkpoint notifications for a particular laboratory entity. This is described in more detail in following paragraphs.

Checkpoint notifications may be defined for a tissue entity and any sample derived therefrom (e.g, specimen, block, slides from a particular block/from a same case, and the like) between any two or more workflow processing points. The time periods may also be determined relative to arrival or completion of processing at a particular point.

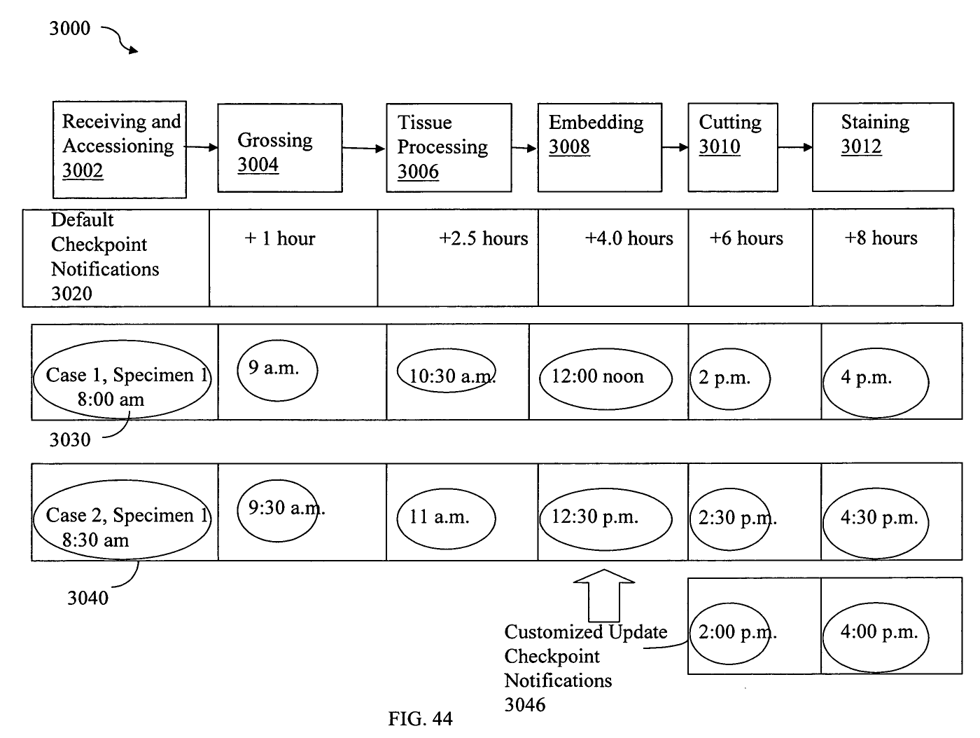

Referring now to FIG. 44, shown is an example 3000 illustrating checkpoint notifications. In this example, a system may be configured to generate checkpoint notifications relative to the arrival of a tissue entity at the different workflow processing points 3002, 3004, 3006, 3008, 3010, and 3012. An embodiment may define checkpoint notifications for a different set of processing points than as included in 3000 for purposes of illustration. Element 3020 defines a vector of default checkpoint notifications indicating time periods relative to the first time of 3002 for receiving and accessioning at the laboratory. As part of receiving and accessioning 3002, the checkpoint notifications are generated and included in the IPS. The subsequent times at which a notification may be generated are indicated relative to when the specimen is received and processed at receiving and accessioning 3002. The individual performing the processing at 3002 may be prompted that the default checkpoint notifications are being generated and included in the IPS. The default checkpoint notifications may be displayed to the individual and the individual may be given the opportunity to modify the checkpoint notification times, delete or disable one or more of the checkpoint notifications, and the like. As an example, the vector 3030 includes checkpoint notification times that may be generated automatically based on the default times of 3020 relative to the first time of 8 a.m. associated with receiving and accessioning 3002. In this example for 3030, if the specimen 1 does not arrive at grossing by 9 a.m., (+1 hour with respect to the receiving time of 8 a.m.), a first notification message for the specimen is generated. As a result of scanning the specimen's label at grossing and recording tracking information prior to 9 a.m., the checkpoint notification for grossing is removed. Each of the cassettes generated from specimen 1 are expected to arrive at tissue processing by 10:30 a.m. As a result of scanning the cassette labels at tissue processing and recording tracking information prior to 10:30 a.m., the checkpoint notification for tissue processing for each cassette is removed. Similarly, checkpoint notification times associated with workflow processing points 3008, 3010, and 3012 are generated and the associated checkpoint notification may be removed upon scanning of the appropriate tissue entity labels at the workflow processing point workstation.

The element 3040 defines checkpoint notification times for another specimen 1 of case 2 which arrives at receiving and grossing at 8:30 a.m. The entries of 3040 are based on the default time intervals of 3020 relative to the first time of 8:30 a.m. In this instance, the individual at receiving and accessioning chooses to customize or update the default checkpoint notification times of 3040. In this example, the updated times are indicated in 3046 by modifying the checkpoint notification time for cutting 3010 and staining 3012. The foregoing may be performed, for example, if all slides for case 1 (3030) and case 2 (3040) need to arrive at staining by 4 p.m. to ensure completion by the end of the day.

The default checkpoint notification times provide for individual specimen pacing based on relative times to when each specimen or sample derived therefrom is at a particular processing point. For example with reference to 3000 using the default checkpoint notifications of 3020, all slides generated from a specimen are expected to arrive at staining within 8 hours from when receiving and accessioning is performed for the specimen. The example 3000 also illustrates customizable checkpoint notifications for one or more workflow processing points. An embodiment may also provide for enabling/disabling one or more checkpoint notifications for all cases, selected specimens, or some other level of granularity. It should be noted that although the foregoing example illustrates checkpoint notification times being set at receiving and accessioning, a lab manager or other appropriate individual may be able to read and/or modify checkpoint notification times at any point in the workflow from any workstation connected to the IPS. Additionally, the default checkpoint notifications may be initially configured. At a later point, an embodiment may include functionality to reconfigure the default checkpoint notifications such as, for example, define different relative time intervals between processing points, add or remove time intervals for workflow processing points, and the like.

In the foregoing example, the checkpoint notification times may be characterized as bound to each specimen and all samples derived therefrom. The checkpoint notification times are determined in this example as part of accessioning and receiving so that all subsequent checkpoint notification times are determined relative to a first time, such as when the specimen is processed for receiving and accessioning at a first laboratory workflow point.

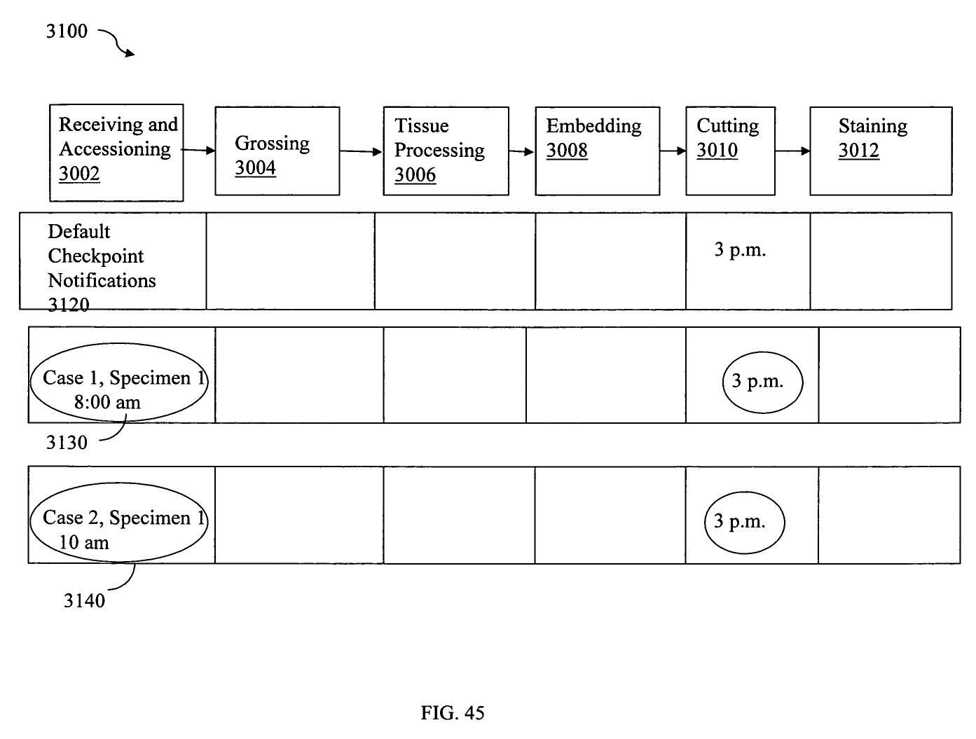

As an alternative, or in addition to, having default relative checkpoint notifications defined for each individual specimen as described above with 3020, an embodiment may also define default checkpoint notifications which may be referred to as absolute checkpoint notification times. The example 3100 of FIG. 45 illustrates this by defining a default checkpoint notification 3120 including absolute times, such as a particular time of day. In 3020, a time of 3 p.m. is specified indicating that all blocks/cassettes which have been received on the same day are expected to be at embedding by 3 p.m. regardless of when the tissue specimens have been received or processed at previous workflow points. In this example, 3130 indicates that case 1 has a single specimen processed by receiving and accessioning at 8 a.m. Element 3140 indicates that case 2 has a single specimen processed by receiving and accessioning at 10:30 a.m. Both specimens for cases 1 and 2 are expected to arrive at cutting by 3 p.m. otherwise checkpoint notification messages are accordingly generated.

The checkpoint notification messages may include information about the case, specimen or other tissue entity, the workflow processing point for which the notification message is generated (e.g., grossing, embedding, staining, and the like), the expected time of the checkpoint notification time which has expired, and the like.

It should be noted that an embodiment may use any one or more different techniques to indicate “stat” or priority test orders associated with a case. For example, specimens, cassettes, and slides associated with a priority order may be indicated by a color or other visual indicator on the labels. Work may be delivered to the individual workstations and prioritized at each workstation accordingly. Checkpoint notification may not be enabled for use with stat or priority orders.

In accordance with the checkpoint notifications as described herein, a laboratory may determine where a tissue entity was last processed to enable tracking of the specimen, cassette, slide, and the like. This may be useful to ensure that slides and other entities processed in the laboratory are not misplaced and/or complete by a particular time. The use of checkpoint notifications provides for a timely notification and determination of where the tissue entity was last in connection with the workflow process. Additionally, obtaining tracking information for the chain of custody at workflow processing points may be used to determine who last processed the tissue entity, where the tissue entity may be located if misplaced, and the like. The checkpoint notification and tracking information for the workflow process may be used in connection with identifying bottlenecks in the workflow process.

Information regarding a checkpoint notification communication may be stored in a data store of the IPS. Such information may indicate who should be contacted, the form of communication (e.g., email, pager), a location as to where the communication should be transmitted (e.g., email address, phone or pager number), particular conditions for which the person should be contacted (e.g., for only particular workflow processing points, times of day, weekends, weekdays), and the like.

It should be noted that in connection with archiving slides and blocks of a case, an embodiment may store the slides and blocks in a particular archival storage location (e.g., drawer of a storage unit). The archival storage location may be recorded in the database and used to locate the slide or block from archive storage if needed at a later point in time. Additionally, retrieval of the slide or block may require a user to log onto to a workstation and scan the slide or block being removed. The user logged on as retrieving the slide or block from archive may be recorded in the IPS database as part of the chain of custody information.

It should be noted that although techniques are described and illustrated for particular specimen types, the techniques herein may be used with surgical biopsies, tissues, and other specimens processed by an A/P laboratory as well as other specimens processed by other laboratories, such as blood samples in a clinical chemistry laboratory and cytological samples prepared in a cytology laboratory.

It should be noted that the functionality described herein for performing processing may be implemented in hardware and/or software in an embodiment. It should also be noted that although examples and illustrative embodiments described herein set forth particular configurations of functionality as may be performed by particular software and/or hardware components, other variations and configurations are possible as known to those of ordinary skill in the art.

While the invention has been described with reference to an illustrative embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for identifying samples processed in a laboratory using harmonized identifiers, the method comprising:
determining a case identifier identifying a patient from whom a specimen is collected;
determining a specimen identifier associated with the specimen;
recording in a data store an entry for the specimen, the entry being associated with the case identifier and the specimen identifier;
forming a harmonized specimen identifier including the case identifier and the specimen identifier; and
labeling the specimen with the harmonized specimen identifier.

2. The method of claim 1, further comprising:
determining a block identifier for each tissue block produced from the specimen;
recording in the data store an entry for said each tissue block, the entry being associated with the case identifier, the specimen identifier, and the block identifier;
forming a harmonized block identifier for each tissue block including the case identifier, the specimen identifier, and the block identifier; and
labeling each tissue block with the harmonized block identifier.

3. The method of claim 2, further comprising, for each tissue block:
determining a slide identifier for each slide produced from said each tissue block;
recording in the data store an entry for said each slide, the entry being associated with the case identifier, the specimen identifier, the block identifier, and the slide identifier;
forming a harmonized slide identifier for said each slide including the case identifier, the specimen identifier, the block identifier, and the slide identifier; and
labeling said each slide with the harmonized slide identifier.

4. The method of claim 1, wherein said harmonized identifiers include one or more types of harmonized identifiers, said type of harmonized identifiers comprising a harmonized slide identifier type, a harmonized block identifier type, and a harmonized specimen identifier type, each type of harmonized identifier used by consumers of said harmonized identifiers to differentiate between different samples of said each type in a workflow process of the laboratory.

5. The method of claim 1, wherein said harmonized identifiers have an associated local level of uniqueness with respect to consumers thereof to allow for identification and tracking of a sample by the consumers.

6. The method of claim 1, wherein said case identifier includes a first portion identifying a source of the specimen and a second portion including one or more alphanumeric characters representing an element in a sequence of elements.

7. The method of claim 1, wherein said specimen identifier includes one or more alphanumeric characters representing an element in a sequence of elements, each specimen associated with the case identifier having a different specimen identifier.

8. The method of claim 2, wherein said block identifier includes one or more alphanumeric characters representing an element in a sequence of elements, each tissue block associated with a same specimen having a different block identifier.

9. The method of claim 3, wherein said slide identifier includes one or more alphanumeric characters representing an element in a sequence of elements, each slide produced from a same tissue block having a different slide identifier.

10. The method of claim 3, wherein each harmonized specimen identifier, harmonized block identifier, and harmonized slide identifier are encoded in a machine readable form.

11. A method of automating information associated with biological specimens processed in a laboratory comprising the steps of:
performing accessioning for one or more specimens, said accessioning including entering case information communicated to a server, the case information identifying a patient from whom the one or more specimens are obtained;
determining a case identifier for the case information;
recording data on the server associating the case identifier with the case information and the one or more specimens;
determining a different specimen identifier for each of the one or more specimens;
recording data associating the different specimen identifier with each of the one or more specimens; and
labeling each of the one or more specimens with a harmonized specimen identifier, the harmonized specimen identifier for each specimen being formed from the case identifier and the different specimen identifier associated with said each specimen.

12. The method of claim 11, further comprising, for each of the one or more specimens:
delivering said each specimen to a grossing station;
reading, from a label on said each specimen, a harmonized specimen identifier;
communicating with the server to retrieve data indicating a number of cassettes to be produced for said each specimen based on the harmonized specimen identifier;
determining a different block identifier for each of the number of cassettes;
recording data on the server associating the different block identifier with each of the number of cassettes;
marking the number of required cassettes by labeling each cassette with a harmonized block identifier formed using the case identifier, a specimen identifier included in the harmonized specimen identifier, and the block identifier associated with said each cassette;
partitioning a number of tissue portions from said specimen in accordance with said number of cassettes; and
placing a tissue portion into each of said cassettes.

13. The method of claim 12, further comprising, for each tissue block included in one of said number of cassettes:
delivering said cassette to a cutting station;
reading, from a label on said cassette, a harmonized block identifier;
communicating with the server to retrieve data indicating a number of slides to be produced for said cassette based on the harmonized block identifier and staining information for each of said number of slides;
determining a different slide identifier for each of the number of slides;
recording data on the server associating the different slide identifier with each of the number of slides; and
marking, at said cutting station, each slide by labeling said each slide with a harmonized slide identifier formed using the case identifier, a specimen identifier and a block identifier of the harmonized block identifier, and the slide identifier, said slide label also including said staining information;
cutting a number of tissue section from said each tissue block in accordance with said number of slides; and
placing a tissue section on each of said number of slides.

14. The method of claim 12, further comprising:
obtaining chain of custody information for each specimen during processing of said each specimen at one or more workflow processing points in the laboratory.

15. The method of claim 14, further comprising:
reading a label associated with each specimen containing the harmonized specimen identifier at the grossing station; and
recording on the server tracking information and associating the tracking information with said each specimen, the tracking information including date and time information and identifying an individual performing processing at the grossing station on said each specimen.

16. The method of claim 14, wherein chain of custody information is obtained related to processing a specimen, or portion derived therefrom, in connection with at least one of: grossing, tissue processing, embedding, cutting, staining, case assembly, coverslipping, pathologist review and archiving, and the method further includes:
recording on the server the chain of custody information and associated the chain of custody information with an appropriate workflow processing point.

17. A method of tracking specimens and samples derived from the specimens in a laboratory comprising:
determining one or more checkpoint notification times associated with a specimen, each of said checkpoint notification times being associated with a workflow processing point in the laboratory;
recording the one or more checkpoint notification times and associating the one or more checkpoint notification times with the specimen;
labeling said specimen and each sample derived from a specimen with a machine readable label including information encoded thereon used for identifying said specimen and each sample derived from said specimen;
as part of processing at a workflow processing point in the laboratory, reading the machine readable label and recording tracking information associated with one of the specimen or said each sample derived therefrom having the machine readable label, said tracking information including data identifying said workflow processing point and a time at which said one of the specimen or said each sample derived therefrom is at said workflow processing point;
determining whether a checkpoint notification is associated with the workflow processing point for said specimen;
if a checkpoint notification and checkpoint notification time are associated with the workflow processing point for said specimen and the checkpoint notification time has not arrived, recording information so that a checkpoint notification communication is not generated at the checkpoint notification time; and
if a checkpoint notification and checkpoint notification time are associated with the workflow processing point for said specimen and the checkpoint notification time arrives prior to tracking information associated with the workflow processing point being entered, generating a checkpoint notification communication.

18. The method of claim 17, further comprising:
specifying one or more default time intervals each associated with a workflow processing point; and
determining a checkpoint notification time associated with the specimen at a workflow processing point relative to a first time associated with the specimen and one of the default time intervals associated with the workflow processing point.

19. The method of claim 18, further comprising:
customizing one or more checkpoint notification times associated with a specimen by overriding a default notification time generating using the one or more default time intervals.

20. A method for generating a harmonized identifier for a sample entity processed in a laboratory comprising:
determining a node corresponding to the sample entity at a position in a hierarchical representation, each level of the hierarchical representation being associated with a workflow processing point in the laboratory, said hierarchical representation having a root node and a path formed from said root node to said node, said root node corresponding to a case identifier associated with a patient from whom the sample entity is obtained;
determining a data identifier for each node in the path other than the root node, the path including two or more nodes, each node other than the root node being associated with another sample entity from which the sample entity is obtained; and
forming a harmonized identifier for the sample entity by combining the case identifier and each data identifier associated with a node in the path other than the root node.

21. The method of claim 20, wherein the harmonized identifier is stored in a database and associated with the sample entity.

22. The method of claim 20, further comprising:
labeling a container including the sample entity with the harmonized identifier encoded in a machine readable form.

23. The method of claim 22, further comprising:
labeling the container including the sample entity with the harmonized identifier encoded in a human readable form.

24. The method of claim 20, wherein the sample entity is a tissue processed in an anatomical pathology laboratory.

25. The method of claim 22, further wherein the machine readable form includes at least one of a bar code and an encoded radio frequency identification label.

26. The method of claim 22, wherein said labeling includes marking a surface of the container.

27. The method of claim 22, wherein said labeling includes generating a label affixed to the container.

28. A method for identifying a slide processed in a laboratory, the method comprising:
determining a first identifier associated with a specimen, the first identifier including a first portion denoting a source of the specimen and a year in which the specimen is obtained, and the first identifier including a second portion denoting a next integer in a sequence;
determining a second identifier for a tissue block derived from the specimen, the second identifier being one or more alphanumeric characters;
determining a third identifier for the slide having a tissue section thereon cut from the tissue block;
forming a slide identifier for the slide by concatenating the first identifier, the second identifier and the third identifier;
recording in a data store an entry for the slide, the entry being associated with the slide identifier; and
labeling the slide with the slide identifier encoded in a machine readable form.

29. The method of claim 28, wherein the slide identifier is encoded in a selected bar code symbology.

30. The method of claim 28, wherein the slide identifier is encoded on a radio frequency identifier label affixed to said slide.
